(19) United States
(12) Patent Application Publication
(10) Pub. No.: US 2004/0047505 A1
(43) Pub. Date: Mar. 11, 2004

(54) Stylus computer

(76) Inventor: Firooz Ghassabian, Great Neck, NY (US)

Correspondence Address: Joseph Sofer, Sofer & Haroun, Suite 910, 317 Madison Avenue, New York, NY, 10017, US

(21) Appl. No.: 10/451,944

(22) PCT Filed: Dec. 26, 2001
(86) PCT No.: PCT/US01/49450

(51) Int. Cl. G06K 9/18

(52) U.S. Cl. 382/186

(57) ABSTRACT

The present invention is directed to a pointing device writing tip comprised of a surface being structured in a manner that while writing with the writing tip on a writing surface, the contacts of the writing tip with the writing surface produce different sounds in different directions. A hand writing recognition system is provided based on at least the recognition of sounds produced by the writing tip having a surface being structured in a manner that while writing with the writing tip on the writing surface, the contacts of the writing tip with the writing surface produce different sounds in different directions for use by the recognition system.

### FIELD OF THE INVENTION

This invention relates to a data entry system and method based on hand-writing-sound recognition system, through which, a naturally, easily and quickly full text and functions input can be provided. It also relates to a computer mouse system for data entry and manipulation, for mobile and fix electronic devices. It finally relates to a stylus-type computer device, using the above-mentioned data entry methods and means.

### BACKGROUND OF THE INVENTION

Miniaturization has been a key component to recent technological advancement, enabling production of many devices that would otherwise be impracticable for reasons of size alone. In fact, the very essence of, for example, portable computers and cellular phones, is their size as a primary feature.

Yet, primarily because of human constraints, there are many obstacles to the growth of miniaturization in several areas. For example, it may be desirable to have a portable computer that fits in one's wallet, but such a computer would not be useable without a large input device that enables human interaction with the computer. In other words, complex miniature computers and devices such as cellular phones (now, also used for the Internet, email, m-commerce, Short Massages Services, etc.), notebooks, Personal Digital Assistant (PDA) devices, require keyboards, numeric pads or other input facilities to allow the user to enter a phone number, send e-mail or transcribe a letter, etc. Also a convenient LCD display for viewing data entered or received is an important feature. Thus, as advanced as miniaturization technology may get, there are other human factors involved that prevent certain devices from realizing a truly miniature state.

As is well known, the key feature of a successful technological product, is its easily manipulations. For above-mentioned instruments and similar devices, a quickly, easily and most importantly, naturally, full text and function entry system is vital. Also a display device of the width of a standard text line is appreciable.

Proposals have been put forward to solve this fundamental man-machine-interface problem of how to quickly and easily enter text and functions using small communication devices.

The telephone-type keypad, is the most common input device for small electronic and telecommunications instruments. It is integrated in many electronic devices such as mobile and wired telephones, PDA, notebooks, laptops, faxes, remote controllers of TVs or other electronic devices, cameras, etc. This keypad has usually twelve keys, while the number of characters and functions used for writing texts or massages are at least seven times more. For example, a computer keyboard has more than eighty keys, while some of those keys are used for two characters, symbols, or functions.

Because of the telephone keypad limitations due to its insufficient number of keys (e.g. mobile phone keypad), each key of a standard telephone keypad contains a group of characters and usually one number. Usage of the Internet or even entering a short message engages a lot of complexity for the user.

One solution to solve this problem, is to provide multiple presses of a single key for selecting a letter or symbol among those represented by a key. This system is currently used for most mobile phone keypads. This is a time consuming method and it frustrates the user.

To improve that system, word disambiguating software products are developed. A dictionary database and language model are used to scan and present possible words according to keys pressed. Later the user selects the desired word among presented possibilities. Such approach engages a lot of problems such as out-of-vocabulary words or obliging the user to concentrate for selecting a word. In addition, entering numbers or single characters are again time consuming procedures.

External miniaturized keyboards are also produced to overcome the problem but they oblige the user to carry two different instruments, interfering with the basic idea of small electronic products, which is their easy portability.

One recent technology that has attempted to overcome such limitations is voice/speech recognition technology. Voice recognition is the process of recognizing one or more voice patterns from an individual's voice as a corresponding computer input command, word, or function. For example, rather than typing a letter on a keyboard a user speaks that letter, wherein the recognition engine associates the voice pattern of that letter with the corresponding computer input character of that letter. Thus, individuals may operate devices in this manner without an input device since the user's voice provides all of the input. Unfortunately, considering the many complex aspects of an individual's voice, there is yet a recognition device that can accurately recognize voice patterns at a sufficient level where input devices can be completely replaced.

Additionally, several letters such as “B” and “P”, or “D” and “T”, can easily be confused by a speech engine. This is not necessarily a shortcoming of the engine as these letters can easily be confused by the humans as well. Hereafter, a list of some of the problems and disadvantages concerning voice/speech recognition systems;

Only for one language, mostly English

Recognizing only one person's voice

Outside noise disturbance (specially, when using mobile telecommunication instruments) reduces the recognition accuracy

Not good for small displays because of correction inconvenience (specially when using instruments with small LCDs, such as mobile phones)

Many mistakes may occur when speaking single words (discontinuous speaking)

Similar pronunciation for different words (e.g. two, to, too)

Not predicting the user intention when writing numbers (e.g. twenty four, 24)

Not predicting the user intention when writing mixture of numbers and symbols (e.g. six by four, 6 by 4, 6×4)

Difficulty to distinguish between letters (e.g. B, P)

Usually many characters are pronounced with only one syllable, making the recognition difficult (e.g. “write”, “right”).

Most importantly, due to the privacy issue, this system may not be appropriate of being used in, for example, public places. Speaking letters, words, or commands is not a discrete input system.

Another method of data input is the hand writing recognition systems. Different directions for this method can be considered:

a) Documents may be written by hand and later been read (e.g. delayed procedure) and digitized by means such as optical readers. Recognition of a person's hand-writing through this system is a very complicated task because it only relies on written graphs which are completely different for each person. There is not yet an appropriate recognition system based on this method.

b) Real time hand-written detection means such as PDA devices, optical readers, etc., that instantly process multiple input parameters such as hand-written graphics, pen directions by which the graphics are written, angles in graphics, time at which each point of graph was written etc.

Because letters and characters are often simple graphs and in many cases they look alike, misinterpreting errors may occur by the recognition engine. Therefor some character writing restrictions are imposed to users.

The most known instruments using this system are palm-type PDA devices. The device has a digitizing system and a sensitive writing surface. A corresponding pen is provided for writing graphics on said surface. It has also a small screen to print the data entered after being digitized. Usually the procedure of writing a symbol must be accomplished without removing the pen from the writing surface. A text must be written character-by-character, separately. Hereafter some disadvantages of this system:

Need of carrying a sensitive writing surface.

Writing is slow because the writing surface of a PDA is small and user must survey to not exit it.

User must carry both PDA and corresponding pen and more importantly, using his both hands whole writing which is not convenient in mobile environment.

Display is of a small size

The PDA itself is bulky and may not permanently been carried, for example, in a user's pocket.

Notwithstanding the miniaturization issue, portable and other electronic devices have many security and efficiency problems. For example, an individual who misplaces or loses a cellular phone must rush to disconnect his or her communications service before a thief or other person uses the phone to generate unauthorized charges. One known method for preventing such unauthorized use is to lock the cellular phone or other device with a code system. Although, effective in many cases, this system is painstaking and inefficient for the true owner, who must activate the phone via a lengthy process before dialing. Similarly, there is no simple method for preventing unauthorized use of many electronic devices without first locking the device with a code system or other time consuming and inefficient process.

The security issue becomes more vital, when the instrument is used for purposes such as E-commerce or banking operations, which require, for example, the credit card number or bank account information of the user.

Therefore, what is needed is a technology that resolves the human constraint dilemma mentioned above, so that miniaturization can continue to realize its true potential. Furthermore, such a technology should also provide means for a more secure and efficient mechanism that can prevent unauthorized use of devices and information among other things, as compared with the prior art.

It is an object of this invention to provide the electronic instruments with data entry needs (specially, mobile communication instruments), with a familiar, quick, and easy data input systems. It is also another object of this invention to provide the user with a familiar, easy to carry stylus-type computer or PDA device, having discrete, quick, and easy data entry and manipulation capabilities, and a large display to enable the user to, for example, work on a display of A3/A4 paper width. The systems, devices, and methods describe hereafter, may be used independently, or in conjunction with other communication devices and systems.

### BRIEF DESCRIPTION OF THE DRAWINGS

In the drawings in which like reference characters denote similar elements throughout the several views:

FIG. 1a shows a pen and a writing surface;

FIG. 1b demonstrates a sample of the pen directions while writing;

FIG. 2a shows a pen, writing a two-direction line;

FIG. 2b shows an imaginary waveform demonstration of the sounds produced by the pen and the writing surface contact when writing the above-mentioned line;

FIG. 3a shows a desired writing instrument tip to produce different sounds for different directions when writing on a writing surface;

FIG. 3b shows a writing instrument tip surface structure for producing above-mentioned different sound productions;

FIG. 3c shows two different sound waveforms produced by a structured tip of a pointing device, while drawing two similar lines in opposite directions.

FIG. 3d shows a written symbol produced by a pen tip such as the one shown in FIG. 3b, and the waveform of the sounds produced by said pen tip while writing that symbol on a writing surface.

FIG. 4a shows examples of different shapes of writing tips, enhancing the production of different sounds while stroking in different directions on the writing surface;

FIG. 4b shows an example of different texture of writing tips, enhancing the production of different sounds while stroking in different directions on the writing surface;

FIG. 4c shows an example of combination of different shapes and different textures of writing tips, enhancing the production of different sounds while stroking in different directions on the writing surface;

FIG. 4d shows a writing instrument angle relating to a writing surface, while a user is writing.

FIG. 4e shows the contacted area of a conical (e.g. convex) pen tip and a writing surface while writing;

FIG. 4f shows a front view of two different contacted areas of a pen tip on a writing surface, at two different rotating to pen axis positions.

FIG. 4g shows side and front view of another pointing device structured tip shape.

FIG. 5a shows a hand-written letter graph produced by a pen;

FIG. 5b shows the imaginary graph of the sounds produced by said pen and writing surface contact during writing that letter;

FIG. 5c shows an imaginary speaking voice graph of that character;

FIG. 6 shows a standard computer keyboard containing keys representing English characters and symbols.

FIG. 6a shows similar hand written characters.

FIG. 6b shows printed and hand written English uppercase and lower case characters and resembling symbols.

FIG. 6c shows how three resembling hand written characters may be written, to be distinguished by a recognizing system.

FIG. 6d shows still four resembling hand written characters, and a proposal of how to write them to make distinguishing possible.

FIG. 6e shows a resembling, number and character;

FIGS. 6f-6j shows printing and hand written characters by categories, and a proposal of directions to be respected while writing them, to permit the recognition system to recognize them easier.

FIG. 6k shows all keyboard printed characters and and a proposal of directions to be respected while writing them, to permit the recognition system to recognize them easier.

FIG. 7 shows a diagram of hand writing recognition processing, according to one embodiment of the invention;

FIG. 7a shows a stylus-type computer using hand writing sound recognition system as input system;

FIG. 7b shows a front view of pen-type tip, for said stylus-type computer being equipped with additional features;

FIG. 7c shows a stylus-type computer according to one embodiment of the invention;

FIG. 7d shows a the front view of a writing tip of a stylus-type computer according to one embodiment of the invention;

FIG. 7e shows a stylus-type computer having an exponential means to amplify sounds of contacts of the pointing tip on a writing surface while writing.

FIG. 7f shows a stylus-type computer having a resonating chamber to amplify sounds of contacts of the pointing tip on a writing surface while writing.

FIGS. 8a-8d show said stylus-type computer and an example of a writing tip in closed, open, and writing position according to one embodiment of the invention;

FIGS. 9a-9c show the erasing feature and erasing procedure of said computer according to one embodiment of this invention;

FIGS. 10a-10b show anther erasing procedure of said computer according to one embodiment of this invention;

FIG. 11 shows a stylus-type computer according to one embodiment of the invention having a flat or concave LCD display.

FIG. 11a shows a stylus-type computer according to one embodiment of the invention having a curved or cylindrical (e.g. convex) LCD display.

FIGS. 11b-11c illustrate the average size of said curved/cylindrical display.

FIG. 12 show a stylus-type computer having a button type mouse, for manipulating and eventually entering data, according to one embodiment of the invention.

FIG. 12a shows some of pen axis movements and positions of said mouse, according to one embodiment of the invention.

FIG. 12b shows clicking pen axis movements/positions of said mouse, according to one embodiment of the invention FIG. 12c shows relatively to stylus axis rotating movements of said mouse, at each position, according to one embodiment of the invention;

FIG. 12d shows the side view of another kind of movements of said mouse caused by perpendicularly to stylus axis pushed by a user on mouse, according to one embodiment of the invention;

FIG. 12e shows the front view of the mouse and some pushing directions.

FIG. 12f shows a side and front view of the mouse having a bull to manipulate a pointer/selector mean on a display of the stylus type computer.

FIGS. 13a-13c show how a menu list may be selected by the mouse according to one embodiment of this invention;

FIGS. 14a-14f show how a menu may be selected by the mouse manipulation according to one embodiment of this invention;

FIGS. 15a-15h show how a menu bar and a function may be selected by using the mouse, according to one embodiment of this invention

FIGS. 16a-16d show how to advance or backward a text on a display LCD, by using the mouse, according to one embodiment of this invention

FIGS. 17a-17f show how to advance or backward a cursor, character by character, in a text by using the mouse, according to one embodiment of this invention

FIGS. 18a-18d show, how to move a text selecting indicator on a document displayed on the screen, when mouse in a predetermined position, according to one embodiment of this invention

FIGS. 19a-19e show the procedure of selecting a portion of a text by the mouse according to one embodiment of this invention;

FIGS. 19a-19d show a copy procedure by using the mouse, according to one embodiment of this invention

FIGS. 21a-21e show a paste procedure by using the mouse, according to one embodiment of this invention

FIGS. 22a-22b show how a selected text may be deleted by using the eraser, according to one embodiment of this invention

FIG. 22c shows how a selected text may be deleted by using the eraser, according to one embodiment of this invention

FIGS. 23a-23e show, a menu bar and a function selecting procedure, by the computer “Normal Select” indicator using the mouse, when mouse is in another predetermined position, according to one embodiment of this invention;

FIGS. 24a-224h show, how to move a text selecting indicator on a document displayed on the screen and, a menu bar and a function selecting procedure, by the computer “Normal Select” indicator, using the mouse in a same predetermined position, according to one embodiment of this invention;

FIGS. 24i-224n show how a cursor may be manipulated in a text by perpendicularly to stylus axes pushes on the mouse, according to one embodiment of the invention;

FIG. 25 shows different positions of the mouse and the clicking direction at each position.

FIG. 25a shows the mouse in one predetermined position, wherein text manipulating procedures and steps are assigned to the movements of the mouse in that position.

FIG. 25b shows the mouse in another predetermined position, wherein menu and function manipulating procedures and steps are assigned to the movements of the mouse in that position.

FIGS. 26a-26c show the mouse system and device described for the stylus-type computer, to be used in other type of computers at different locations on them according to one embodiment of this invention

FIG. 26d shows a computer equipped with a writing surface and the input system of the invention, replacing the traditional keyboard;

FIG. 27a shows pressure buttons for the stylus-type computer according to another embodiment of this invention;

FIGS. 27b-27f show an additional multi directional button and their function in the stylus-type computer, according to one embodiment of this invention;

FIGS. 27g-27j show a multi position clip button for the stylus-type computer according to another embodiment of this invention;

FIG. 27k shows a clip button of FIGS. 27b-27f located closed to the writing tip of the stylus computer according to one embodiment of the invention;

FIG. 27L shows a multi sectioned/directional clip in open position, used as directional microphone and/or an antenna and/or a clip button for the stylus computer according to one embodiment of the invention;

FIGS. 27m-27n show the multi-sectioned clip of FIG. 27L, in variety of open positions;

FIGS. 28a-28e show an additional input system by using the display and the mouse, according to one embodiment of the invention.

FIGS. 29-29d show a cover for the stylus-type computer protecting the LCD display when not in use and the steps of covering the computer, according to one embodiment of the invention.

FIGS. 29e-29g show the stylus type computer while it is used as a telephone and tele-communicating instrument.

FIG. 30a shows a stylus-type computer according to one embodiment of the invention.

FIG. 31 shows a stylus-type computer, having different navigation buttons, according to one embodiment of the invention.

FIG. 31a shows a cursor navigating button according to one embodiment of the invention.

FIGS. 31b-31f show a cursor navigating on the screen by manipulating said button according to one embodiment of the invention.

FIGS. 32a-32f show a menu navigating button and its manipulation according to one embodiment of the invention.

FIG. 33a shows a mobile telephone having a writing-surface and a microphone for inputting the sounds produced by a pen while writing on it according to one embodiment of the invention.

FIGS. 33b-33c show a wrist-mounted device such as a watch combined with an electronic device such as telephone or PDA, having a display, a writing surface and a microphone for inputting the sounds produced by a pen while writing on it, according to one embodiment of the invention.

FIG. 33d show a wrist-mounted device such as a watch combined with an electronic device such as telephone or PDA, having a display and a microphone for inputting the sounds produced by a pen while writing on it, according to one embodiment of the invention.

FIG. 33e shows a number of electronic devices, having at least a display and eventually a microphone for inputting the sounds produced by a pen while writing, according to one embodiment of the invention.

FIGS. 33f-33g show an enhanced keypad to be combined with the hand writing sound recognition system of the invention, permitting full text and function input;

FIG. 34a shows a stylus-type computer having means to determine its pen tip position from a beacon, according to one embodiment of the invention.

FIG. 34b shows the cover of the stylus-type computer of FIG. 29a, used as the beacon, according to one embodiment of the invention.

FIG. 35 shows a notepad having a horizontal beacon to permit a stylus-type computer to determine its pin position on that notepad, according to one embodiment of the invention.

FIG. 36 shows a notepad having horizontal and vertical barcodes indicating a locations on that pad.

FIG. 37 shows a writing surface having indicating number, or sins, or colors, to indicate locations on it.

FIG. 38 shows a writing surface and a projector to project location indicating signs on that surface.

### DETAILED DESCRIPTION OF THE INVENTION

In the following description, a method of data entry is described, in which a pointing device such as a pen, stylus, or even a user's finger is used in conjunction with a writing surface to facilitate hand written data entry. The input is based on the sounds produced by the contact of the pointing device or finger, and the writing surface during writing.

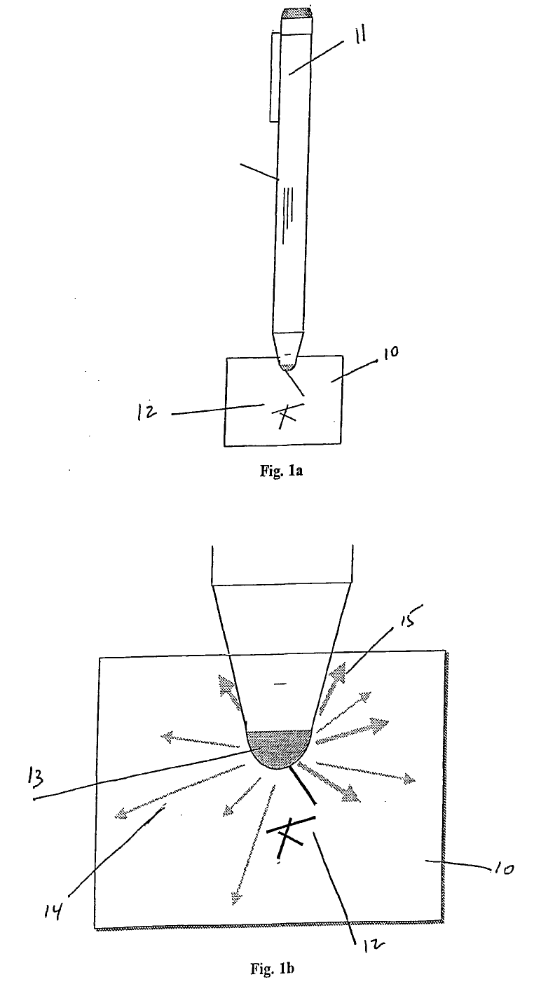

With initial reference to FIG. 1a, a pen (11) and a writing surface (10) are shown wherein, two symbols (12), are written by the pen.

With reference to FIG. 1b, a zoomed portion of a pen tip (13) is shown. It demonstrates as example, some pen tip possible writing movements and directions on the writing surface (10). The pen may move in different directions (14). In this figure some of those directions (15) are used to write the symbols (12) on the writing surface (10).

The contacts between the pen and the writing surface during writing procedure, produce different sounds and noises. Those sounds may vary depending on parameters such as pen tip surface structure, starting point manner, symbol ending manner, pen directions, change in directions, duration of each direction, speed in each direction, variation in pressure force of the pen on the writing surface, etc.

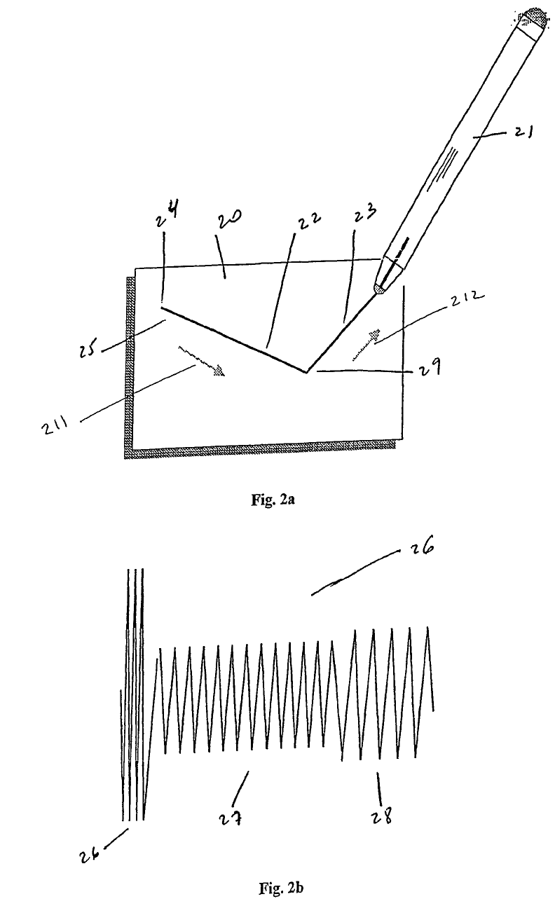

FIG. 2a shows a writing surface (20) and a pen (21). By using the pen, a user has drawn a symbol (25) on the writing surface. The symbol consists of two straight lines (22,23), drawn continuously wherein second line direction is different from the first line. Each drawing has its own characteristics. In this example, some of the characteristics are, information such as starting point (24) manner, first and second line directions (211,212) and duration, changing point manner (e.g. curved, straight, accentuated), etc. Usually contacts of the tip of a pointing instrument on a writing surface, while writing a symbol by a user, cause the production of different sounds and a sound waveform characterizing that symbol. Each time that symbol is written by the same pointing device tip, the same user, and in a same manner, same sound and waveform will be produced.

FIG. 2b represents an imaginary waveform (26) of the sounds produced during the writing of symbol (25) of FIG. 2a, showing changes in amplitude (y axis) over time (x axis). First part (26) of waveform relates to the sound produced by pen tip shock on the drawing surface at the starting point (24). Second part (27) of waveform relates to the sound produced during the first line (22) drawing. Because the changing direction point (29) is not accentuated, no sound may be produced. Third and last part (28) of the waveform is produced by drawing the second line (23).

The sounds produced by a shock of the pen tip on a writing surface may be different for each symbol. For example starting shock sound waveform of letter “c”, is stronger than starting point of letter “b”. This is also true for ending points. Ending point sound of letter “c” weakens slower than ending point of letter “b”. This is another additional parameter that may be considered by a hand writing sound and/or sensor recognition system (hereafter HWSRS) which will be explained in detail later.

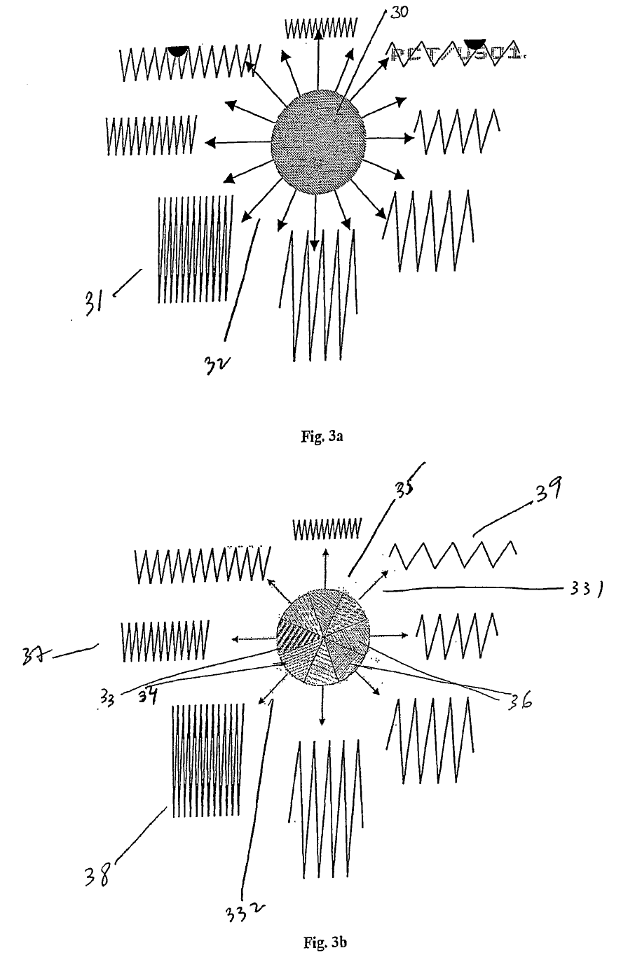

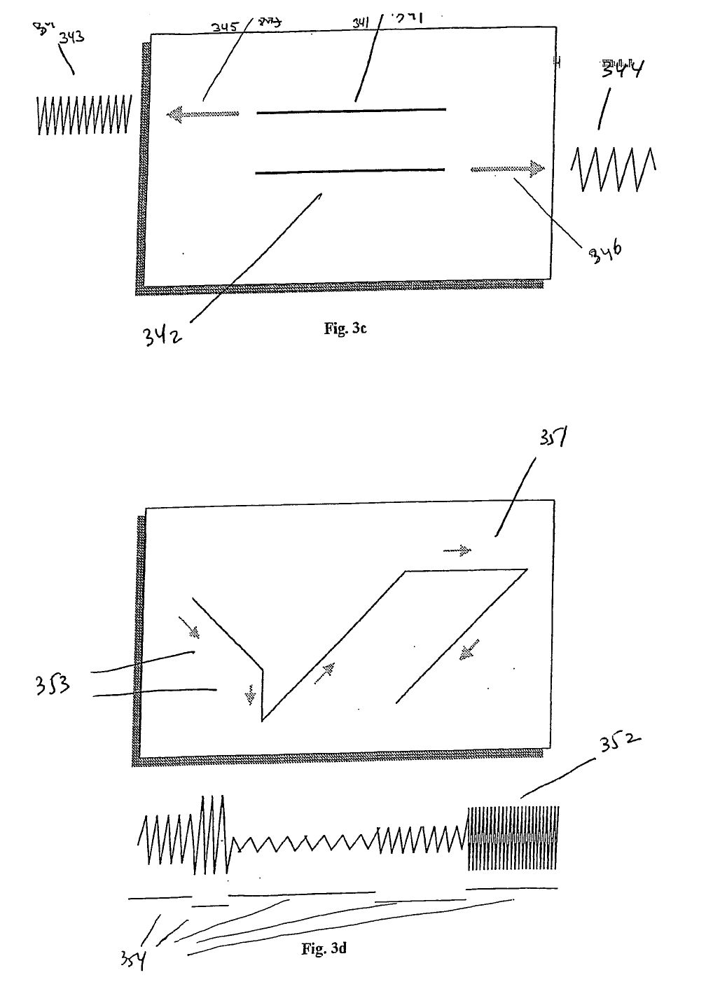

Variation of sounds or sound waveforms produced by strokes of a pointing device in different directions on a writing surface may not be easily distinguished if the pointing device tip surface is smooth. On the other hand those variations may easily be recognized if the pointing device is equipped with a structured coarse tip surface, in a manner to produce a different sound for a different direction. FIG. 3a illustrates the front view of a pointing device tip, and imaginary different waveforms (31) produced by shifting that structured pointing device tip (30), in different directions (32) on a writing surface.

In order to produce such different sounds, one solution is to create a pointing tip (35) as shown in FIG. 3b. Pointing tip (35) may be divided to different portions (36), wherein each portion may be made of different materials (33,34) to produce different sounds (37,38). This system will also permit to have, for example, two different sounds (38,39), for two opposite directions (331,332). Also, for better accuracy, neighboring portions may be structured in a manner to produce distinctively significant different sounds.

FIG. 3c, shows two parallel lines (341,342), drawn by a pointing device having a structured tip such as a tip (35) described before. First line (341) is drawn from right to left direction (345) producing a sound shown by its sound waveform (343). Second line (342) was drawn parallel to the first line. It was drawn by the same pointing device being in the same position in the user's hand as for the drawing of the first line, but it was drawn in the opposite relationship, from left to right (346), producing a different sound which is shown by its sound waveform (344). Because the left side pen tip surface was different from the right side, two different sounds were produced for two apparently similar lines. This is an advantageous feature because it permits to have two different symbols for apparently two similar symbols. For example the number “0”, may be written in clockwise direction, and the letter “O” may be written in counter clockwise direction. By using this system, they will produce two different sounds and therefor two different sound waveforms. They will easily be recognized by a HWSRS.

FIG. 3d shows a written symbol (351), and its sound waveform (352). The symbol is written by the pointing tip of FIG. 3b. To write this symbol, the pointing tip has used five directions (353). Waveform (352) is produced by five consecutive sounds (354) produced by five pointing tip directions (353) during the drawing of the symbol.

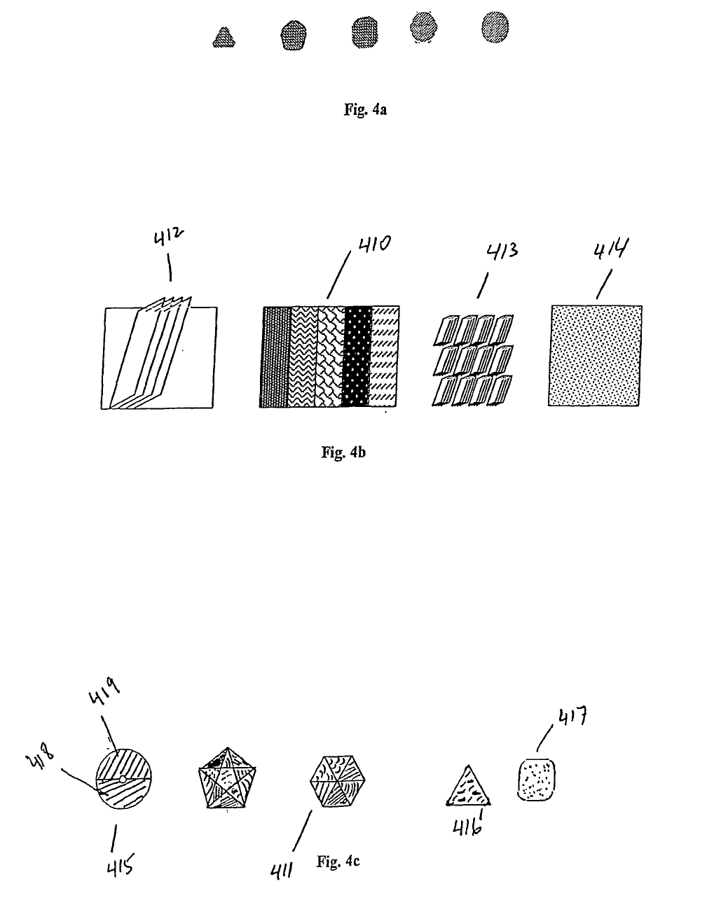

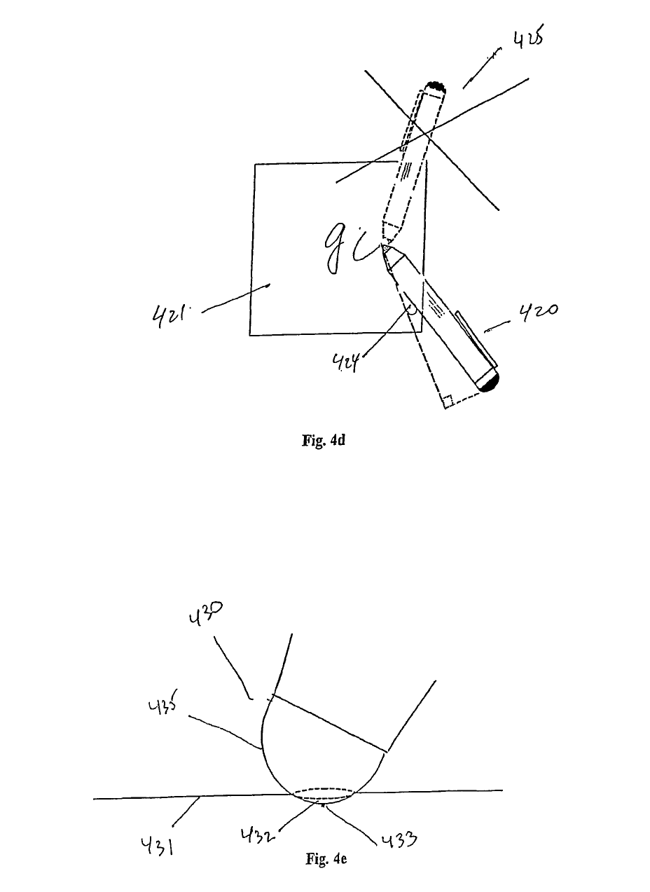

It is understood that the pointing tip shown in FIG. 3b is only an example. Many other forms or types of pointing tips maybe considered. For example, a pointing tip maybe divided in less or more portions. As shown in FIG. 4a, pointing tips can have different shapes and forms. Their surface may be of different shapes and made from different materials, as shown in FIG. 4b. To enhance different sound production and to accentuate their differences, as shown in FIG. 4c, the pointing tip surface may be divided into different portions wherein each portion can be made from different materials (410,411). In addition the divided portions of the pen tip can have different forms.

As shown in FIG. 4b, a pointing tip may contain, for example, different pins distributed on different locations on the tip surface. The pins may be positioned on the tip surface in a manner to touch differently the writing surface in each direction and to produce different sounds for each direction. For this purpose, the pins may also have different shapes. They, for example, may be longish (412), short (413), inclined to left or right, and installed in different orientations on the pointing tip (415, 416). This will permit to produce different sounds by the same portion of the tip but in different shifting directions.

According to one embodiment of the invention, the tip surface may have sensors (414), to produce different signals to indicate information such as directions, duration of directions, etc., according to pressure force applied on its different sensors by drawing movements of the pointing tip while writing symbols or commands. Then accordingly, the device may produce different sounds, different waveforms and other information needed for HWSRS engine to recognize the written symbol.

Also the pointing device maybe equipped with a direction recognition system being capable of recognizing the pointing device tip directions on a writing surface or in space. Then accordingly, the device may produce different sounds, different waveforms and other information needed for HWSRS engine to recognize the written symbol.

To produce the same sound for the same direction, the pen tip surface portion in touch with the writing surface, must always have the same similarities (e.g. structure, texture, material, position). The above-described pointing tip surface structures oblige the user to hold the pointing device in a predetermined position in hand. To avoid that restriction, pen tip (and its surface) must be structured in a way so that when it touches the writing surface, the portion in touch will always be similar.

As shown in FIG. 4d, while writing a symbol, a user usually keeps the stylus or pen (420) in the same position in his hand and the same angle (424) in relationship with the writing surface (421). He usually does not radically change the pen position (425) in his hand. FIG. 4e shows the side view of a hemispherical form (e.g. convex) pointing device tip (430). While writing with a pointing device tip having a curved form (convex surface) (435), on a flat writing surface (431), only a small portion (432) of the pointing device tip surface, closed to contact point (433), between the pointing device and the writing surface, may also get in contact with the writing surface. If the tip has a harmonious form such as hemispherical form, and by the fact that a user keeps always the pen in the same angle relationship with the writing surface, the contact area will always have, approximately, the same geometric form. If the tip surface is structured in a way that the same contacted portion has the same structure, then the user can take the pen, in any rotating position according to the stylus axis, in his hand and write on a writing surface. FIG. 4f shows the front view of a hemispherical or conical (e.g. convex) pen tip (441). The pen tip is structured in a way that every time the pen touches the writing surface with a same predetermined angle but in different rotating positions (according to pen axis), portions of the tip in contact with the writing surface (442, 443), have the same form, structure, material, etc, (444, 445). It is understood that the structure must be made in a way that when writing on a writing surface, the pen tip produces different sounds for different directions. Different structuring materials such as the pins described before, may be used. FIG. 4g shows the side view cut (451) and the front view (452) of another suggested pen tip form. It should be noted that the pen tip forms and structures described in hereinabove, are only examples. Variety of other pen tip forms and structures, made from variety of materials, may be created by people skill in the art. For better and faster recognition, plurality of hand written character sets and symbols sound waveforms and patterns, may be produced by a user pen tip, in different writing angles relating to a writing surface and introduced to the HWSRS.

Preferably also the writing surface may be structured in a way to enhance the sounds produces by the pen tip.

It must be noted that while writing a symbol necessitating different directions, consecutive different sounds produced accordingly by structured pointing tip strokes on the writing surface, produce a waveform which characterizes that symbol and only that symbol. For example, while writing the letter “O”, the pointing tip uses a variety of different short directions that produce a characteristic waveform for letter “O”.

Sounds, waveforms, and other characteristic information produced by the pointing tip for each symbol or function may be patterned and recorded, and later be processed by the HWSRS to recognize text or drawings written by users. For example, waveforms of a user's hand-written sound character set, hereafter HWSCS, may be patterned as his personal character set and “taught” to the HWSRS. For better accuracy, for each writing surface a different Hand Writing Sound Character Set can be provided.

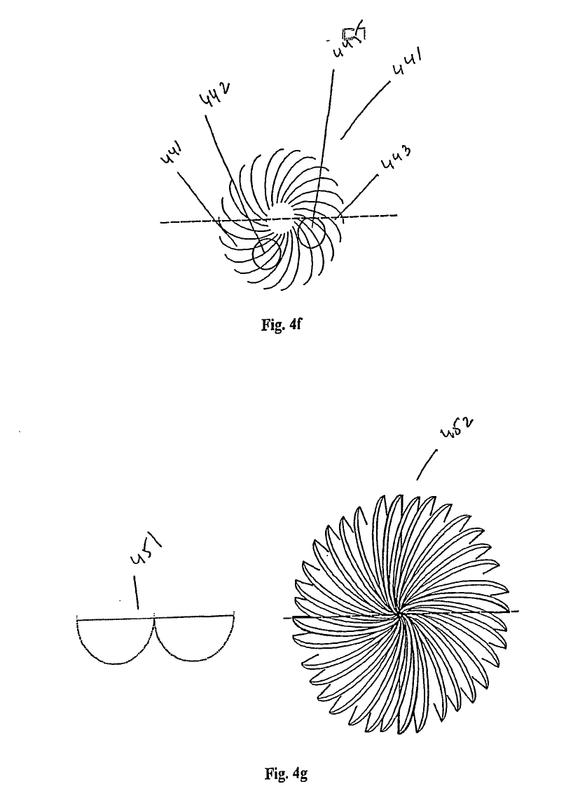

FIG. 5a shows a stylus (511) having a structured tip (512). The letter “e” (513) has been written by that stylus. FIG. 5b, is an imaginary waveform of the sounds produced by said stylus while writing the letter “e”. Finally FIG. 5c, demonstrates an imaginary waveform of the letter “e” pronounced by a user.

A comparison of these graphs demonstrate the advantages of the present invention. First graph (513), the written letter “e”, is a very short graph. Depending on how, or by who this letter was written, it can easily be misinterpreted by a traditional handwriting recognition engine, with for example, the letter “c” or the letter “l”. Contrary to it, the graph (waveform) of FIG. 5b, which was produced by sounds of pen tip movements on the writing surface is a long graph with plurality of variations and characteristics thanks to different sounds produced by different pen directions while writing it. It will be easily recognized.

Finally the graph of FIG. 5c, is again a short graph with almost few variations. It can be easily misinterpreted by the voice recognition engine by letters such as b, d, p, or even an outside noise, etc. Waveform of sounds produced by the pen tip contacts with the writing surface during a character handwriting is much longer and varied, therefore the recognition by a voice engine will be much easier.

Hand writing input has many advantages comparing to voice input;

it is discrete (privacy issue is solved)

user intention is not considered (“24” is different than “twenty four”, 6×4 is different from, six by four, etc.)

voice recognition engine shortcomings do not exist (p, is different than b)

words with similar pronunciation (e.g. two, to, too), are written differently.

discontinuous speaking issue is solved.

Corrections are immediate

It is good for all languages.

outside noise is not a problem

Traditional handwriting recognition systems are on character by character basis. It is much easier to recognize a written character graph than a written word graph. Two continuously written similar words never look alike, even if they are written by the same person. On the other hand it will be very difficult for a recognition system to distinguish the continuous characters by which the written word is formed. But the traditional handwriting recognition systems based on written graphs and character by character basis, have a major problem that sometimes makes the recognition difficult even by humans: Characters and symbol graphs are often too short and therefor in many cases they look alike. If they are not written clearly, they may be misinterpreted and sometimes even not recognized at all.

Also voice waveforms of a pronounced character and/or word may be similar (e.g. “T”, “Tee”, “Tea”. Therefore voice or speech recognition systems are usually based on sentences. It is easier for a speech recognition engine to recognize a sentence rather than a single word or letter. Speech recognition system analyses the suggested received words and according to a predicted sentence, decides for example, if a received word is “right”, or “write”. This system is not good because in many cases, only single words, letters or symbols, are inputted.

HWSRS brings the answer to all above-mentioned problems. It has all advantages of handwriting system and solves its shortcomings. This system may work, preferably, on character by character recognition basis, but the recognition is based on recognizing waveforms, patterns and other information of sounds produced by a pointing device tip on a writing surface while writing those characters. Those waveforms, as explained before, are much longer and more varied than written character graphs or spoken sound waveforms, and contain more characteristic parameters such as;

Start/end sound of a symbol, or a portion of a symbol if it is written discontinuously;

Number of syllables produced by writing a symbol wherein a syllable refer to a portion of the symbol having a substantially constant shape. The number depends on different angles in the hand written graph and if the symbol is written continuously or discontinuously. The number of syllables for each discontinuous portion of a symbol is N+1, wherein, N, is the number of angles.

Speed of writing in each direction causing changes in sound accordingly;

Differences in pressures on the writing surface while writing a symbol, according to the shape of its written graph, causing changes in sounds accordingly;

Duration of writing time of each direction;

Different users, or even a same user at a different writing period, may use a different character set size (e.g. writing with smaller or larger characters), causing shorter or longer sound for each direction. Different portions of written characters may keep unique relationship and proportion, even if they are written in different font sizes. This resembles to “Octaves”, in the music domain.

And other additional parameters deriving from this system;

Therefor recognizing becomes much easier.

Information such as length of a line, size of a character, etc., may become available by using these parameters. According to these principles and parameters, a sophisticated HWSRS, may even recognize symbols according to hand written sound patterns of symbols written by a regular pointing device tip such as a pen, or even a finger or nail of a user, on a writing surface. In this case a structured tip may not be necessary.

The outside noise shortcoming may be easily overcome by installing, for example, a microphone in the electronic device equipped with the HWSRS or even in the pointing device itself. The sensors may be connected to the pen tip by, for example, wires, so that only the sounds produced inside the stylus as a result of the writing procedure are captured and transmitted to the recognition engine.

In addition, for better accuracy, other systems such as hand written graph recognition systems, pen/hand movements recognition systems, voice/speech recognition, lip recognition, and/or other recognition systems, separately or combined together, may be used in conjunction with the HWSRS. For example, a user may write a symbol such as a character, a word or a sentence, and speak it simultaneously. The combinations of HWSRS and a voice recognition system may provide a better accuracy rate for inputted characters. For a natural and user friendly inputting method, while writing, a user may speak only the letters, words, sentences and other symbols which may naturally be spoken by people while writing a text. Other symbols such as at least part of punctuations marks, etc., may only be written without being speaking them.

The system may include one or more databases of letters, words and symbols in different languages. A predictive word recognition system may also be combined with the system to make the selection of a word possible before entering it entirely. This system may allow an automatic selection of the desired word by the system mostly before ending to enter it entirely and sometimes even without the need of the user interference. This is possible, because by writing, individually and sequentially, characters or symbols (e.g. character by character basis) of a word, and the very small numbers of corresponding words, in many cases, before finishing to enter the word entirely, the word predictive system can either determine the desired word, or may show a few possible words, and the user selects one of them.

Even if the user enters a wrong letter while writing a word, or the HWSRS fails to identify a given letter, since in most cases other letters of the word are entered correctly, the predictive word recognition system can automatically correct the wrong letter.

It is understood that instead of being on character by character basis, the system may be based on the recognition of an entire word or even an entire sentence. In this case, sound waveform or sound pattern databases for entire written words, symbols, or even sentences, may be provided to the HWSRS.

For better accuracy and easier recognition, a user can “teach” (e.g. train) the HWSRS, his/her hand writing. In this case the recognition procedure will become easier and faster.

In addition, a user can create his own commands based on his hand writing characteristics. For example his electronic device may be turned on or turned off, only by his hand written instructions based on his hand writing sound patterns and/or sound waveforms. He can also personalize his instrument. In this case, the device can be manipulated by only his hand writing input. A user can also cerate his own customized characters, symbols, macros, functions, commands etc. A created symbol may refer to plurality of other symbols or commands. Contrary to regular keyboards, this system permits unlimited variety of symbols or commands to be created and used by the user.

The user can also teach his signature to the HWSRS. In this case his signature can never be imitated. For example, when opening a bank account, the user can introduce the sound waveform of his signature, based on his personal structured pointing tip and a selected writing surface, to his bank references. The combination of the signature, personal structured pointing tip and the selected writing surface will produce a unique sound waveform and pattern, making the imitation impossible. Thanks to this procedure, tele-banking transactions, e-commerce operations and the like will become secured.

E-mails, short massaging services (SMS), etc., will become confidential. First the user equips, for example, his friend's or his bank HWSRS, with his hand written sound patterns or waveforms based on his personal equipment (e.g. pointing tip structure, writing surface). Then all operations or massages will be made or sent by his hand written sound patterns. They will be compared with hand written sound patterns recorded in other party's directory. After being matched the operation will be done and/or the massage could be read.

For security reasons, a user can also create his own codes based on his hand writing sound patterns. For above-described reasons, his codes are strongly confidential permitting him to transmit coded documents which maybe decoded by the other party, only if that party's recognition system has a copy of coded patterns.

Numbers, digits, characters, symbols, commands, etc, may be encoded by, for example, a user's customized additional meaningless (for non-concerned parties) written graphs, while writing a text, so that the sound waveforms of symbols will have additional meaningless syllables. These additional meaningless graphs may be written at any moment and location (e.g. combined with the symbol or separately) while writing. They will be filtered by the receiving party's HWSRS, familiar with customized meaningless graphs of the user, resulting decoded information. This system can help to send confidential information such as the credit card number of a user in an E-Commerce operation.

It is understood that all voice or speech recognition systems and other recognition systems such as traditional hand writing recognition systems and technologies may be used to enhance the HWSRS.

The recognizing procedure may also, effectuate at a delayed time. It means that all parameters, such as writing sounds, timings, writing speed, etc., may be recorded while writing, and be processed later by a HWSRS, to recognize the hand written symbols.

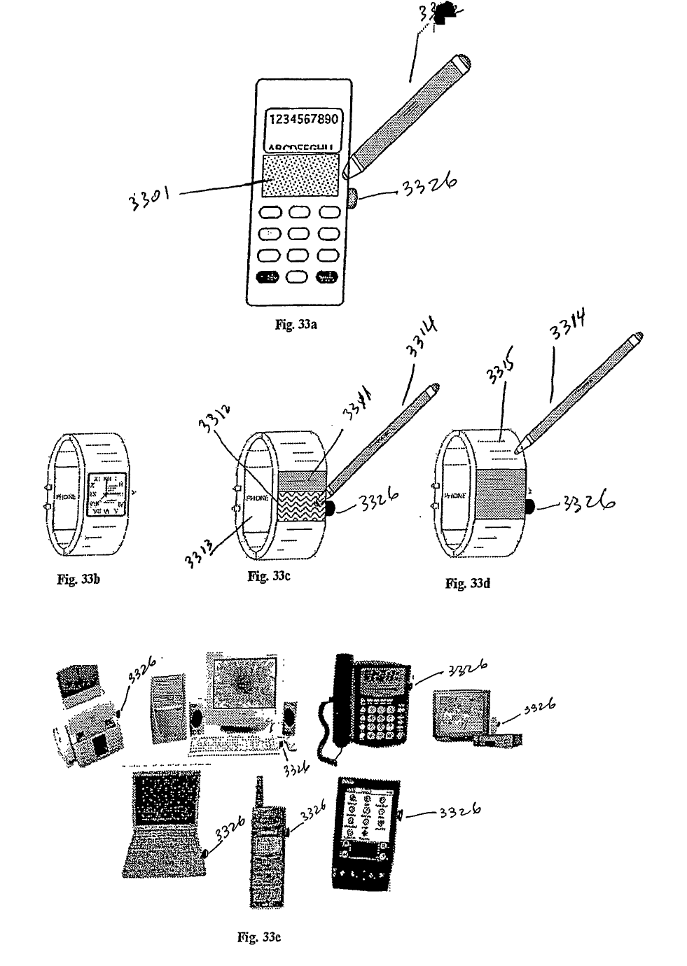

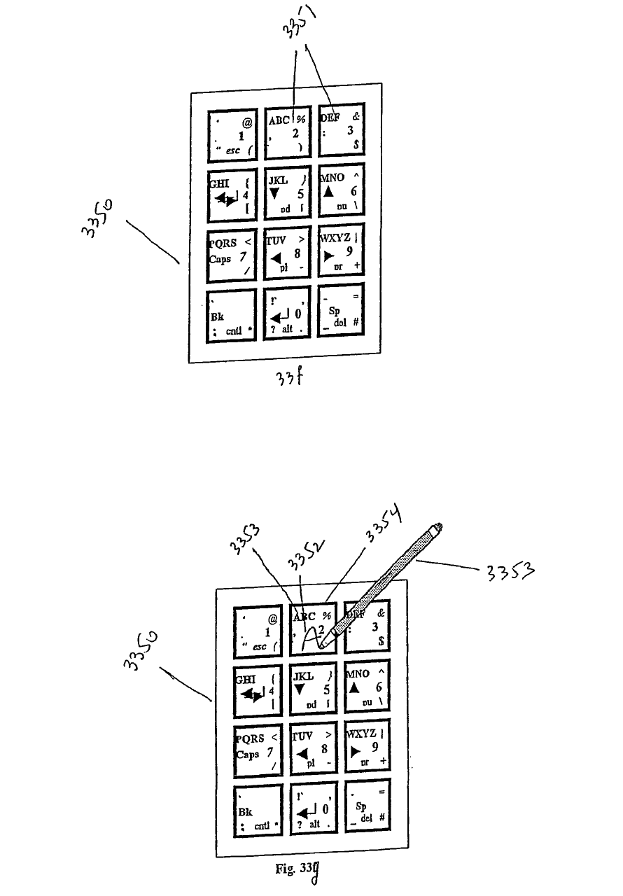

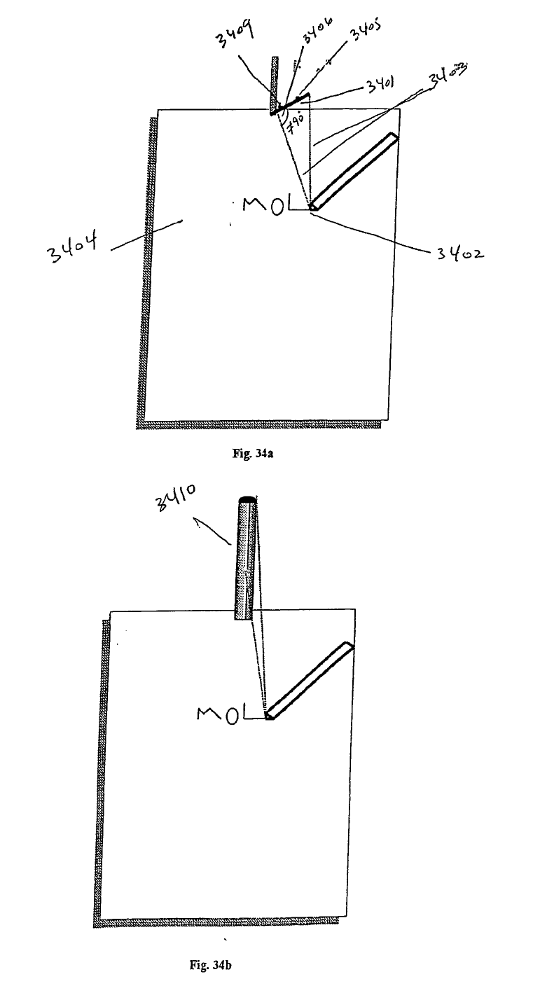

Almost every electronic device, and specially, mobile instrument, may be equipped with input devices based on this method. Electronic devices may be equipped with this HWSRS and a microphone connected to eventually a writing surface. A user having a preferably a pointing device with a structured surface can input data by writing on that surface. FIGS. 33a-33e show some of those devices. For example, FIG. 33a shows a mobile phone having a writing surface (3301), at least one microphone, and a HWSRS. A user, having a pointing device with a structured surface (3302), can input hand written data by using the pointing device on the writing surface. Sounds produced by the strokes of the pointing device on the writing surface while writing data, will be transmitted to a processor and the HWSRS digitizes the data entered. This system can even be used in very small devices such as the ones shown in FIGS. 33b-33d (e.g. watchphone, wrist PDA device). FIG. 33b shows a wrist watchphone/PDA device, FIG. 33c shows a LCD display unit (3311) and a writing surface (3312) which are preferably located in the opposite side of the watch unit (3313). A pointing device (3314) having preferably a structured tip surface of the invention, is provided to input data by writing on the writing surface. It is understood that an electronic device, itself, may be equipped with a writing tip of the invention provided within a desired location of said device.

By using a well-structured pointing tip, a good microphone, and a sophisticated recognition engine, any surface on the device may be used for writing on said surface. For example, as shown in FIG. 33d, the user can input data on any surface of, for example, a watchphone metallic bracelet (3315).

Depending on an electronic device design and/or concept, at least on of, the microphone and/or the recognition system, may be integrated within the pointing device (e.g. a pen) or within the electronic device itself. Of course, in case of the stylus computer those components may be integrated within the stylus computer.

One advantage of using the HWSRS, is that it can be incorporated in every electronic device without, eventually, the need of deforming those devices.

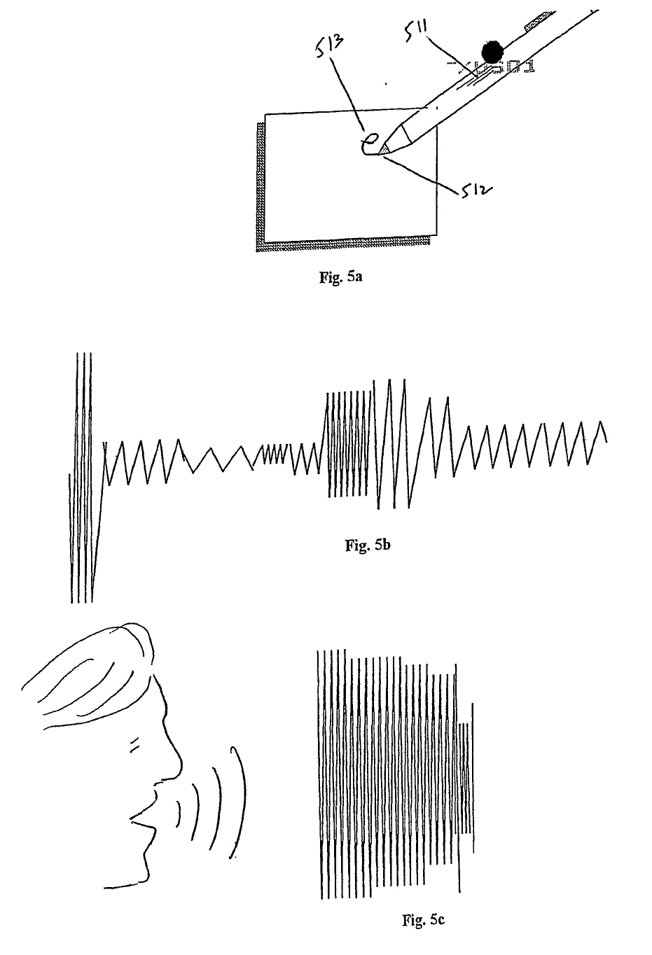

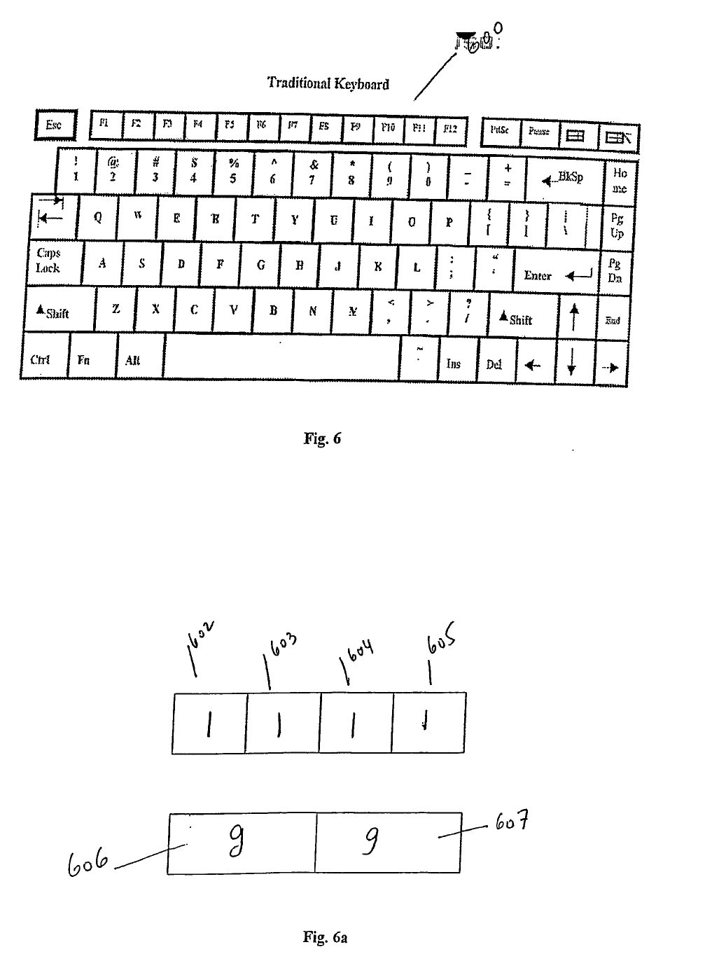

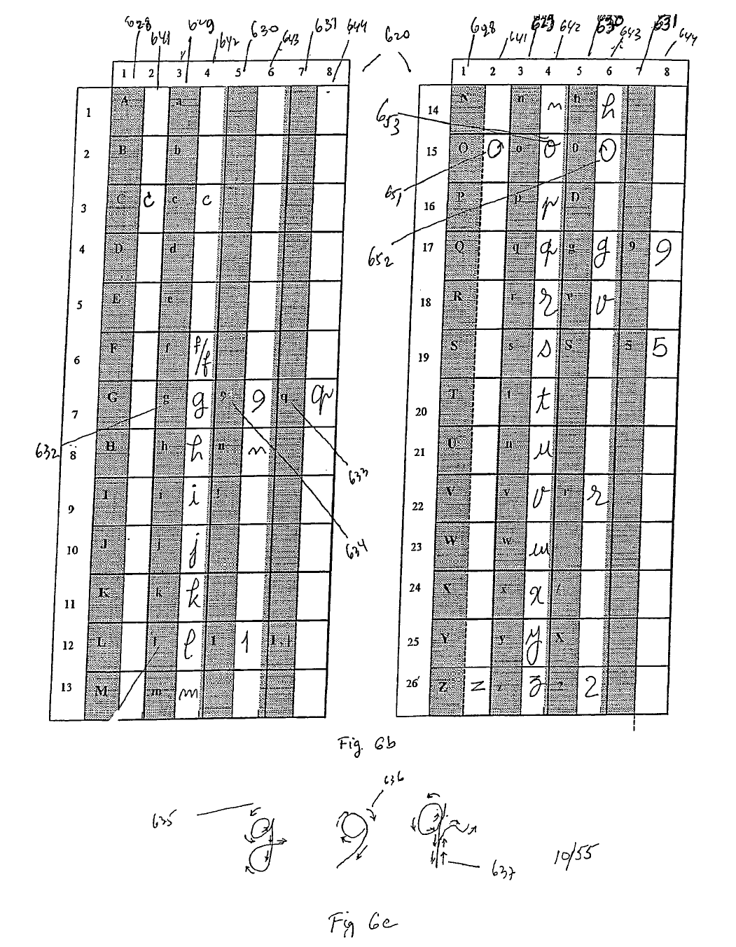

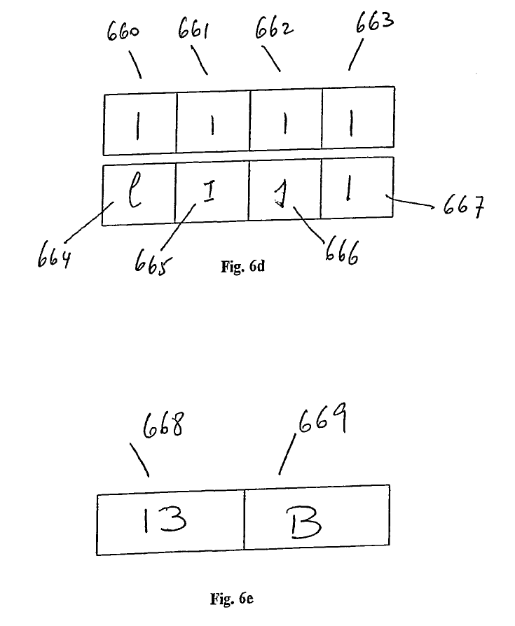

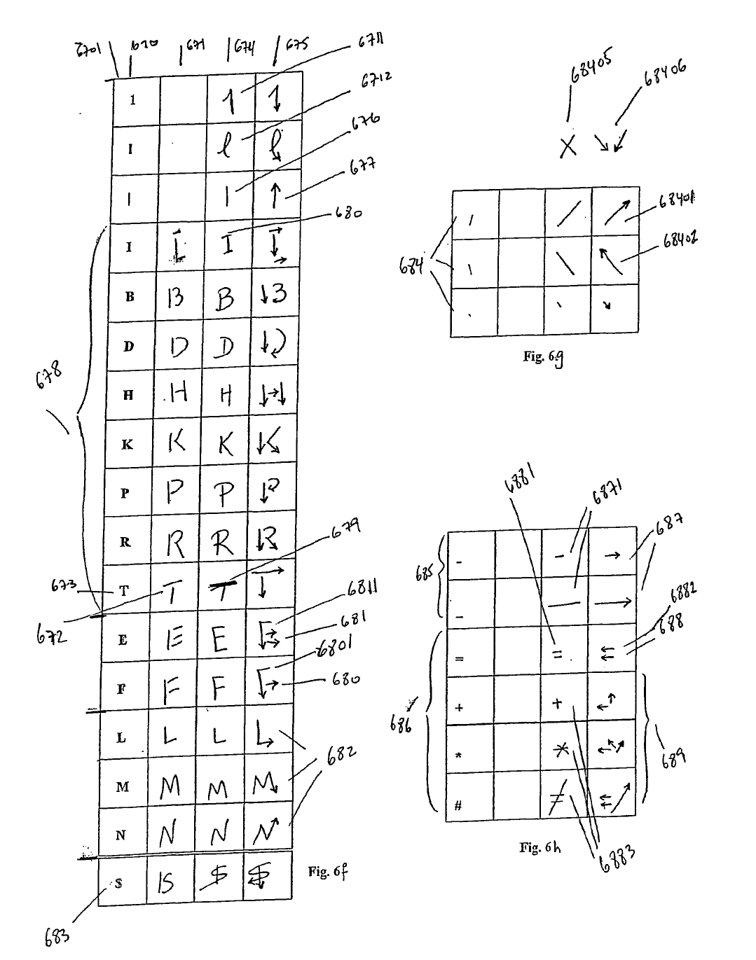

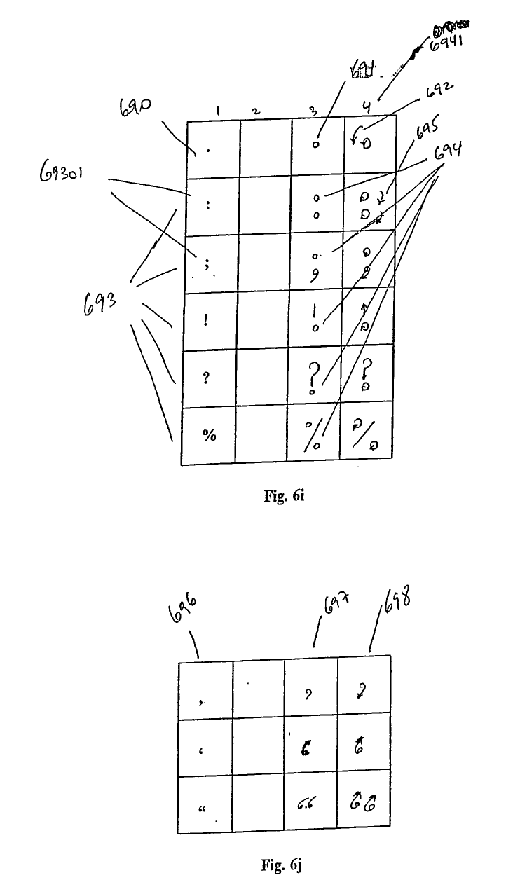

FIG. 6 shows a traditional computer keyboard (600) containing letters, numbers, punctuation marks, and other symbols for writing an appropriate text or data. As is shown in FIG. 6a, when writing the keyboards characters by hand, some of those characters, such as “1”, “l”, “|”, “I” (602-605), or “9”, “g” (606-607), etc., may look almost alike. Distinguishing between those characters will be impossible by a traditional hand writing recognition system or even by the humans. This problem can be solved by using a structured pen tip and the HWSRS. Hereafter, some of most important cases are described.

FIG. 6b shows a table (620) containing roman uppercase letters arranged in a column (628) of the table, and the lowercase letters arranged in another column (629). Some of the characters and numbers, similar to those letters, are written in next columns (630, 631). Proposed hand-written symbols for those who are similar, are shown beside each of them in white columns (641-644). Even the user himself, at his convenience, can create his own hand written fonts, symbols, and written commands.

As shown, for some characters such as the letter “g” (632), there are some apparently other similar characters such as the letter “q” (633), or the number “9” (634). To permit the HWSRS to easily distinguish between them, and because the HWSRS works on the sound waveforms and patterns, of written symbols, as shown in FIG. 6c, the user may write those letters, by using different directions ((635-637) for each. This will cause different sound waveforms and patterns for each character, which then, may easily be distinguished.

They will be patterned and memorized, according to the sound produced while writing each of them. At each moment a user can create a new symbols, or delete an old one. While writing symbols, the HWSRS, compares them with the already patterned and memorized symbols. If the system finds a pattern which matches with the inputted symbol, it selects that pattern as the one entered.

As mentioned before, one objective of this system is to provide users, with a familiar input system and device. This is a very important issue because people reject electronic devices with complicated input systems. The traditional handwriting characters and standards should be respected. Nevertheless for better accuracy some of advantages and characteristics of this system may be used. For example, letter “O” (uppercase), may be written in opposite clockwise direction (651), while the number “0”, maybe written in clockwise direction (652). They create two different sounds and therefor two different sound waveforms. The lowercase letter “o, may be written, as most people usually write (653).

There are some more specially difficult-to-distinguish characters. For example, as shown in FIG. 6d, if they are not differently hand written, the lowercase letter “l” (660), the uppercase letter “I” (661), the number “1” (662), or the character “|” (663), may never be distinguished by a traditional hand writing system. To distinguish them from each other, they can be written as in different common forms (664-667) respectively.

In addition, as shown in FIG. 6e, discontinuously written letters, signs and numbers, such as upper case letters, “B” (669), or the number “13” (668), etc., may also be confused by a traditional hand writing recognition system.

FIG. 6f shows a group of characters (670) that whole or part of them consists of a straight vertical line that may naturally be written separately from the rest of the same character (671). Because the handwriting recognition system does not know the location (on a surface) where those parts are written, for example, it can not know if a written symbol (672), relates to the letter “I” (673), or to two separate characters, “|−” or (I−), etc.

By using the HWSRS, the above mentioned problems may be solved without deforming those characters. The third column from left (674), shows the hand written characters corresponding to the printed characters of the first column from left (6701). As it is shown, non of those written characters has been deformed. The only rules a user must follow, is the (naturally common) directions by which the pen tip must stroke on the writing surface. First column from right (675) shows proposal for directions for each written character. It is understood that other directions may be considered as well, even by the users. As mentioned before and shown here, lowercase letter “I” (6712), and the number “1” (6711), can be written differently. Character “|” (676), may be written by a straight line in upward direction (677). Upward direction is not a common direction to write a character. The reason to use it for this character, is that this character is not often used.

Now we can use a downwardly written straight line to write a lot of other characters and permit to distinguish them from each other and avoid confusion. A straight line written in downward direction may always be considered by the system, as a commencing part of a discontinuously written symbol. When this line is written the system expects to receive more written graph(s) (e.g. strokes) to be followed after that line. By this method uppercase letters such as “I, B, D, H, K, P, R, T” (678) and the character “$” (683), may be written normally and been recognized by the system. To not confuse the system, it must be noted that, as it is known by hand writing principals, two different size of horizontal lines should be used for writing characters, a short one and a long one. For example, the horizontal line (679) used to write the letter “T”, must be importantly longer than horizontal lines (680) used for letter “I”. This will permit to avoid confusing situations while writing, for example, the letter “I”, or two consecutively written characters, “T−”.

Concerning the uppercase letter “F”, to not confuse the uppercase letter “F” with, for example, the uppercase letter “I”, first an upside down “L” form continuous line (6801) should be written, followed by one small size horizontal line (680). Also, to not confuse the uppercase letter “E” with, for example, the uppercase letter “I” continued by the character “−”, first an upside down “L” form continuous line (6811) should be written, followed by two small size horizontal lines (681). Uppercase letters, “L,M,N”, may be written by a continuous line (682), as shown.

To make the system simple, we can consider that all non-text-related characters having a straight line shape or starting with a straight line, may be started in opposite direction relationship with text related characters having the same characteristics.

With reference to FIG. 6g, three more characters (684), having common characteristics are shown. They all are straight diagonal lines. By writing the characters “/,\”, in upward direction (68401-68402), we avoid the possible confusion with the uppercase letter “X” (68405), because the letter “X” is normally written by two downwardly written diagonal lines “\/” (68406).

FIG. 6h shows another group of symbols, which have a common characteristic. They all have at least a horizontal line, written separately. This group of characters may also be divided to text related group (685), and non-text character group (686). The text related characters, “−” and “_” (6871), have two different lengths, respectively, short and long. They can be written as commonly, from left to right direction (687). Other symbols related to non text character group, preferably, may start with a short right-to-left horizontal line (6882). After writing this line, the system expects additional written information to complete the desired symbol. For example, by receiving an additional short right-to-left horizontal line (688), the system understands that the character “=” (6881), has just entered. Other proposal directions (689), for other symbols (6883), are also shown. It is important to follow the order of entering each discontinuous part of a symbol. They are illustrated according to the habits of most users.

With reference to FIG. 6i another important part of hand writing direction method is illustrated. The character “.” (690), is shown. Some other discontinuous characters such as “:” and “;” (69301), also contain the sign “.”, plus other signs. Again to avoid the confusion by the recognition system, the character “.”, may be written as a very small circle (691), in opposite clockwise direction (692). Other characters containing the “.” sign (693), may start (694) with this sign but in clockwise direction (695). The system understands that this is not the character “.”, and it expect the rest of the symbol to be entered. Column 4 (4941), shows the parts of symbols to be entered in order and as directions illustrated.

FIG. 6j shows additional printed symbols (696) available on a standard keyboard, the hand writing form based on common writing habits (697), and the direction to be taken for writing each symbol (698).

In addition, a special symbol or function sound waveform, produced by an action such as a knocking action (e.g. a single tap) by, for example, the pen tip on the writing surface, may indicate a space character or, “.” (e.g. dot character) to the HWSRS. This is specially important, because in many cases, the end of a word, a character, a symbol, etc., is signaled by a space character or a dot character. Each additional knocking action, represent an additional space. Also the end of a discontinuous symbol may be signaled to the system by an action, such as a contact of the pen tip on the writing surface (e.g. to produce a waveform) or a voice signal, etc.

FIG. 6k shows all printed symbols and characters of a standard keyboard and a proposal of a eventual direction to be respected while writing each symbol, based on principles described. As it is shown, non of the symbols has been deformed and the restrictions to be followed by the user are minimal and logical, therefor they will easily be adopted by the users. It is also understood that the principals and directions to write the symbols, proposed above, are only some examples among a variety of possibilities. Various omissions and substitutions and changes in the form and details of the disclosed invention may be made by those skilled in the art without departing from the spirit of the invention. For example, the lowercase characters may be written in importantly larger sizes in a text to inform the HWSRS to consider them as uppercase characters. This can facilitate there cognition system because it uses less patterns. Is must be noted that these methods and invention may also, and even specially, be applied for other languages such as Arabic, or Chines.

As mentioned, a user may “teach” his handwriting to a recognition system of the invention. At the beginning of use of an electronic device having for example, a structured writing tip and a hand writing recognition system of the invention, he may write all the symbols that he intends to write (e.g. a character set in a language, his customized symbols, etc.). The recognition system may produce patterns (e.g. key pattern) for each symbol, creating a “patterned character set” and use them for comparison purpose for recognition of written symbols (e.g. inputs) by the user in the future. During writing (e.g. texts, drawings, etc.), a user may add new symbols (e.g. new key patterns) to his “patterned character set”. As mentioned before, for better recognition accuracy of written symbols on a different surface having different structure (e.g. made from different materials such as a paper, a wooden table, etc.) a user may either create a new “patterned character set” for said surface by repeating the same procedure of “teaching” explained here-above on said surface, or he may write a few basic symbols (e.g. straight lines in different directions, circles in clockwise and counter clockwise direction, etc.) on said surface. Then the system may automatically create a new “patterned character set” for said surface, based on characteristics of the original “patterned character set” and the characteristics of said written basic symbols on said surface.

According to one embodiment of the invention a behavior of the user may signal to the system to repeat a symbol as much as desired. For example, while, or before, or after writing a symbol a user may tap, with his finger or with the eraser etc. on the writing surface to repeat a last written symbol.

According to another embodiment of the invention, to repeat a written symbol, a user may, for example, press a predefined button provided on the stylus to repeat a last written symbol. He may also repeat an already entered symbol displayed on the screen of the stylus and situated before a cursor (cursors will be described later in this application). A single press on a predefined button may repeat said symbol once. Each additional press (e.g. tap) will cause an additional repeating of said symbol. For continuous repeating of said symbol, the user may keep the button pressed. Said symbol will be repeated continuously until the user stops pressing said button.

A digitized waveform of a symbol may sometime not match to ant key pattern of the key pattern character sets, and therefore said written symbol may not be recognized by the hand writing recognition system of the invention. According to one embodiment of the invention, if a symbol is not recognized by the system the information relating to said symbol (e.g. its graffiti, its waveform, its location in a text, etc.) may be stored in a memory of for example, said stylus computer, to permit to a user an access to said information for an eventual manipulation. For example, said symbol may be a drawing to be saved or printed.

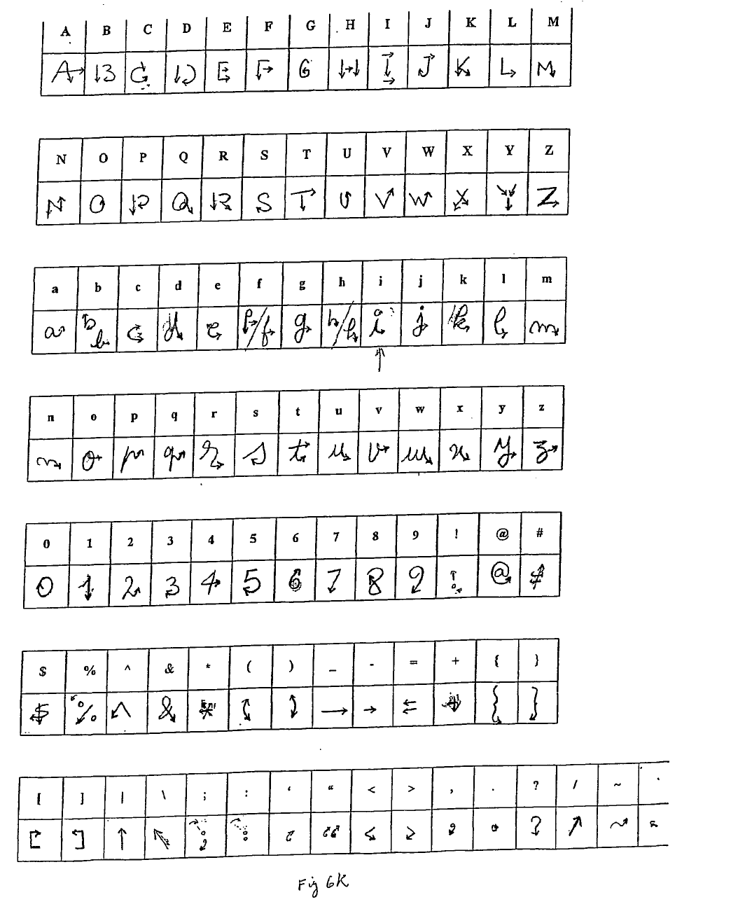

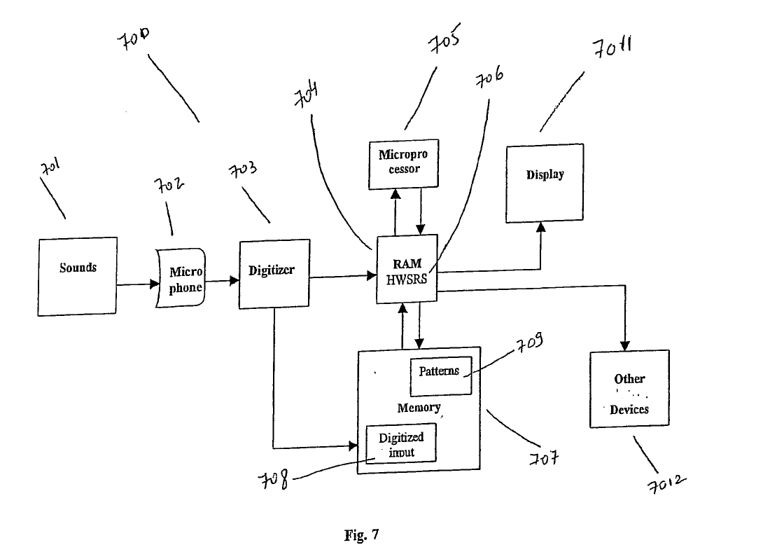

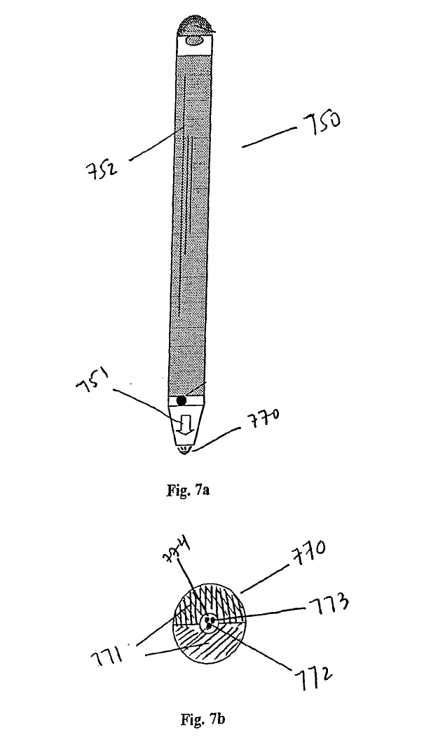

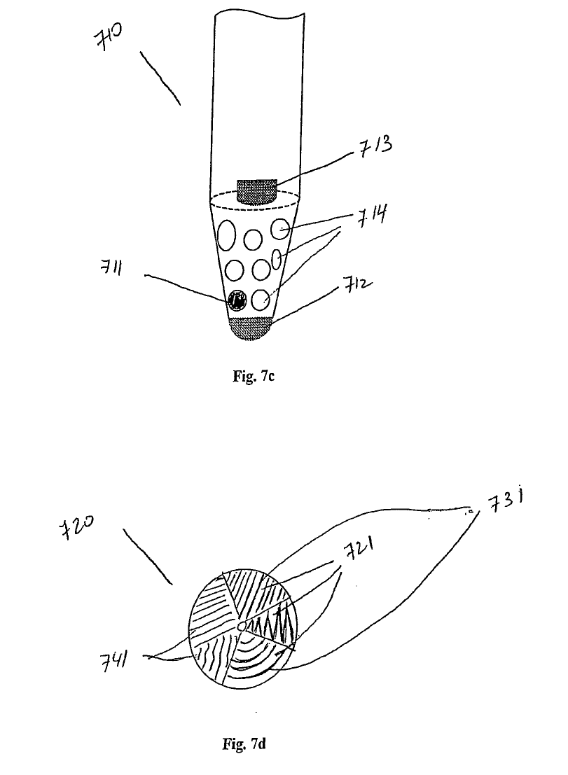

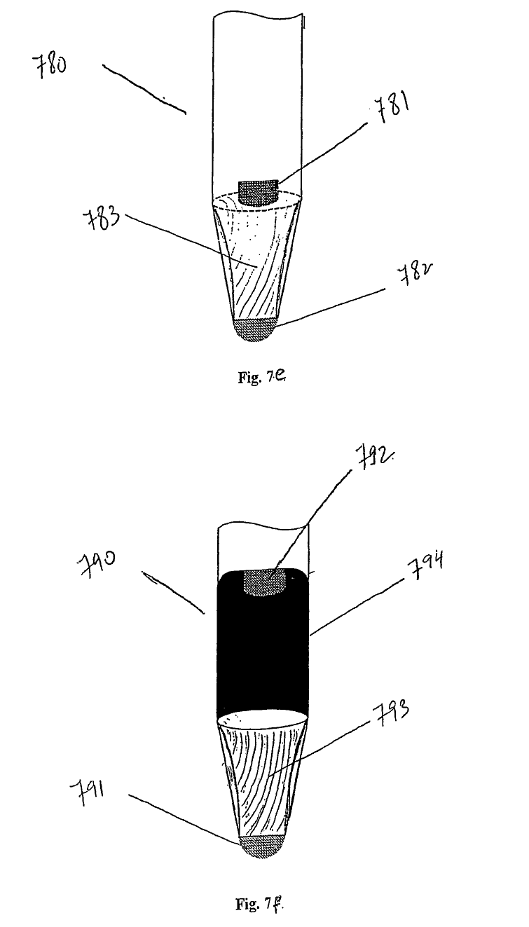

FIG. 7 shows a diagram 700 concerning the steps of input data (e.g. sounds while writing symbols by a stylus writing tip on a writing surface) and data output according to one embodiment of the invention. As shown, at the step 701 sounds produced (and maybe amplified) are perceived by a microphone at step 702 to produce waveforms. Said waveforms are transmitted to a digitizer as shown in step 703. Depending on processing procedure such as a real time recognition processing, the digitizer may for example, transmit said digitized waveforms to a RAM 704 of the stylus computer wherein a HWSRS system 706 may be installed. For reasons such as a delayed recognition processing, or simply to record said digitized waveforms, said digitized waveforms may be transmitted to a memory 707 of said stylus computer 700. Said digitized memorized input 708 may be used in further processing (e.g. a delayed HWSRS processing). Said memory 707 may also contain the digitized key patterns of waveforms of a variety of predefined symbols used by the HWSRS for recognition of the digitized input. After transmitting (in real time or delayed) a digitized input to the RAM 704 of said stylus computer, by using a microprocessor 705, the HWSRS of the stylus computer of said stylus computer compares said digitized input with said key patterns and tries to match said input to said key patterns. After selecting the key patterns having the highest similarity with a the digitized input, the system selects the digitized symbols corresponding to said selected key patterns. According to needs, said digitized symbols may either be stored in the memory 707, or be transmitted as an output to devices such as a display 7011 of said stylus computer, or an external device 7012, etc.

The embodiment described here-above, relates to a data entry method using sounds produced by contacts of a pointing device writing tip on a writing surface while writing symbols on said surface. According to another embodiment of the invention, as described before, sensors may be provided within a writing tip of a pointing device such as a stylus computer structured writing tip. Examples of said sensors and their structures have already been described in this application. As described, said sensors may perceive information such as pressure level (according to for example, vibrations, heat, etc.) exercised on different portions of the structured writing tip surface while writing a symbol on a writing surface, and conduct said information to a digitizer of the stylus computer for a recognition processing such as the one described in FIG. 7. It is understood that all embodiments and examples, described before and hereafter, relating to a hand writing sound recognition system may be applied for recognition based on any waveform produced by said pointing device writing tip sensors.

As mentioned before and shown in FIG. 7a, another objective of this invention is to provide the users with a familiar, user-friendly, highly portable small electronic device in form of a stylus (750). The stylus can function as a simple organizer, mobile communication device, PDA device, computer, etc. Preferably, it may also have a structured pen tip of the invention to produce hand writing sounds as input, a display (752), and the HWSRS. The stylus may have an indicating means (751) to permit the user to hold the stylus in a predetermined position in hand, while writing. This is because the structured pen tip should always generate the same sound (already patterned and introduced to the HWSRS) for the same direction. FIG. 7b shows an imaginary stylus computer writing tip front view. (770). The pen tip may also have the conventional writing means, such as ink (771), to simultaneously or separately, produce conventional hand writing documents when and if needed. Communicating means such as laser, infrared, etc., and other features such as camera (772), optical reader (773) or the like, may be provided within the pen tip or anywhere else in/on the stylus.

According to one embodiment of the invention, as shown in FIG. 7c, a stylus computer 710 of the invention may comprise at least one microphone 711 to perceive the sounds produced by the stylus writing tip 782 while writing on a writing surface. Said microphone, may be a directional microphone. For a better perception, said microphone may be provided near the pointing tip 712 of the stylus computer.

According to one embodiment of the invention, at least one microphone may be provided inside the stylus computer body in a manner to perceive the sounds produced by the contacts of the pointing device tip and a writing surface while writing on said surface. Said sounds may be conducted into the stylus computer body. Sill, with reference to FIG. 7c, for example, a microphone 713 may be provided inside the stylus computer 710. To permit the passage of the sounds produced by the contact of the writing tip on the writing surface, towards inside the stylus computer body, holes 714 may been provided in the stylus computer surface body, preferably near the writing tip 712. Said holes may be designed in a manner to amplify said sounds passing into the stylus body. Also, the stylus writing tip 712 may be structured in a manner to contain holes permitting the passage of said sounds into the stylus computer body. FIG. 7d shows an example of a writing tip 720 of a stylus computer. As shown, for example said writing tip may be designed in a manner to have empty passages (e.g. holes) 721 between the structured parts 731. Also, sensors on said writing tip, may for example, conduct the vibrations produced by the writing tip on the writing surface, into the stylus and produce sounds which will be received by said microphone located inside the stylus.

To amplify the sounds produced by the writing tip on a writing surface, an amplifying means may be provided within the stylus computer. FIG. 7e shows a stylus computer 780 having an amplifying means 783 having an exponential form (e.g. similar to the form of conventional loudspeakers). Sounds of contacts of a pointing tip 782 with a writing surface while writing with said pointing tip on said writing surface may be conducted inside said amplifying means 783 and being perceived by a microphone 781 located in an appropriate location (e.g. at other end of the amplifying means).

Sounds of contacts of a pointing tip with a writing surface while writing with said pointing tip on said writing surface may still been more amplified. According to one embodiment of the invention, as shown in FIG. 7f, to amplify said sounds, an amplifying means such as resonating chamber 794 maybe provided within a stylus computer 790. The sounds produced by contacts of the stylus writing tip 791 on a writing surface may be conducted in a said resonating chamber 794, wherein said sounds may be amplified. A microphone 792 may be provided within said chamber to perceive said amplified sounds. This amplifying procedure may be in addition to another amplifying procedure such as, already described exponential means 793. It is understood that any transmitting and amplifying means, known by the people skilled in the art, may be used for perception of a high quality sounds. For example, the amplifying chamber may have any form, structure, maid from any materials, etc., for the amplifying purposes.

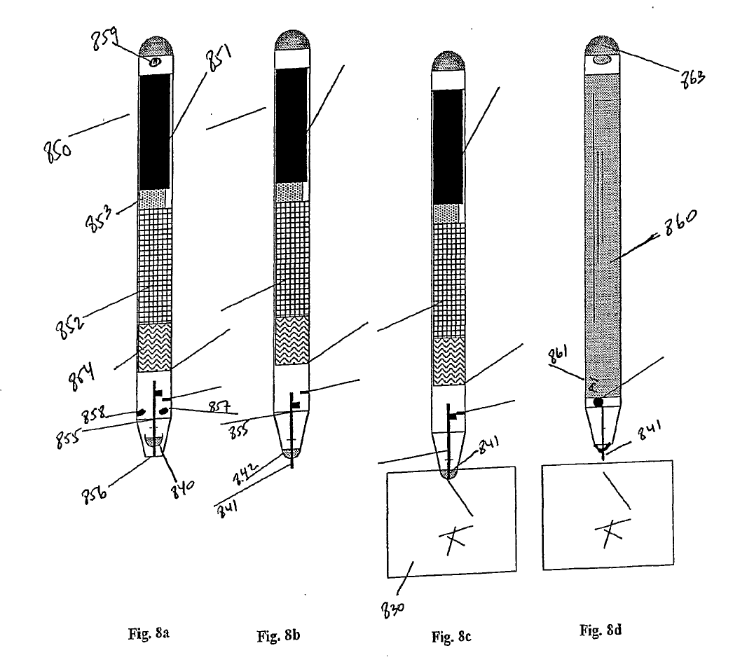

As shown in FIG. 8a, the stylus (850) may contain all computer features and additional means such as at least one battery (851), memory (RAM) (852), hard disk, microprocessor (853), a transceiver (854), a microphone (857), an optical reader (856), a position detection means (858), a writing start/end detection means (855), a speaker (859), a timer (not shown), LCD display (not shown), etc.

To avoid undesirable operations when the stylus is not in use, the structured pen tip may be in hidden position inside the stylus (840). FIG. 8b shows the structured pen tip in open position outside the stylus (842). It also shows a writing start/end detection means (855) having a pin (841). While the tip is in contact with the writing surface (830) as shown in FIG. 8c, the writing detection pin (841) is in inside position to indicate a writing status. When the user lifts up the pen tip (FIG. 8d), the detection pin (841) will exit to indicate a non-writing status. It is understood that the detection means described is only an example. Other writing start/end indication means and systems may also be used. For example one or more sensors may be installed in the structured pen tip, to indicate the system a writing or a non-writing status. Also the sounds created by the contact of the pen tip with the writing surface may indicate a writing status. Silence may indicate a non writing status.

With continued reference to FIG. 8d, the stylus (850) may have one or more LCD displays (860) to display the data (861). It also may have an eraser (863) for corrections. The eraser surface may have a special texture to function as a conventional pen eraser on a writing surface, and simultaneously create special sound to indicate the HWSRS of an erasing status. Similarly to structured pen tip, eraser surface can also be made from a special texture to produce plurality of sounds according to directions of its strokes on the writing surface. Of course, those sounds should be different from the structured pen tip sounds. Commands or functions such as, on/off, send/receive communication, etc., may be assigned to the sounds produced by eraser, when writing corresponding words or symbols on a writing surface. Of course same microphone or an additional microphone (preferably directional) may be provided to clearly capture the sounds generated by said eraser contacts with the writing surface.

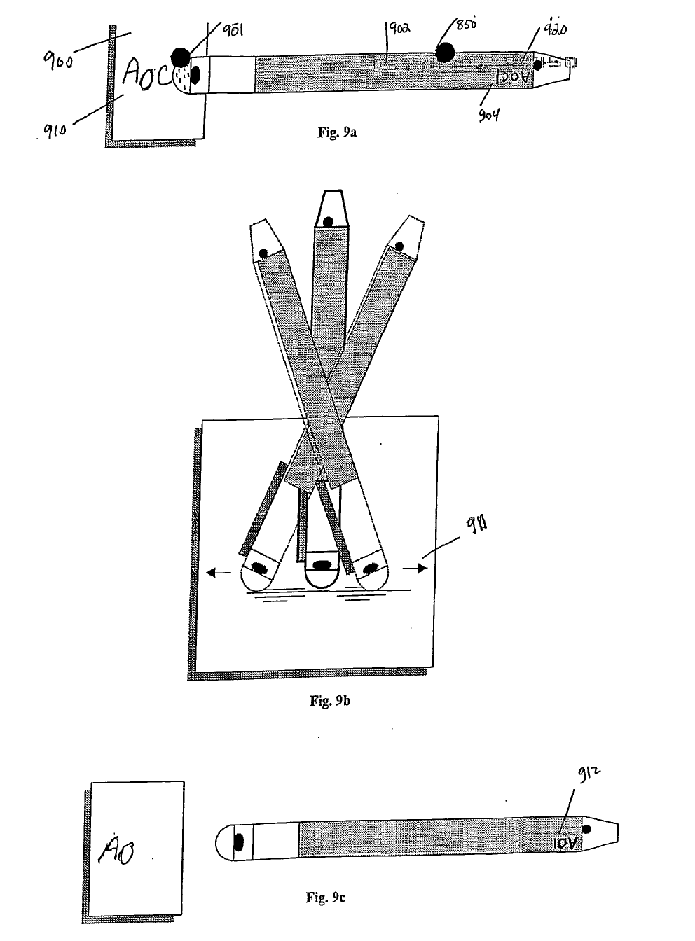

FIG. 9a, illustrates a writing surface such as a paper notepad (900) with three handwritten characters (910) written by a user using the stylus (850). The characters are digitized (920) by the stylus computer and displayed on the LCD display (902) of the stylus. A cursor (904) is locating after the last character entered. If a user wishes to erase, for example an erroneously entered character, he can use the structured eraser (901). As shown in FIGS. 9b and 9c, by giving for example, a straight stroke, in for example, left or right direction (911), on the writing surface, the sound produced by the contact of eraser and the writing surface, inform the HWSRS of an erasing action. The last character entered will be erased from the display (912) and the memory of the stylus computer. To erase an additional character, an additional stroke may be introduced, and so on. If a user desires to erase a character other than the last one, he can place the cursor next to that character and produce the erasing procedure as described before. Because this stylus may also be capable to produce conventional written documents, for the reasons of practicality, more than one stroke may be needed to erase simultaneously, a character on a notepad. In this case the computerized erasing system may be modified to permit other erasing systems. For example, consecutive short interval strokes (as in traditional hand writing erasing procedure with a pencil rubber) may inform the HWSRS to erase one character. To erase the next character at least a short pause may be applied. For better perception of the sounds produced by said eraser strokes on a writing surface, at least one additional microphone (preferably directional) may be provided within or near said eraser. It is understood that other possible erasing procedures based on this principle, may also be applied. Also users can create their own customized procedures or symbols or actions for erasing.

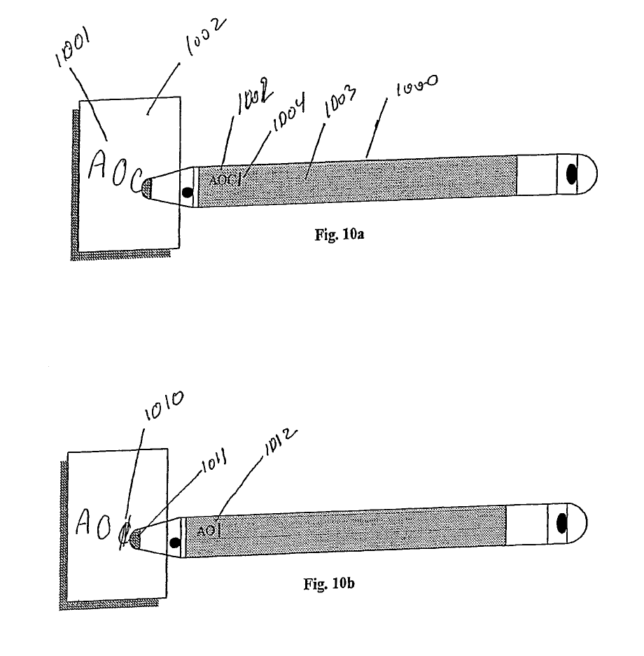

According to yet another embodiment of the invention, erasing procedure described before may be done by the structured pen tip. As shown in FIG. 10a, a text (1001) is written by the stylus (1000), on a writing surface (1002). Those letter are digitized (1002) and displayed on the LCD display (1003) of the stylus. A cursor bar (1004) is located after the last character entered. As shown in FIG. 10a, if the user desires to erase a character, as in traditional hand writing procedure, he can cross out (1010) on a writing surface with the pen tip (1011) to erase the last letter before the cursor from the memory of the computer. The sounds produced by the strokes of the pen tip on the writing surface, may inform the HWSRS of an erasing status. The letter before the cursor will be erased from the memory and display (1012). For each additional character to be erased, a same procedure is needed.

FIG. 11 shows the stylus type computer (1111), described before, having flat display (1110) according to one embodiment of the invention.

FIG. 11a illustrates the stylus computer (1100) according to one embodiment of the invention. This stylus may have some or all of the features described before. It may also have a curved (e.g. convex) LCD display unit (1101) covering at least a portion of stylus computer surface. FIG. 11b demonstrates that display in semi-unfolded position (1112). The dimensions of the surrounding surface of an average conventional stylus is about 17 centimeter long by 4 to 5 centimeter large. To overview the whole display a user may rotate the stylus in his hand.

Seventeen centimeter, is almost the size of a standard text line written on an A3/A4 paper sheet. As shown in FIG. 11e, a LCD display screen (1121), covering a standard stylus form computer with dimension of 17×5 centimeters (1122), is large enough to display a real size text and permit real size manipulations of that text. It is also large enough to view pictures or to permit browsing on real size web pages. Combination of a user friendly hand writing input systems, as described before, and a large display as mentioned now, in a familiar apparatus in the form of a pen, creates a highly portable powerful miniaturized instrument. It can be manufactured in many versions such as simple digitizing pens used by everyone (e.g. reminder of shopping list for housewives), or as more sophisticated instruments such as mobile phones, PDA devices, or computers. One great advantage of this instrument is that there may be no need to carry a writing surface. The user can write the input on any surface available such as a table surface. It must be noted that the display unit 1112 of the stylus computer may be detachably attached to the stylus computer and be connected to said stylus computer either by wires, or wirelessly. Said display may be flexible (e.g. made from plastic materials), so that, for example, when said stylus computer is not in use said display may be enrolled around said stylus, or enrolled and being attached to said stylus, or being inside said stylus computer or its cover. Said display may be detached and/or deployed (e.g. unfolded) for use. By using this concept, even larger displays (e.g. enrolling several times the stylus computer) may be considered for integration and/or use with the stylus computer. Also the stylus computer may be connected to any external display by means of wires, or wirelessly. If said display is wirelessly connected to said stylus, wireless telecommunication means (e.g. blue tooth, infrared etc.) may be provided within said display and/or said stylus.

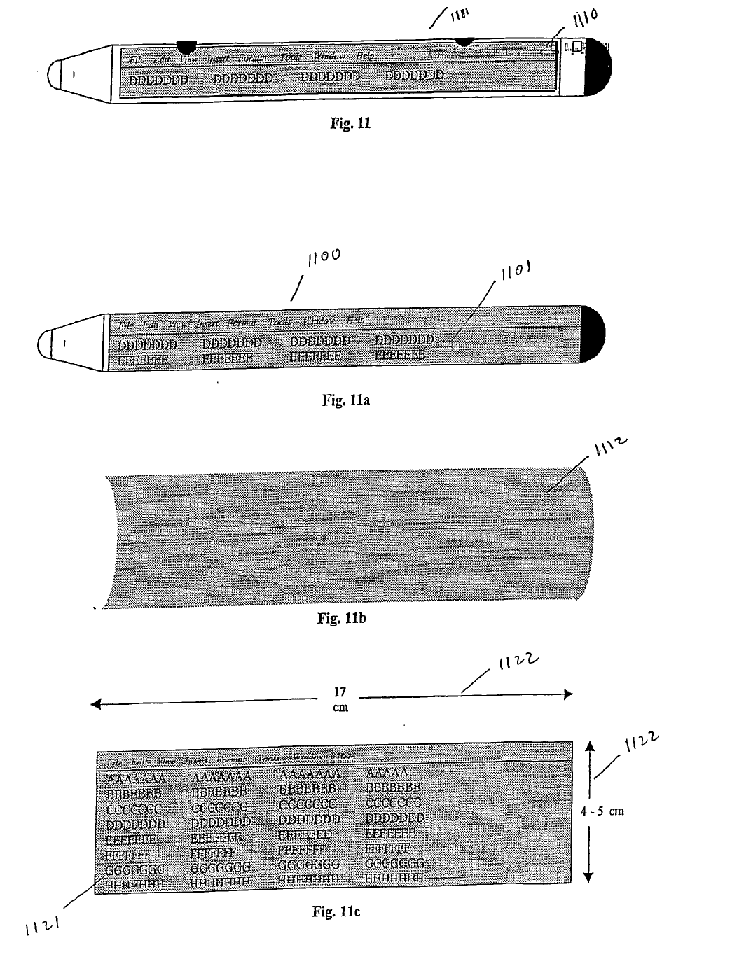

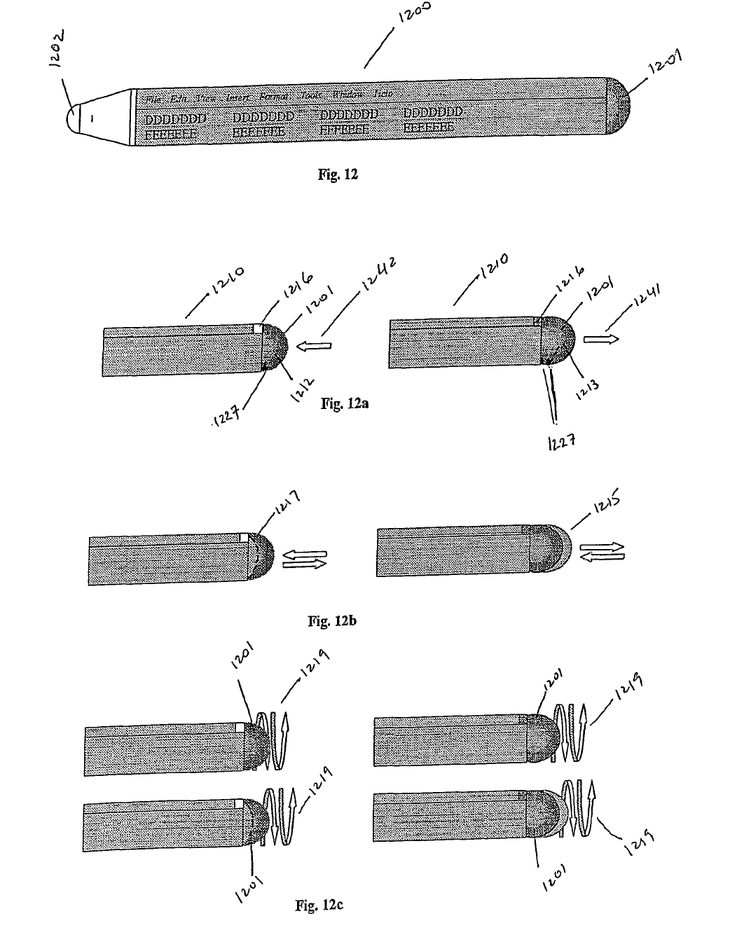

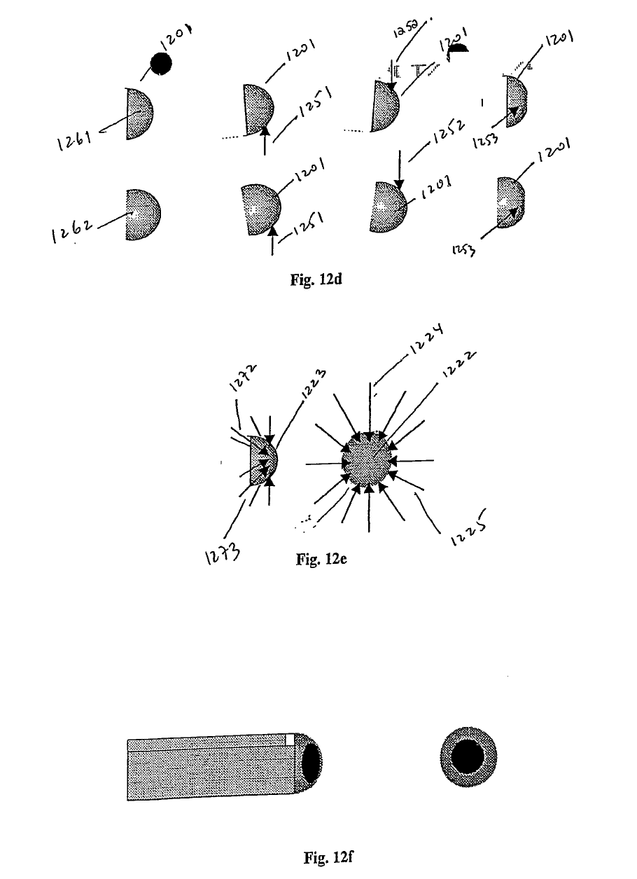

According to one embodiment of the invention, as shown in FIG. 12, the stylus-type computer (1200), may also be equipped with a button-type-mouse (e.g. pointing and/or selecting device) (1201), preferably installed at the opposite side to the pointing tip (1202). With reference to FIGS. 12a to 12e, some possible physical movements of the mouse are shown. FIG. 12a shows the mouse side (1210) of the stylus, wherein a mouse (1201) is installed. The mouse can have one, two, or more installation positions on the stylus axis, such as inner position (1212), or outer position (1213). To change installation positions, the mouse may be pulled out (1241) or pushed in (1242), in stylus axis. An indication mean (1216), or indicating marks (1227), may indicate the mouse positioning. As shown in FIG. 12b, the mouse can also have different click systems, for example, one to the inside direction (1217) of the stylus, and one to the outside direction (1215) of the stylus.

Yet, as shown in FIG. 12c, the mouse (1201) may also have a rotating movement (1219) in opposite directions for each positioning or clicking status.

Still additionally, as illustrated in FIG. 12d, the mouse (1201), in every positioning status such as inside position (1261) or outside position (1262), may be pushed in all directions (1251, 1252, 1253, etc.) perpendicularly to stylus axis. FIG. 12e shows the side view (1223) of the mouse, and some of pressure directions (1272, 1273, etc.) on that mouse. It also shows the front view (1222) of the mouse and some pressure directions (1224, 1225, etc.) on it. It is also understood that the movement explained here, are some examples among a variety of possibilities. Various omissions and substitutions and changes in the form and details of the disclosed invention may be effectuate by those skilled in the art without departing from the spirit of the invention. For example, as shown in FIG. 12f, the stylus type computer mouse may be equipped with a bull system, similar to those used in lap top computers, and be manipulated in the same way as in laptops.

The above explained mouse movements and/or combinations of them may be assigned to variety of computer commands, functions, system modes, etc. They permit a complete, easy and fast manipulation of data and functions of the stylus-type computer. Some different embodiments will be described hereafter, to demonstrate this matter. It must be noted that the examples that explained before, or explain hereafter show only a few methods as samples. It is appreciated to those skilled in the art that many variations of the combinations of assignments can be employed without departing from the spirit of the present invention.

According to one embodiment of the invention, the stylus computer display may be similar to any computer display. It can contain program icons, menus, show different windows, etc. For example, as shown in FIG. 13a, when opening a word processing program, the display (1300) may show at least two different sections. A menu section (1301) located, for example, on the top of the screen and a text section (1302) located, for example, under the menu section. The menu section may contain one or more menu lines (1303), each line containing a list of menu bar titles (1304) that may be opened when needed. In this example a display showing one of the lines of a menu list is illustrated. It is understood that a display unit of the stylus computer may show more than one line of a menu list at a time, according to needs and/or limits of the surface available, etc.

According to one embodiment of the invention a user can scroll the menu lists by using the mouse (1309). For example, for finding a menu list containing a desired menu bar, the user first positions the mouse in menu mode which, for example, is the inside position (1307). Then, as shown in FIGS. 13b-13c, by rotating the mouse in any direction (1308), new menu lists (1313, 1323, etc.) scroll on the display. When a menu list containing a desired menu appears, the user stops rotating.

According to one embodiment of the invention, a user can navigate in menu lists by using the mouse. For this purpose, as explained before and shown in FIG. 14a, the user first locates the mouse (1400) in menu mode position (1401). At this moment the system is in menu list selecting mode. Then as shown in FIG. 14b, by pushing the mouse in stylus axe inside direction (1411), strong enough to cause a click, the system will enter the menu (bar) selecting mode and a menu (bar) selecting indicator mean (1412) may appear at a location on the menu list. At this moment the indicator may not point to any menu. Then, as shown in FIG. 14c, by rotating the mouse (1421), the menu bar selecting indicator will navigate on the menu bar titles (1422). If the selecting indicator reaches the last menu on list and the user continues to rotate the mouse, as shown in FIG. 14d the next menu list (1432) will appear and the menu bar selecting indicator will jump to the first location (1433) of the new menu. It will continue to advance as shown in FIG. 14e, until the user stops rotating the mouse because, for example, the indicator has reached the desired menu. To exit from menu mode and go back to menu list selecting mode, as shown in FIG. 14f, the user may, for example, click the mouse in inside direction and simultaneously, shortly rotate it (1451) in any direction.

FIGS. 15a to 15h show an example of navigation in the menus and functions by mouse manipulations. With reference to FIG. 15a, a stylus-type computer (1500) is shown. As described before, the upper portion of the LCD display (1503) is assigned to menu lists. To select a function in a menu bar, the user has to view the menu list wherein that menu bar is situated. If, for example, the user wants to change a font, he has to go to corresponding menu list. For this purpose, first the user must positions the mouse (1501) at menu selecting mode, for example, in inside (stylus axial) position (1502). If the desired menu bar is not in current menu list (1504) and the system is in menu (bar) selecting mode, then, he rotates (1505) the mouse to advance the selecting indicator (1506) forward or backward, as needed, to reach the last menu bar title (1510), as shown in FIG. 15b. If the user continues to rotate the mouse, then next menu list (1520) will be displayed, as shown in FIG. 15c. The menu selecting indicator will jump to the next location of new menu list. If, for example, still this menu list is not the one desired by the user, he will continue to rotate the mouse, advancing the menu bar indicator (1521) until it reaches the last menu title and as shown in FIG. 15d, a new menu list (1530) appears on the screen. Again the menu bar indicator jumps to the next location of the new menu list and continues to advance in menu titles until the user stops rotating the mouse, stopping the indicator on a menu title (1531). If by mistake, the selecting menu title indicator was advanced more than needed, as illustrated in FIG. 15e, the user can rotate the mouse (1501) in the opposite direction (1541) bringing back the menu bar selecting indicator and stopping it on desired menu title (1542). As shown in FIG. 15f, at this time the user pushes the mouse to the inside direction (1551) to click it. The system enters in function selecting mode and the menu bar (e.g. popup menu surrounding the pen surface and shown in extended flat position for demonstrating purpose) (1552) opens. A function selecting indicator (1553) is located on the current choice. As shown in FIG. 15g, to bring it to a desired choice, the user will rotate (1562) the mouse (1401) in the needed direction until the indicator reaches the desired function (1563). This popup menu may use principals similar to popup menus of computers. As shown in FIG. 15h, then the user again pushes the mouse to inside direction (1571) to click it. The function is selected and displayed on the menu bar title (1572), replacing the previous choice. Also the mouse exits the function selecting mode and returns to menu (bar) selecting mode.

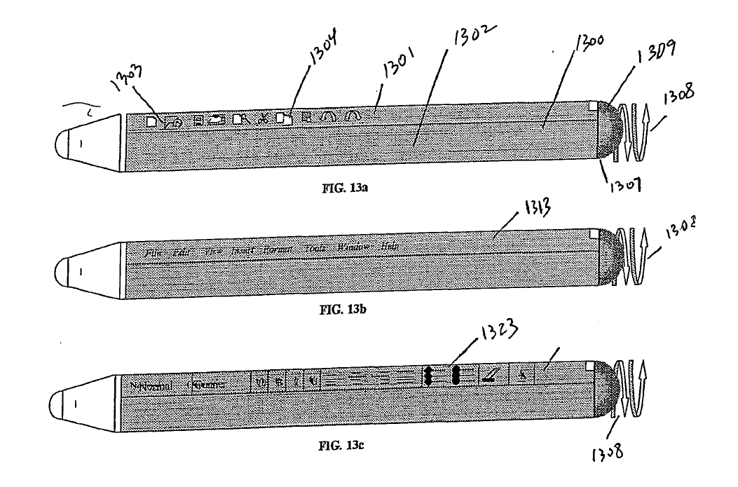

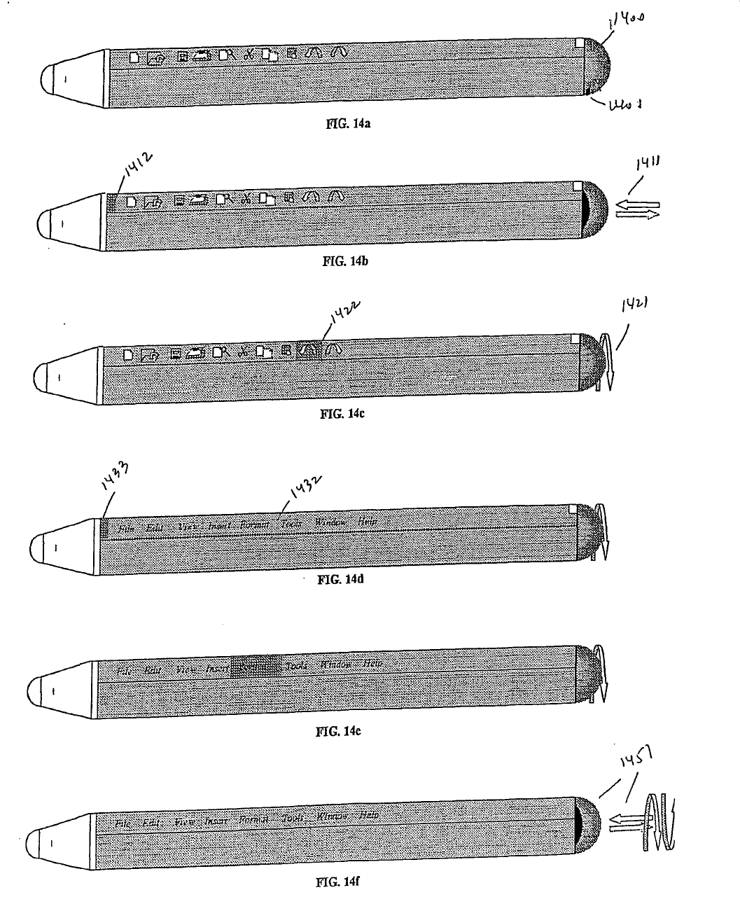

According to one embodiment of the invention, a text editing mode can be assigned to one of the mouse positions on stylus axis and by using the mouse rotating movements, while mouse is in text editing position, a user may scroll text document lines or pages. FIG. 16a shows a stylus-type computer (1600) having, for example all of the features and systems explained before. In this example, a text editing window (1601) is shown. The display unit is divided into two sections. The upper section (1602) is assigned to menu lists and the lower section (1603) to the text. In this example a display showing two lines of a text is illustrated. It is understood that a display unit of the stylus computer may show less or more than two lines according to needs and/or limits of the surface available, etc. The mouse button (1604) is in menu mode, for example, in inside position. As shown in FIG. 16b, the user, for example, pulls the mouse out (1610) and locates it in outside position and to enter the system in text editing mode. Then, as shown in FIG. 16c, he can scroll forward the text lines and pages (1608) by rotating the mouse in, for example, clockwise direction (1605), or scroll backward the text lines and pages (1609), as shown in FIG. 16d, by rotating the mouse in the opposite clockwise direction (1606).

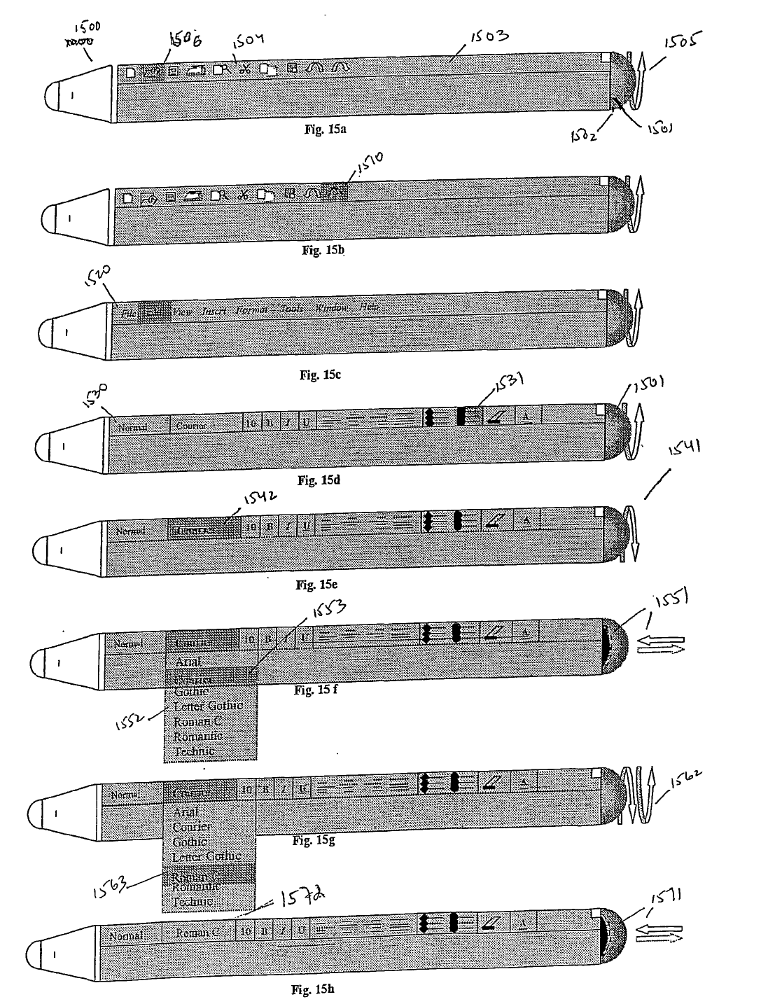

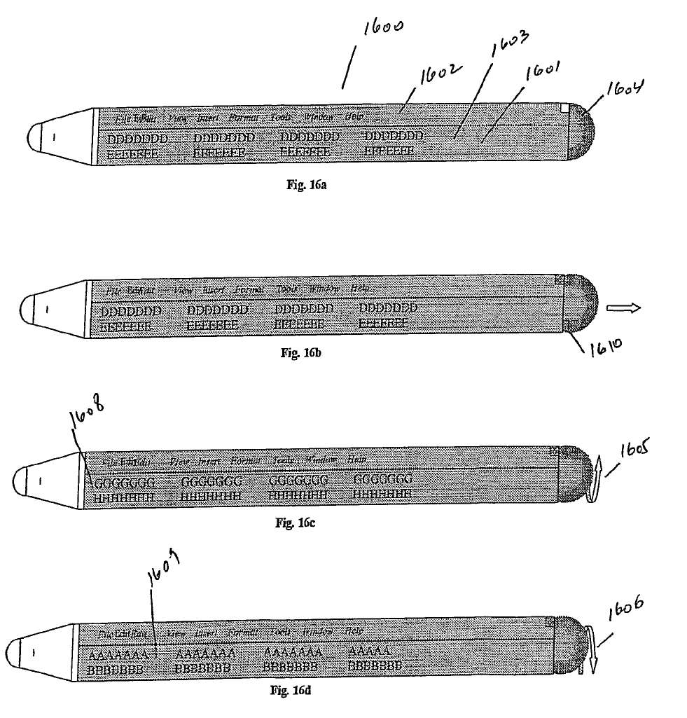

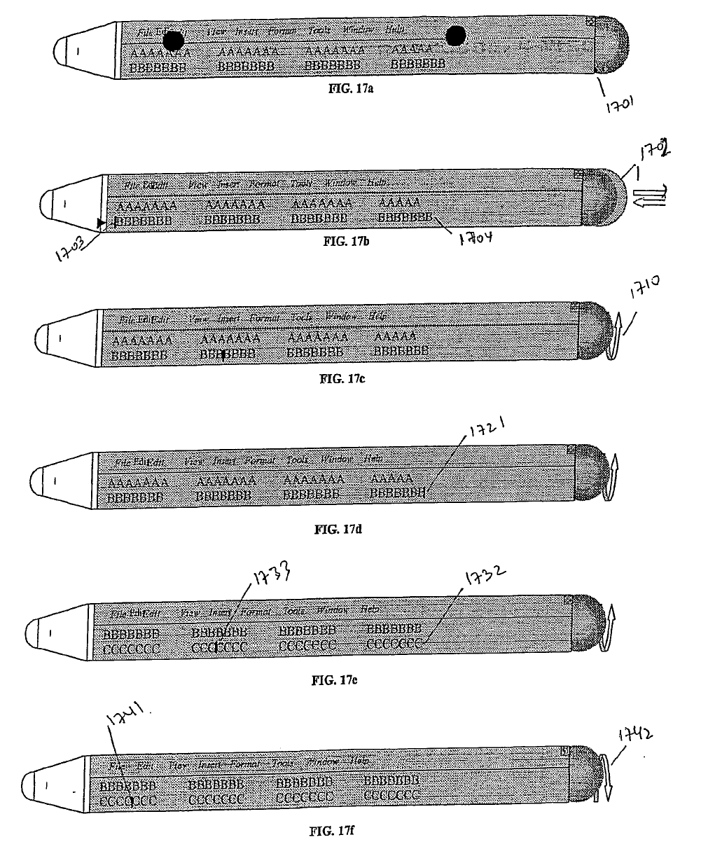

According to yet, another embodiment of the invention, also a cursor can be manipulated by rotating movements of a mouse. This matter is illustrated in FIGS. 17a-17f As shown in FIG. 17a, first a user must position the mouse in a position relating to text editing mode, for example, in outside position (1701). If the text navigating mode is in line scrolling mode, then as shown in FIG. 17b, the user clicks the mouse in outside direction (1702), to bring the system in cursor (character) navigating mode. If the cursor is in current page, it remains at the same position in the text. If the cursor is not in current page, then it may stay at its original location in the text or will be brought, automatically, to current page and will be located, for example, at the first position (1703) or last position, on the last line (1704) or any other predefined line or position in a line. Then, as shown in FIGS. 17c-17d, by rotating the mouse in, for example, clockwise direction (1710), the cursor advances between the characters until it reaches the last position on a line (1721). If a next line is available on the screen, the cursor jumps to the beginning of the next line and continues to advance as long as the user rotates the mouse. If the current line is the last line on the screen and the cursor reaches the last position on a line, then as shown in FIG. 17e, if the user continues to rotate the mouse, then the next line (1732) appears and the cursor advances in the next line (1733), and so on, until the user stops rotating. If the user desires to move the cursor in opposite direction (1741), he rotates the mouse oppositely (1742). To go back to line scrolling mode the user, according to one embodiment of the invention, pulls the mouse out to click it and simultaneously shortly rotates it.

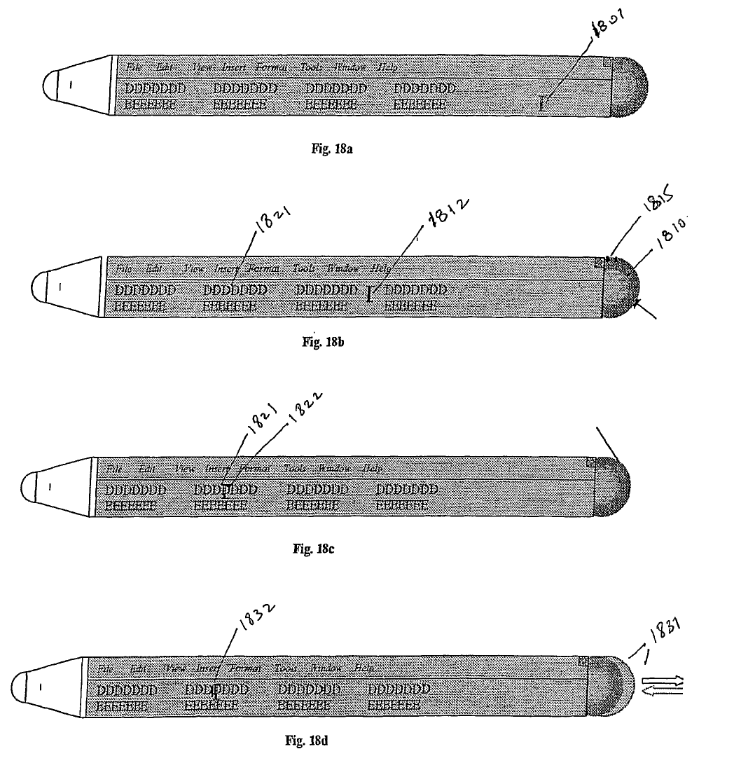

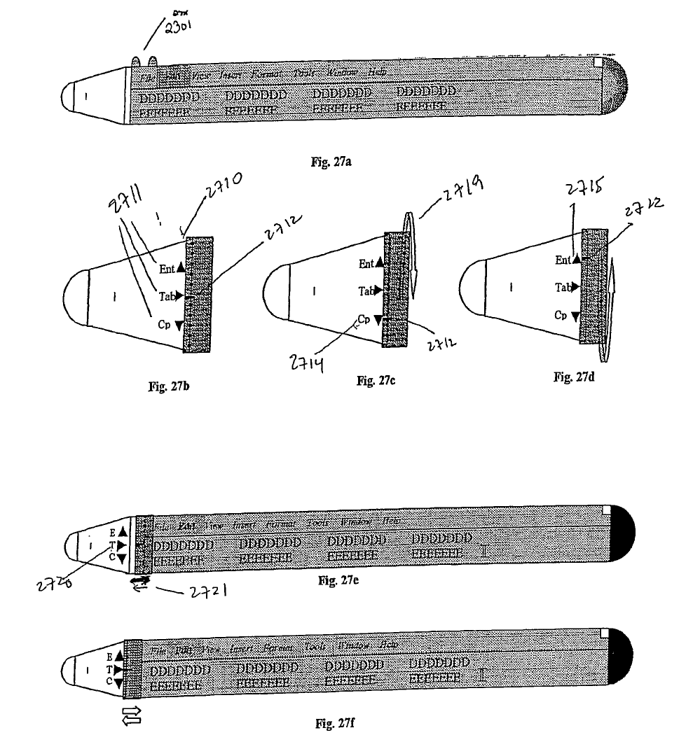

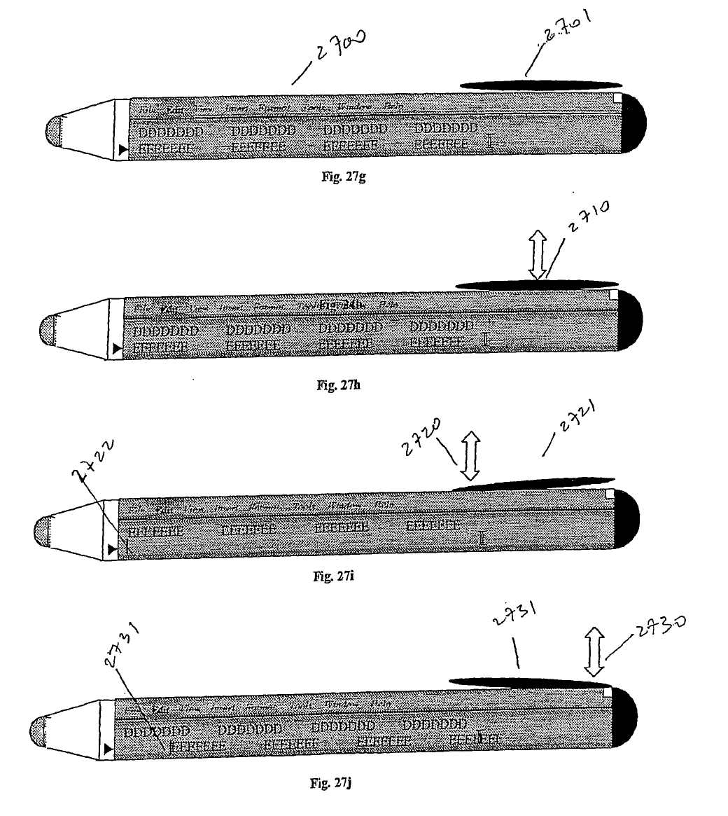

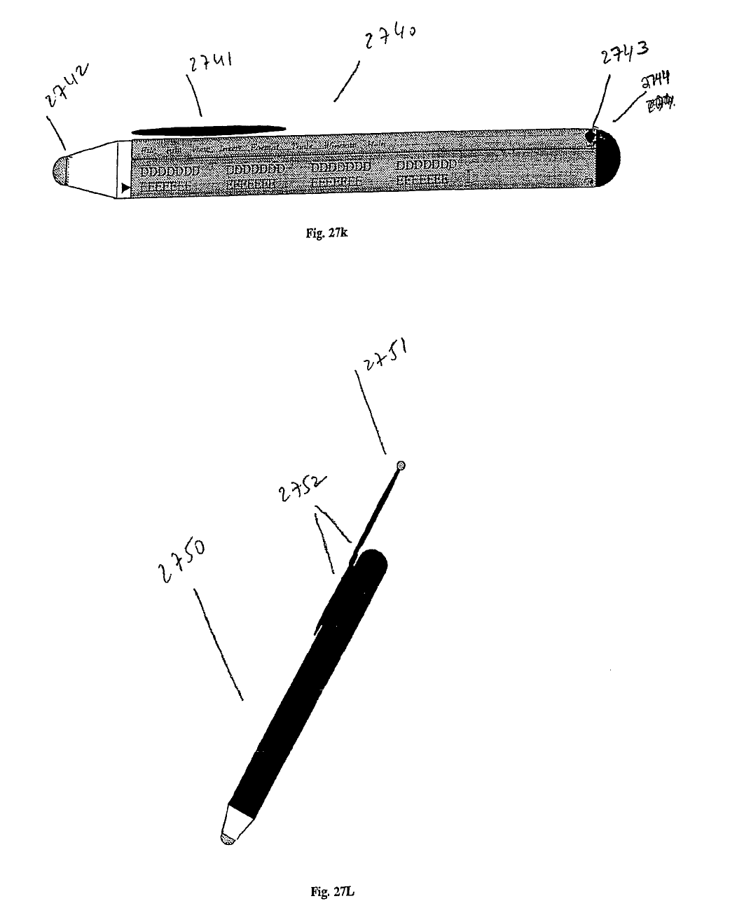

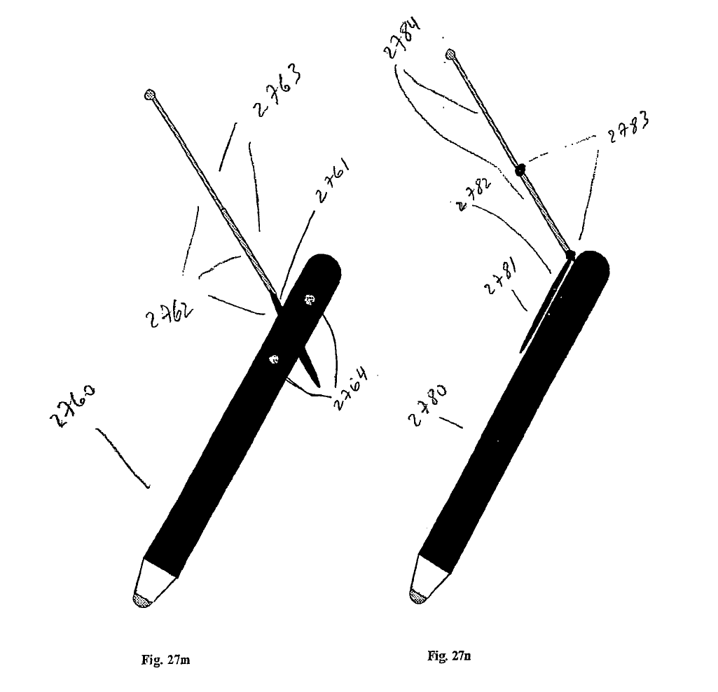

According to one embodiment of the invention, as shown in FIG. 18a, a text select indicator (1801), for example, similar to those used in computers, may be provided in the stylus-type computer device text editing mode. As shown in FIG. 18b, the mouse (1810) maybe used for moving (1812) the indicator on the screen. For this purpose the mouse may be in a position such as text editing mode, in this example, the outside position (1815). As shown in FIG. 18c, for example, to select a location (1821) in a text, first, the user, by perpendicularly to stylus axis pushes on the mouse, bring the indicator (1822) to that point. Then, as shown in FIG. 18d, by clicking the mouse in outside direction (1831), the user selects that point and a cursor (1832), installs there. To avoid confusion with other functions (e.g. passage from line scrolling mode to cursor manipulating mode), while clicking, the user should keep the mouse pushed for a longer time (e.g. one second). Instead of clicking the mouse, the user may either press a predefined button such as the one 2701, shown in FIG. 27g (e.g. a clip-type button which will be described later in this application) available on the stylus computer, or proceed another action known by the people skilled in the art.

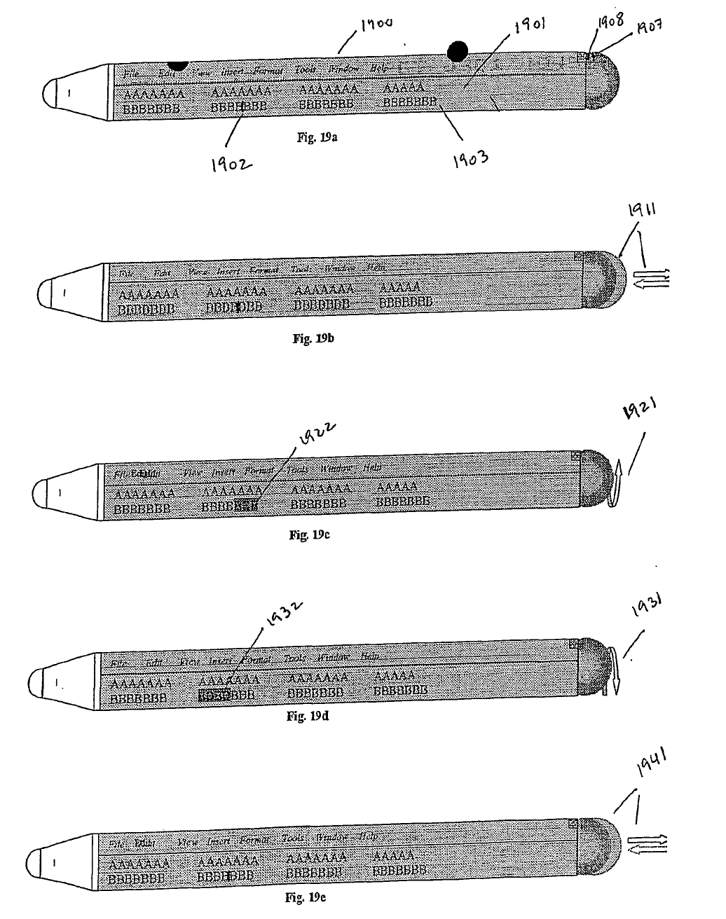

According to yet another embodiment of the invention, by using mouse movements, all, or a portion of a document or text may be selected. FIG. 19a, shows a display (1901) of the stylus type computer (1900) wherein a cursor (1902) is positioned on a specific location in a text (1903) and the mouse (1907) is positioned on the text mode, for example, in outside position (1908). If the system is in character/cursor manipulating mode, as shown in FIG. 19b, to enter the text selecting mode, the user pulls the mouse outward (1911), strong enough, to click it. He releases the button to permit it to, preferably go back to its initial outside position. To do select a portion of a text, the user now rotates the mouse in either clockwise direction or opposite clockwise direction. As shown in FIG. 19c, by rotating the mouse in clockwise direction (1921), the system starts to select progressively, for example, the text situated after the cursor position (1922), according to rotation degree until the user stops rotating. If the user rotates the mouse oppositely (1931), then, as shown in FIG. 19d, starting from cursor position, the system starts to select progressively, for example, the text situated before the cursor position (1932), according to rotating degree, until the user stops rotating. If the user wants to proceed to operations such as, copy, clear, changing font, etc., on the text selected, he may change the mouse position to menu selecting mode position (e.g. inside position). The system will proceed to next procedures, described hereafter.

As shown in FIG. 19e, if the user wants to exit the text selecting step, he pulls the mouse towards outside direction until it clicks (1941) and releases it. The system goes back to character (cursor) manipulating mode.

As shown in FIG. 20a, a text (2001) is selected by, for example, the procedure described before. To apply, for example, an editing procedure such as copying, on this selected text, the user, as described previously, brings the mouse to menu selecting mode (2002) and looks for edit menu (2003), selects it, and then as shown in FIG. 20b, by clicking the mouse to inside direction (2010), opens the menu (2021). Then, as described before and shown in FIG. 20c, by rotating the mouse (2031), the user locates the function selecting mode on the “copy” function (2032). Then as shown in FIG. 20d, by pushing the mouse again in inside direction (2033), strong enough to make the button clicking once, the system copies the text and exits from function mode.

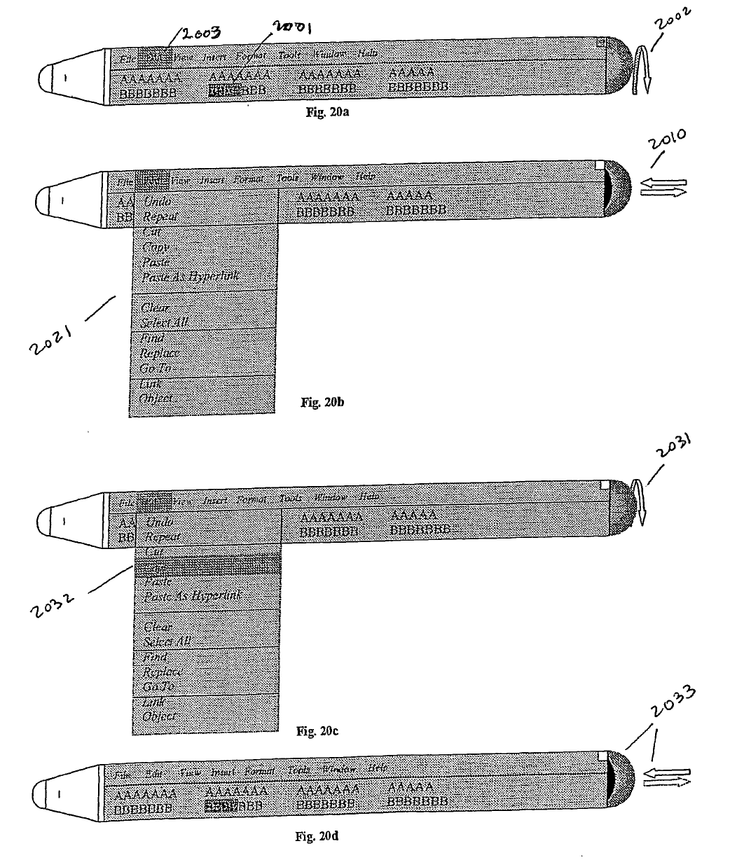

To make an operation such as, pasting the copied text elsewhere, as known in computer domain, the user first must indicate the pasting location to the system, by means of a cursor. For this purpose, as shown in FIG. 21a, the user first brings the system to text editing mode by for example, pulling the mouse and positioning it in outside position (2100). Then, as described before and shown in FIG. 21b, by pushing the mouse perpendicularly to the stylus axis (2110) in directions needed, he moves the cursor (2111) to a location, in where the text will be pasted. Then, as described for copying procedure, the user bring back the system to menu selecting mode, by for example, positioning the mouse in inside position, and looks for “edit” menu (2112), by rotating the mouse (2113). After locating the menu selecting indicator on the menu bar name (e.g. “Edit”), as shown in FIG. 21c, he clicks the mouse in inside direction (2120), opening the menu bar (2121). Then as described before and shown in FIG. 21d, by rotating the mouse (2130), the user brings the function indicator on the desired function (2131) which is the “Paste” function in this example. Then as shown in FIG. 21e, by clicking the mouse in inside direction (2140), the paste function is selected and the copied text (2142) will be pasted into the document in location that was pointed by the cursor (2141).

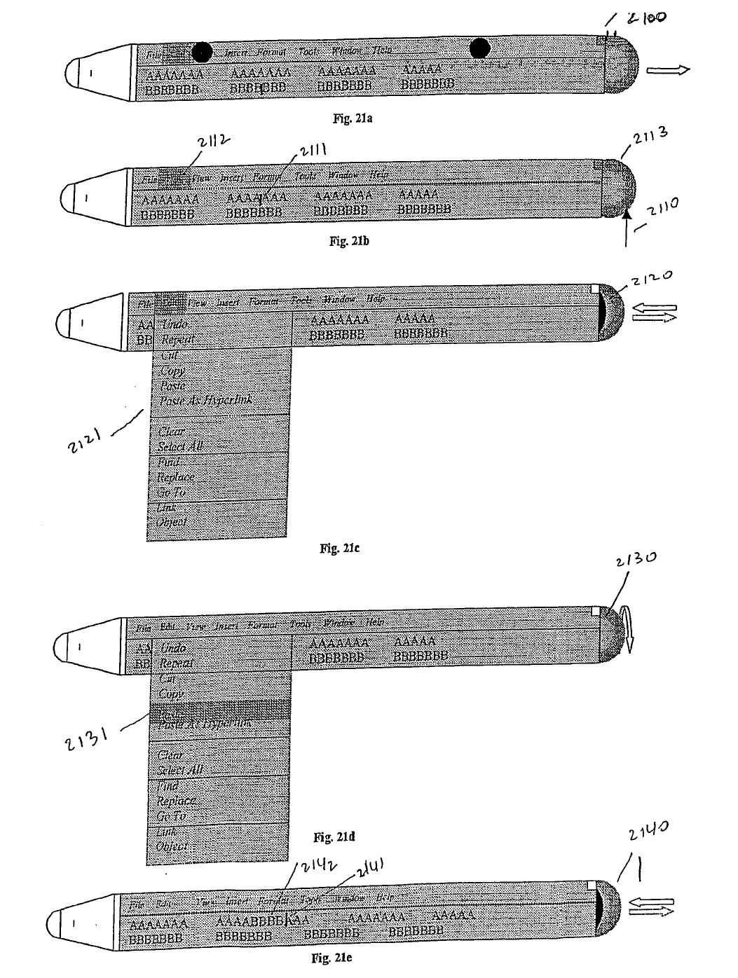

Also as shown in FIG. 22a, if a text (2201) is selected to be erased, it can also be erased either by using the “Clear” function in “Edit” menu bar, similar to procedure described for “paste” function, or; as shown in FIG. 22b and described earlier, it can be cleared by using the erasing tool (2211) and producing a predefined movement causing a sound waveform known by the HWSRS as an indication for erasing. A single erasing movement by the eraser on the writing surface, erases whole selected text. Additional erasing movements will cause additional characters or symbols of the text located before the cursor, to be erased. Instead of erasing tool, as also described earlier, the user can write a predefined cross out symbol (2311) by the pen tip to cause production of an already patterned sound waveform informing the HWSRS of an erasing command. Again, as mentioned hereinbove, a single erasing movement by the pent tip on the writing surface, erases whole selected text. Additional erasing movements will cause additional characters or symbols of the text located before the cursor, to be erased.

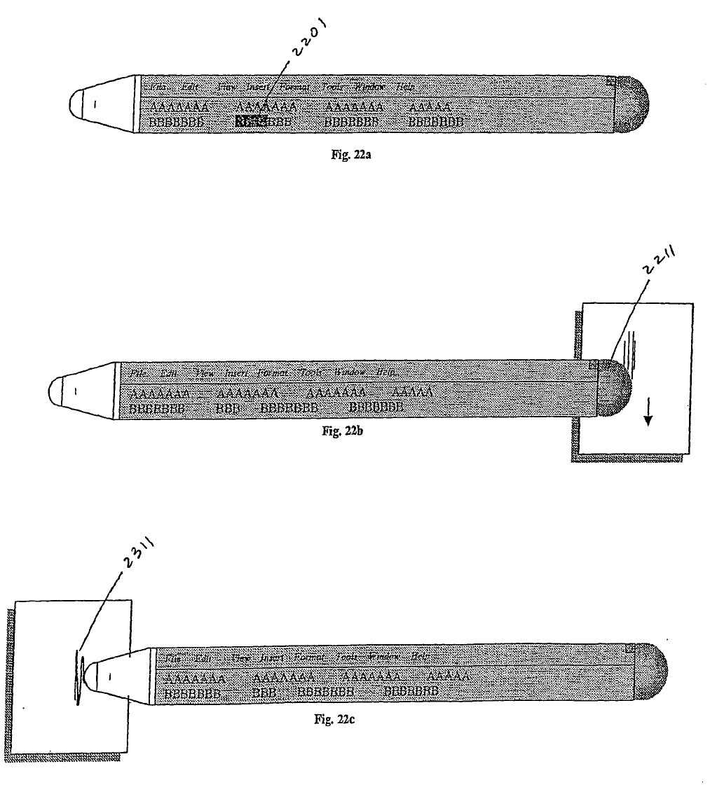

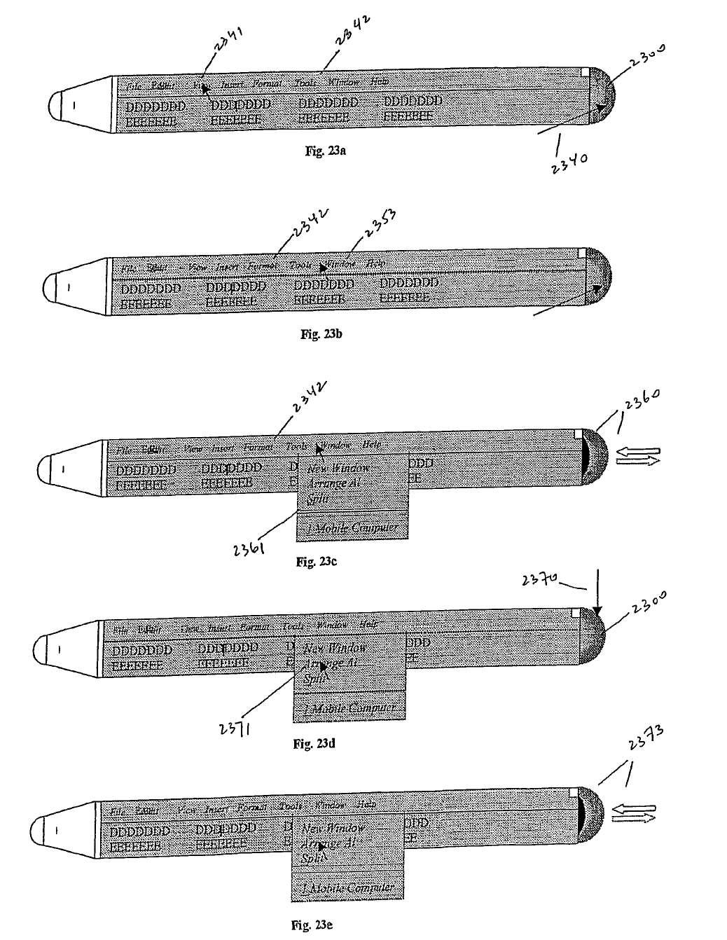

According to one embodiment of the invention, also a Normal Select (pointer) indicator may point to a menu in a menu list and select a function in that menu. As shown in FIGS. 23a-23e, first the user positions the mouse in menu mode, for example, in inside position. Then by perpendicularly to stylus axis pushes (2340) on the mouse (2300), the user moves the normal select indicator (2341) towards a desired menu in a menu list (2342). When the indicator is brought on the desired menu title (2353), as shown in FIG. 23c, to open the menu bar, the user can click the mouse in, for example, inside direction (2360). The menu bar (2361) opens. To select a function among those existing in the menu bar, the user can move the indicator to the desired function (2371) by perpendicularly to stylus axis pushes (2370) on the mouse (2300), and then to select that function he clicks the mouse in inside direction (2373). To avoid confusion with mode selecting, while clicking, the user may keep the mouse pushed for longer time (e.g. one second). Instead of clicking the mouse, the user may either press a predefined button such as the one 2701, shown in FIG. 27g (e.g. a clip-type button which will be described later in this application) available on the stylus computer, or proceed another action known by the people skilled in the art.

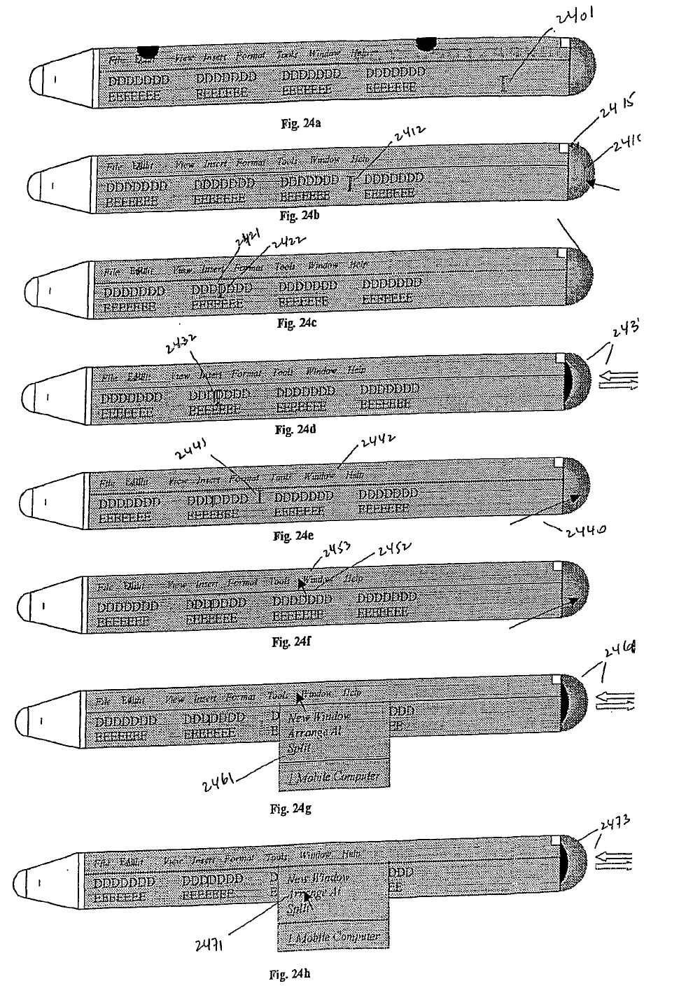

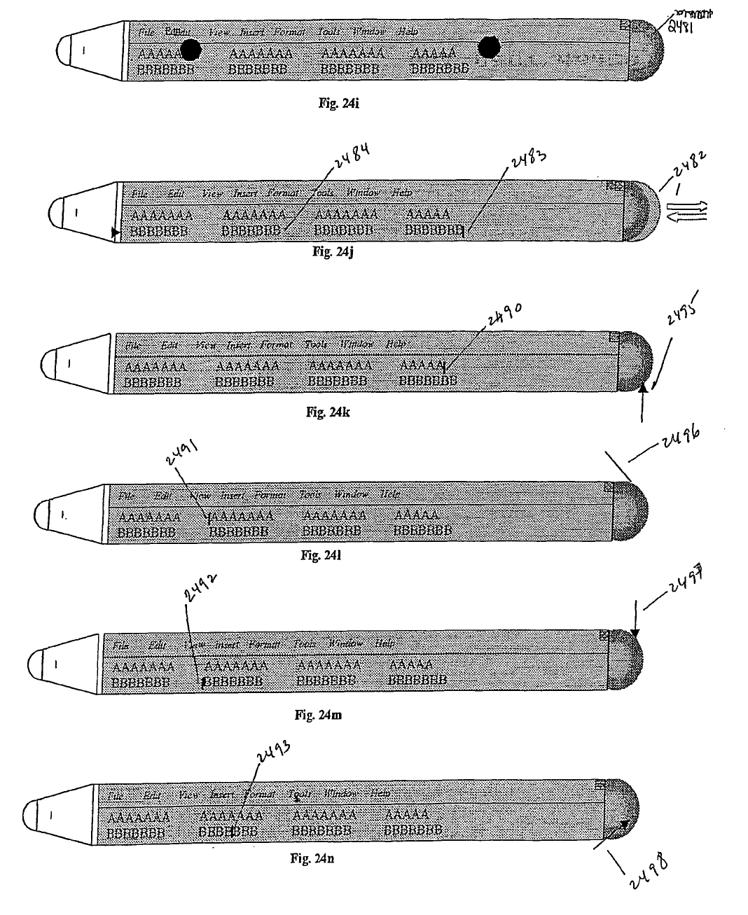

According to one embodiment of the invention, instead of assigning the text select indicator and normal select indicator, to two different mouse modes (e.g. inside and outside position), both indicators may be assigned to only one mouse mode (e.g. inside position). As shown in FIG. 24a, the text select indicator (2401) similar to those used in computers, may be provided in the stylus-type computer device. As shown in FIG. 24b, the mouse (2410) maybe used for moving the indicator (2412) on the screen. For this purpose the mouse may be in a position such as menu selection mode, in this example, inside position (2415). As shown in FIG. 24c, for example, to select a location (2421) in text, first, the user, by perpendicularly to stylus axis pushes on the mouse, bring the indicator (2422) to that point. Then, as shown in FIG. 24d, by clicking the mouse in inside direction (2431), the user selects that point and a cursor (2432) installs there. To avoid confusion with other modes, while clicking, the user should keep the mouse pushed for a longer time (e.g. one second). Instead of clicking the mouse, the user may either press a predefined button such as the one 2701, shown in FIG. 27g (e.g. a clip-type button which will be described later in this application) available on the stylus computer, or proceed another action known by the people skilled in the art.

The indicator may also point to a menu in a menu list. As shown in FIGS. 24e-24f, by perpendicularly to stylus axis pushes (2440) on the mouse, the user moves the indicator (2441) towards that menu list (2442). As for computers, when the indicator reaches the menu list, it changes the appearance from a bar shape (2441) to an arrow shape (2452). When the indicator is brought on the desired menu title (2453), as shown in FIG. 24g, to open the menu bar, the user can click the mouse in inside direction (2460). The menu bar opens (2461). Also, as shown in FIG. 24h, to select a function among those existing in the menu bar, the user can move the indicator to the desired function (2471) by perpendicularly to stylus axis pushes on the mouse then he selects that function by clicking the mouse in inside direction (2473). To avoid confusion with other modes, while clicking the user should push the mouse pushed for longer time (e.g. one second). Instead of clicking the mouse, the user may either press a predefined button such as the one 2701, shown in FIG. 27g (e.g. a clip-type button which will be described later in this application) available on the stylus computer, or proceed another action known by the people skilled in the art.

To the perpendicularly-to-stylus-axis pushes on, the mouse in other position (e.g. outside position), which was freed by above mentioned pointer assignment, for example, a cursor manipulating procedure in a text may be assigned. FIGS. 24i-24n, illustrate the procedure.

According to one embodiment of the invention, a cursor can also be manipulated by, for example, perpendicularly pushes to stylus axis on a mouse. As shown in FIG. 24i, first the user positions the mouse at text editing mode (2481), for example, in outside position. If the text mode is in line scrolling mode, then as shown in FIG. 24j, the user clicks the mouse in outside direction (2482), to bring the system in character/cursor navigating mode. As described before, for example, if the cursor is in current page, it remains at the same position in the text. If the cursor is not in current page, then, for example, it will be brought to the current page and will be located, for example, at the last (2483) or first position, of for example, the last line (2484) of the document. Then, as shown in FIGS. 24k-24n, the cursor may be navigated on the text in up (2490), left (2491), down (2492), or right (2493) directions, by perpendicularly to stylus axis pushes in different direction on mouse (2495-2498), accordingly.

As described before, the mouse may have one, two, or more positions on the stylus computer, wherein for better and easier functionality, each position may be assigned to a number of functions, for example, in a same domain. Although, the mouse may have unlimited numbers of positions on the stylus computer axis, for easier usage of the mouse and to not frustrate the user, it is preferable to have a mouse with not more than two positions on the stylus computer. For more functionality, in addition, at each position side (e.g. inside, outside), an additional clicking system may be provided for the mouse it must be noted that instead of a clicking system provided in the mouse, one or more predefined buttons provided on the stylus computer may be used with the mouse as mouse buttons. For example, while manipulating a mouse, the user may press a predefined button such as the one 2701, shown in FIG. 27g (e.g. a clip-type button which will be described later in this application) available on the stylus computer. The mouse including its clicking system and/or the mouse combined with its predefined corresponding buttons may function similar to a computer mouse and may have at least all the functionality of a computer mouse. It must be noted that the examples that explained before, or explain hereafter show only a few methods as samples. It is appreciated to those skilled in the art that many variations of the combinations of assignments can be employed without departing from the spirit of the present invention.

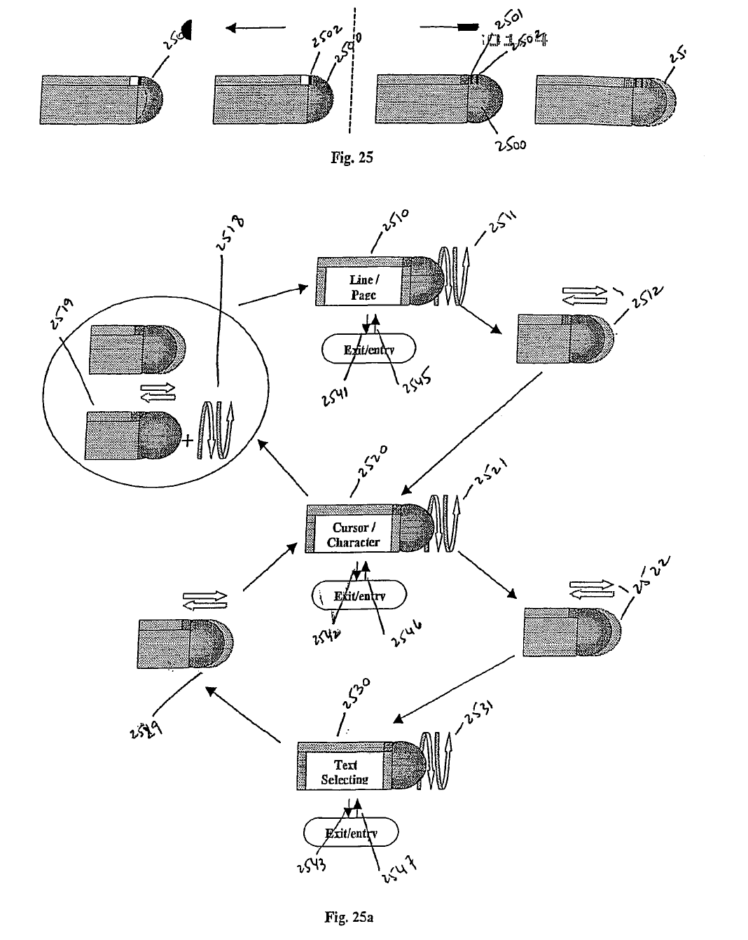

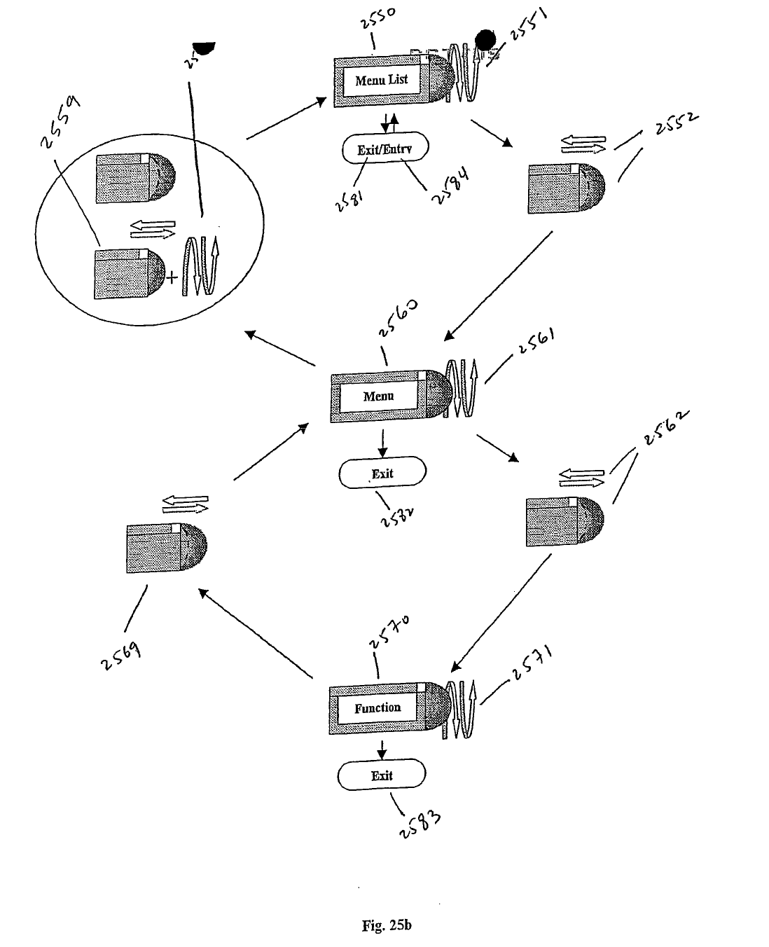

FIG. 25, according to one embodiment of the invention, shows a mouse (2500), having two positions (2501, 2502) on the stylus axis direction, on the stylus. Here also, for more functionality, in addition, at each position side (e.g. inside, outside), a clicking system (2507, 2508) is provided for the mouse.

According to one embodiment of the invention one of the mouse positions, for example outside position, may be assigned to text editing (manipulating) functions. FIG. 25a shows an example diagram of how the mouse functions. At the first step (2510), the mouse is in line/page scrolling mode. By rotating (2511) the mouse in perpendicularly to the stylus axis, in clockwise direction or oppositely, as shown in examples before, the user can advance or move back a text document lines on the LCD display. If at any time, the user pulls out the mouse strong enough to click it (2512), the system changes the mode and enters to cursor/character mode (2520). Now if the user rotates the mouse (2521), a cursor will advance or move back in the text, character by character. To go back to line mode (2510), the user may for example, pull out the mouse to for clicking (2519) and simultaneously rotate the mouse shortly (2518).

On the other hand, if the user wants to select a portion of a text, while the system is in cursor/character selecting step (mode) (2520), first he must position the cursor before or after the text to be selected. Then he pulls the mouse out to click it (2522) and the system enters into text selecting step (mode) (2530). Now, by rotating the mouse in either direction (2531), the text before or after the cursor will be selected accordingly. The length of the text to be selected depends on rotating quantity (degree). After selecting the text, the user can manipulate (e.g. copy, bold, delete, etc.) the selected text portion. To go back to cursor mode (2520), the user again pulls the mouse out and clicks it (2529).

The user may exit (2541-2543) the text mode at any step, by, for example, positioning the mouse in another position (e.g. inside position, menu selecting mode). The current text page, current cursor position, and current selecting step may be kept as default. When the user enters the text mode again, he will enter the text mode in the same position and step (2545-2547), as he left.

It must be noted that the step of scrolling the text lines/pages (e.g. line/page scrolling mode) may be omitted. In this case the user may scroll the lines by being in cursor/character mode and rotating the mouse to forward (or backward) the cursor. When the cursor reaches to the last (or the first) position in a text and the user still continues to rotate, then the next line/page may appear. It is understood that a text may comprise several lines which one or more than one of said lines may been displayed at a same time on the screen display unit of the stylus computer.

According to one embodiment of the invention, one of the mouse positions, for example inside position, may be assigned to menu and functions manipulation. FIG. 25b shows an example diagram of how in this case, the mouse functions. At the first step (2550), the mouse is in menu list selecting mode. By rotating (2551) the mouse in perpendicularly to the pen axis, in clockwise or opposite clockwise direction, as shown in examples before, the user can scroll forward or scroll back, the menu lists on the LCD display. If at any time, the user pushes the mouse inside, strong enough to click it (2552), the system selects the current menu list, changes the mode (step) and enters to menu selecting mode (step) (2560). A menu selecting indicator appears at a predefined location on the menu list. Now if the user rotates the mouse (2561), the menu selecting indicator advances or moves back (according to rotating direction by the user) on the menus of the selected menu list, menu by menu. If the menu selecting indicator reaches the last menu in the list and the user continues to rotate, then according to rotating direction, the next or the precedent menu list appears. The menu indicator jumps to first or last menu (according to rotating direction) and continues to run on the menu titles until the user stops rotating. To go back to menu list selecting mode (2560), the user may for example, push the mouse in, for clicking (2559) and simultaneously rotate the mouse shortly (2558).

In the other hand, if the user wants to select a function included in a menu, while the system is in menu selecting mode (2560), first he must position the menu selecting indicator on the menu to be selected. Then he pushes the mouse in, to click it (2562) and the system enters in function selecting mode (step) (2570). If there is only one function in that menu, then that function is automatically selected. If there are two possibilities and one of them is already in use (e.g. bold, normal), then the other possibility is selected automatically. If there are two or more functions excluding the current function in use, the a menu bar corresponding to the menu opens. Now, by rotating the mouse in either direction (2571), as needed, a function selecting indicator will be appeared and runs on the function titles until the user stops the indicator on one of them as desired. To select that function, the user again pushes the mouse in and clicks it (2569). The function is finally selected and the system goes back to menu selecting mode (step) (2560).

The user may exit the menu mode (2581-2583) by, for example, pulling the mouse and positioning it in outside position (e.g. text selecting mode). The current menu list may be kept as default. When the system enters the menu mode again (2584), the default menu list will be displayed on the screen.

It must be noted that the step of scrolling menu list (e.g. menu list mode) may be omitted. In this case the user may scroll the lines by being in menu selecting mode and rotating the mouse to forward (or backward) the menu selecting indicator. When the indicator reaches to the last (or the first) position in a menu list and the user still continues to rotate, then the next menu list (e.g. line) may appear. It is understood that a menu list may comprise several lines which one or more than one of said lines may been displayed at a same time on the screen display unit of the stylus computer.

It must be noted that the normal selecting indicator described before, separately or in conjunction with mouse rotating movements, may also be used to select functions.

According to one embodiment of the invention, written commands may be provided for at least a part of commands assigned to mouse or other buttons. For example, after selecting a portion of a text by the mouse manipulations, the user can write on a writing surface, the word “copy”. The system at this moment copies the selected portion of the document. If the user wants to paste that portion in another place, he can first bring the cursor to that position and then write the word “paste”. The system will paste that copied portion in that location. To inform the system that the words written, are not part of the text, but commands, various indicating systems may be used such as:

Special existing or customized, command reserved words or symbols may be used for each command or a plurality of commands (e.g. copy, cp) (e.g. a user may draw a predefined customized symbol such as “ ” to inform the system to proceed to next page in a text)

Command words may be preceded by reserved existing or customized word(s) such as, for example, “cm” (e.g. cmcopy, cmopen, etc.),

Or any other possibilities based on this idea. For example to advance five lines in a text the user may write “a105” (advance line 05 lines, wherein al is a reserved word)

According to one embodiment of the invention, the commands may be written by a separate pen tip, provided on the stylus type computer. They can also be inputted by the mouse structured surface, as described before. For better perception of the sounds generated by said mouse surface contacts with the writing surface, at least one additional microphone (preferably directional) may be provided, inside (e.g. as described before for the microphone of the writing tip), or outside the stylus computer body, near said mouse. Also a button such as a clip button may be used to inform the system of starting a written command input by the pen tip. In these cases, no reserved or restricted words may be needed.

Also a pointing device tip may be structured in a manner that a portion of it may be assigned to written commands. As shown in FIG. 4e, a pointing device tip (415), may be structured in a manner that a structured portion (418) of it may be assigned to text, and another differently structured portion (419) of it, maybe assigned to hand written commands.

By writing a command with the command assigned part (419) of the pointing device tip, on a writing surface, according to sounds produced and after comparing them with patterned memorized waveforms, the HWSRS interprets the written data or symbol as command.

According to one embodiment of the invention, as for regular computers, the display may show different icons. The normal select pointer may be used to, for example, select an icon, open files, use vertical and horizontal elevators, run programs, and/or at least all other manipulations done with regular computer normal select pointers.

According to one embodiment of the invention, first the normal select pointer may be positioned on the desired icon or object, by for example, mouse perpendicularly or rotating movements. Then by clicking the mouse, for example once, that object may be selected. A longer time pushing and clicking procedure may select the object and keep it to, for example, shift it somewhere else. To release that object, another long click may be produced. Also, as for traditional computer mice, some functions or commands me be assigned to double clicking of the stylus type computer. All other manipulations by a traditional computer mouse may be possible by the stylus type computer mouse of the invention. Those mouse manipulations are known by computer users.

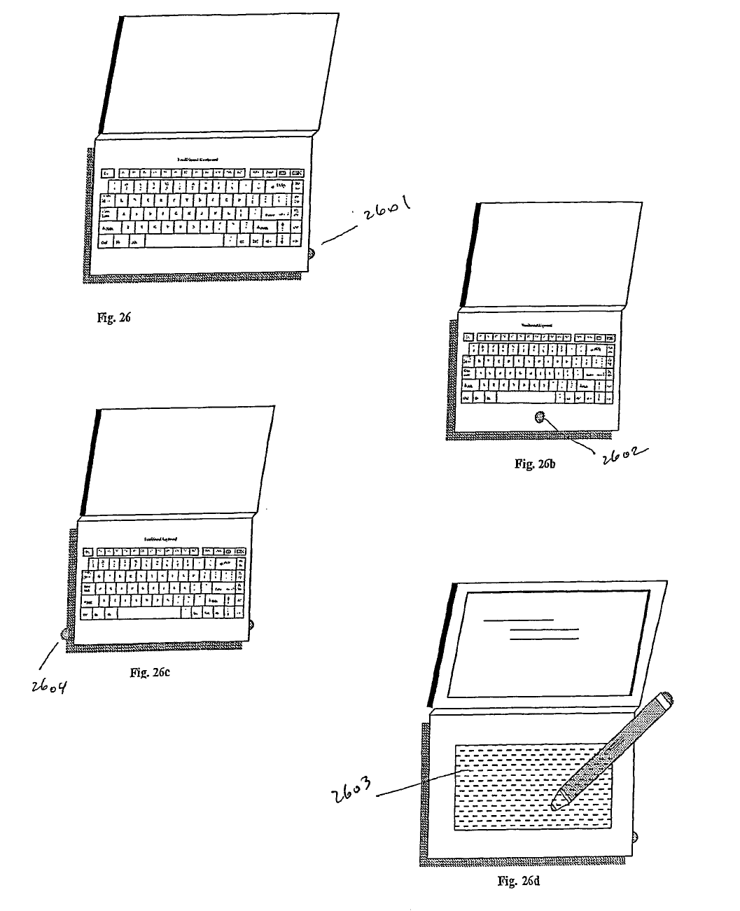

The mouse, having command and selecting systems and movements as described, may be installed in all electronic devices such as computers, laptops, PDA devices, mobile phones, wired phones, etc., which all need a simple navigating/selecting means. Some of those devices are shown in FIGS. 33a to 33e. FIG. 26a shows a laptop computer equipped with the mouse of the invention (2601) on the side. As shown in FIG. 26b, the mouse may be installed in another location (2602) on the computer, such as in the center. Also as shown in FIG. 26c, it is understood that additional complementary-to-mouse buttons or mice (2604) may be provided on the computer. FIGS. 33a-33e show a variety of electronic instrument equipped with the mouse (3326), and the selecting system by the mouse, as described.

According to one embodiment of the invention, the hand writing sound recognition system of the invention and/or the mouse system of the invention, may also be provided in computers and other electronic devices equipped with keyboard, keypads or other input systems such as voice/speech recognition, etc., replacing their input systems or combined with them. As shown in FIG. 26d, a writing surface (2603), a microphone (not shown), the HWSRS of the invention, and all other materials needed (not shown), are installed in a computer to permit a pen having preferably, a pen tip of the invention, to produce sounds according to symbols written by that pen tip on that surface. Preferably also the writing surface may be structured in a way to enhance the sounds produces by the pen tip. The microphone receives the sounds and transmits them to the computer that in combination with HWSRS, digitizes the hand written data input. This system may also be used for all other electronic instruments such as those shown in FIGS. 33a-33e.

Also computers and other electronic instruments, equipped with HWSRS and microphone, may not have a writing surface. In this case, by writing on any place such as the cover of a computer, the corresponding sounds produced may be interpreted by the HWSRS. This system may also be used for all other electronic instruments such as those shown in FIGS. 33a-33e.

One important advantage of this system is that, the HWSRS of the invention may replace the bulky keyboards and frustrating keypads of electronic devices and computers. By having a simple pointing device such as a pen, preferably, having a structured tip of the invention, a user can input an unlimited variety of data into electronic devices. Of course the electronic instruments must be equipped with at least a HWSRS of the invention and a microphone. They also, must have all other necessary features such as processor, memory, etc. Preferably a structured writing surface to enhance the sounds produced by the contact of pointing device tip on the writing surface while writing, may also be provided within the electronic instrument.

According to one embodiment of the invention, as shown in FIG. 27a, additional buttons (2701) used for some functions, specially those used frequently, such as “Enter”, “Next Line”, “Tab”, or “Caps Lock”, may be provided on the stylus computer.

In still another embodiment of the invention, instead of, or in addition to, those buttons, a rotating and/or clicking system may be provided on the pointing side of stylus-type computer. For example, as shown in FIG. 27b, three frequently used functions, Enter, Tab and Caps Lock (2711) are indicated on the stylus type pen head (2710), and a selecting indicator (2712) is positioned on the body edge of the computer. As shown in FIGS. 27c-27d, by rotating (2719) the stylus head or body, and bringing the indicating mark (2712) in front of indicated functions (2714,2715), the function relating to that indicated function will be selected and executed. The head may automatically move back to its original location. For example, in FIG. 27c and FIG. 27d, functions Caps Lock, and Enter (Next Line), are selected respectively. According to example shown in FIGS. 27e-27f, the Tab function (2720) will be executed by pushing the head in inside direction (2721) and clicking it. Each additional click causes an additional advance of the tab.

According yet to one embodiment of the invention, as shown in FIG. 27g, the stylus type computer (2700) may have a clip type button (2701). By pushing on several locations on the clip, different functions or commands may be executed. For example, as shown in FIG. 27h, by pushing the clip button in the center (2710), for example, on/off commands may be executed. Pushing the clip button on the sides may also execute commands. For example, by pushing the left side (2720) of the clip button (2721), “Enter” or “next line” function (2722) may be executed. Also, for example, by pushing the right side (2730) of the clip button (2731), “Tab” function (2731) may be executed. Each single press on the right side will cause the cursor to jump to next tab location on the screen. Symbols such as a space character may also be assigned to a press on a location on a clip button. Also, for example, if a user presses a on a predefined location of the clip button (e.g. a key of said clip button) and keeps it pressing, a symbol or a function assigned to said location pressed may be repeated until the user stops pressing said key. Also double clicks on different locations of the clip button may be assigned to different functions. For example, a double click on the left side of the clip button may be assigned to “Caps Lock” function, etc. also, for example, when the device is in telephone mode the clip button may be used for functions such as “Send”/“End” (communication), etc.

An interaction such as a press or a double click on a location (e.g. a key 2710, 2720, 2730, etc.) of a clip button 2701 may be used in conjunction with the pointing and selecting device (e.g. a mouse) of the stylus computer. The clip button keys may function as said mouse keys. Said combined interaction with the mouse and clip button keys may either replace the mouse clicking functions which have been described before, or may add additional functionality to the already described mouse functions of the stylus computer. For example, a user may manipulate a mouse with, for example, his right hand to position a pointing indicator arrow on a file icon, and press or double click a key of the clip button with his left hand to select or open said file. Also during a text editing the user may use said clip button keys to, for example, select a menu, select a function, or change a mode (e.g. change the mode from menu list to menu selecting and vise versa, or from line selecting/scrolling mode in a text to cursor manipulating mode and vise versa) etc. For example, when the system is in menu selecting mode, after locating a menu selecting indicator on a menu, a user may press a predefined key of the clip button to open said menu bar. Also when desiring to exit a mode such as exiting from menu selecting mode and to enter menu list mode, instead of, clicking and simultaneously rotating, the mouse, a predefined key of the button clip key (or any other type of predefined keys) of the stylus may be used. In other words, the mouse with its integrated clicking modes and/or the mouse with other keys assigned to it may comprise at least all the functionality of a PC mouse.

The clip button may be located at a different location on the stylus computer. For example, as shown in FIG. 27k, the stylus computer 2740 of the invention may comprise a multi-function clip button 2741 of the invention located closed to the writing tip 2742 of said stylus. It is understood that for the reasons such as the convenience of use, said clip button may be located at any location on the stylus, such as, closed to the mouse, or closed to the writing point tip, or in the middle of the stylus, etc. In addition, said clip button may be designed in a manner to attach the stylus computer to, for example, a user's pocket (e.g. similar to attachment of a regular pen to a user's pocket). Also, if needed, more than one clip button may be provided on the stylus computer.

According to one embodiment of the invention, the stylus computer 2740 may contain at least one additional microphone 2743. Said microphone may be provided in a manner to receive a user's voice. For this reason, said microphone, preferably, may be located in a location 2744 on the stylus closed to the user's mouth (e.g. at the opposite end of the stylus relating to the other stylus end wherein the pointing tip is installed).

Yet, according to one embodiment of the invention, as shown in FIG. 27L, a stylus computer 2750 may contain a muti-sectioned/directional microphone 2751 to, for example, perceive a user's voice. Said microphone 2751 may be extended towards said user's mouth in a manner to clearly perceive said user's voice. The multi-sectioned structure 2752 of the microphone may be used as an antenna of the stylus computer. Said antenna may be a diversity antenna. In closed position said muti-sectioned microphone and/or antenna, may have the appearance and/or the functionality of the above-mentioned clip button of the stylus computer.

FIGS. 27m-27n show different positions of the multi-sectioned microphone/antenna described here-above. With reference to FIG. 27m, a clip button 2761 of the stylus computer 2760 having a multi-sectioned structure 2762 is shown. In this example, the clip button 2761 itself, may be pivoted and/or rotated to help the adjustment of the stylus in a desired position. Said clip button may have telescopic sections 2763 to be extended from said clip button. If the clip button system contains keys 2764 under said clip button (e.g. operated by presses on said clip button), while rotating said clip button for, for example, extending the microphone towards a position, said buttons are uncovered and may be directly manipulated by a user's finger. It is understood that the structure of the clip button may comprise any extending technologies known by the people skilled in the art. For example, as shown in FIG. 27n, the clip button 2781 of the stylus 2780 may have a first fixed structure 2782, and additional pivoting 2883 structures 2784.

By using a microphone closed to stylus writing tip and a multi-sectioned microphone of the invention closed to a user's mouth, two clear inputs may be perceived by the system for a same data (e.g. symbol) inputted. A user, for example, may write a text while speaking said text. For better recognition, the system may use both inputs (e.g. handwriting sounds of the stokes and spoken input of the user), simultaneously. This matter will be disclosed with more detail later in this application. While writing, said microphone may function in a manner to automatically permanently stay near the user's mouth. For this purpose, for example, a biasing means such as a wire may be provided to attach the microphone to, for example, a user's part of the body or his dress. It is understood that instead of having a multi-sectioned structure, the microphone may be extended by a wire towards a user's mouth.

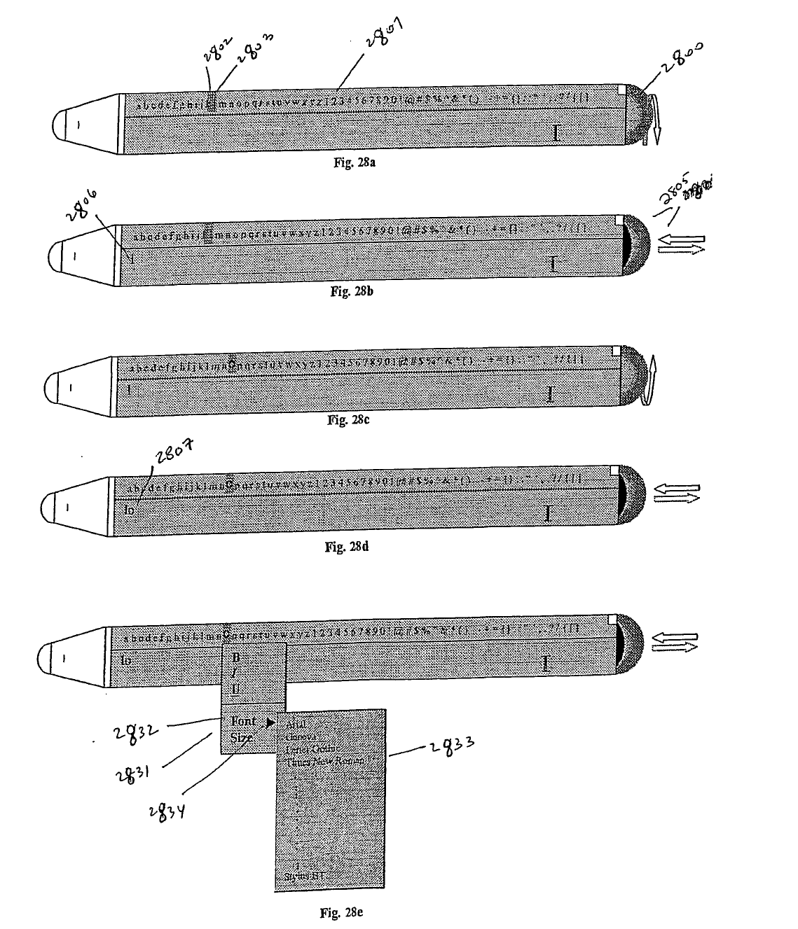

In yet another embodiment of the invention, as shown in FIG. 28a, as a separate system or a complementary system to the hand written sound input system of the invention, a menu list containing alphanumerical characters and symbols (2801) may be provided with the stylus type computer. A character or symbol may be chosen and inputted by any of the menu selection methods described before. For example, after the alphanumerical menu list is selected, the mouse (2800) may be rotated until the menu selecting indicator (2802) is on a desired symbol (2803). Then as shown in FIG. 28b, by clicking the mouse in inside direction (2805), the character is selected/inputted and printed (2806) on the LCD screen. As shown in FIGS. 28c-28d, this procedure may be repeated for selecting additional characters or symbols (2807). In addition as shown in FIG. 28e, shortcut functions (e.g. bolding, font, size, etc.) may be applied on each character by creating a menu bar (2831) for them. It is understood that if a function (2832) contains sub functions (2833), by pressing the mouse after the indicator (2834) is on that function, the sub function menu (2833) opens. To select a function among those in the sub functions menu again the user must rotate until he selects the desired function by clicking the mouse in, for example, inside direction. As far as, the functions contain sub functions, this procedure may be repeated until a function without a sub function is selected.

According to one embodiment of the invention. The above-described procedure may be applied to any menu bar having functions containing sub functions, and so on.

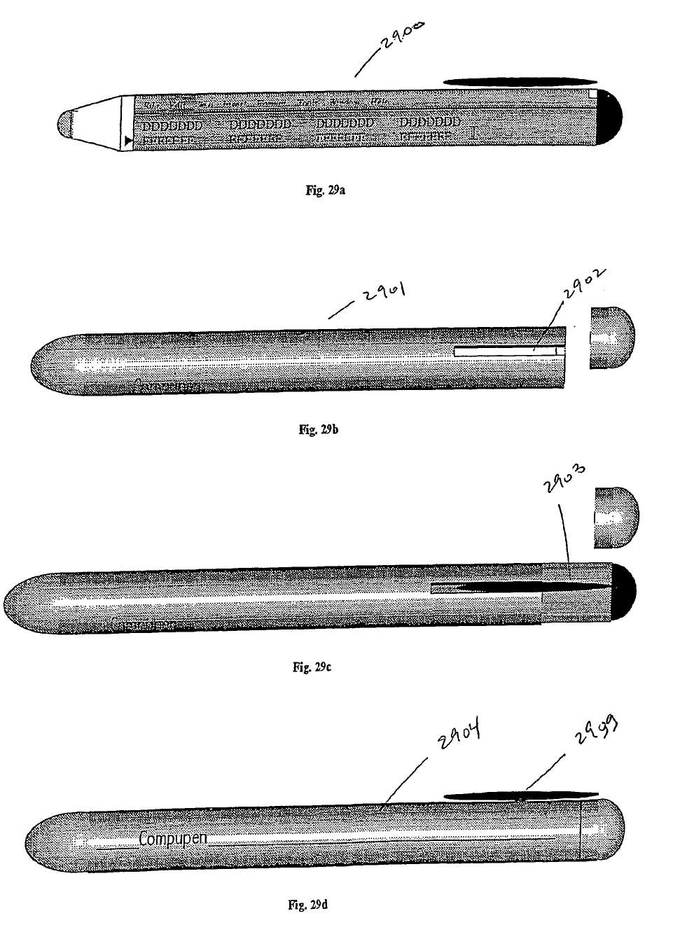

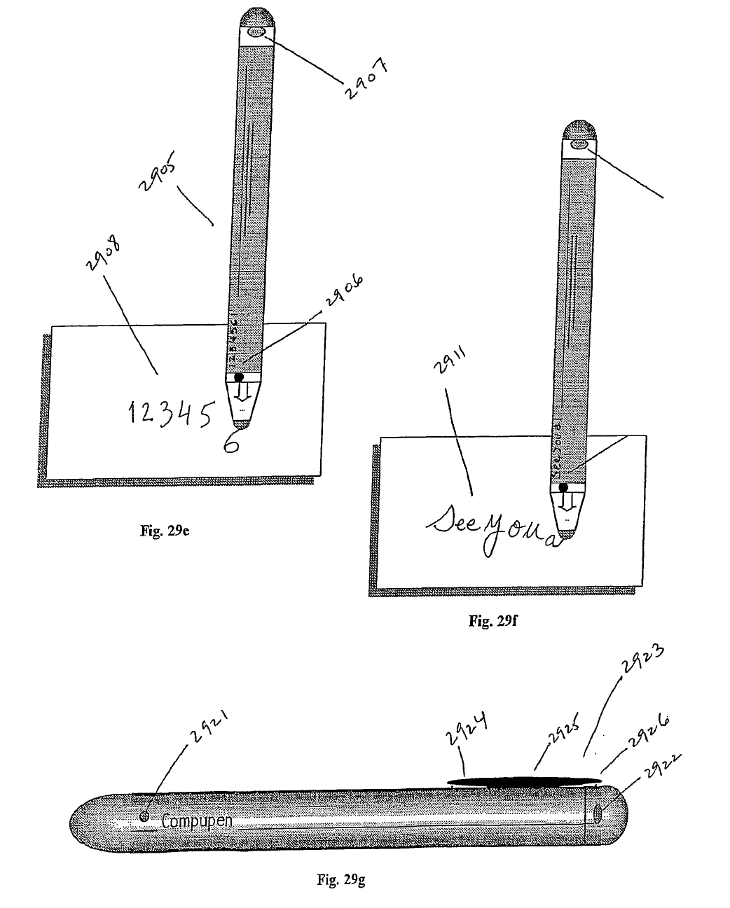

According to one embodiment of the invention, a cover for said stylus type computer may be provided to protect the display and all other features of the device. In addition it may protect the pen-tip preventing accidental erroneous inputs. FIGS. 29a to 29d illustrate the stylus type computer (2900), the cover (2901), to cover the stylus computer. The cover may have a special structure (2902) to permit the computer clip button (2903) to be available (2999) and function even the cover the computer is covered. (2904). This is because the stylus type computer may also have telephony and telecommunication capabilities. When the device is used as a mobile phone and the user receives a call, he may answer to that call while the device is covered. The cover may also protect the device from water.

According to one embodiment of the invention, the stylus-type computer can also function as a tele-communicating device, such as wireless telephone or PDA device. As shown in FIGS. 29e-29g, the stylus (2905) may be equipped with part or all equipment and systems of the invention and additional not mentioned necessary features. It may be equipped with a transceiver (not shown) and all other necessary features to communicate with other electronic devices. For example, the device may comprise at least a speaker (2907), a microphone (2906), a camera, etc. The input systems and functions of the invention permit to dial numbers (2908) by writing them on a writing surface, write and send massages (2911), send files, pictures, receive, memorize and manipulate data, etc. Telephone functions and menus may be organized similarly to other computer functions and menus. For example, one or more menu lists and menu bars, containing one or more functions, may be organized, even by the user for telephone operations such as telephone directories, received/sent calls, etc. In addition the stylus type computer device maybe equipped with voice recognition systems to alternatively permit to input data and functions, commands, etc., by voice or speech of a user. It may also dial numbers by speech orders.

As shown in FIG. 29g, for better portability, the device may also have a cover to protect it from shocks end eventually from water. To not open the cover while, for example, receiving a call, means such as wholes (2921,2922) on the cover, at the locations of the features such as, speaker, microphone, camera, etc., may be provided. When the device is in telephone mode the clip button (2923) may be used for some telephone functions. For example, functions such as “Send”, “End”, may be assigned to pressing the left side of the button. Also, for example, functions “on”, “off”, may be assigned to the center (2925) of the clip button, and function “Voice (e.g. Mail) Box”, may be assigned to the right side (2926) of the clip button, etc. Of course at least a portion of a display of the stylus telecommunication device may also be available for use while said device is covered.

According to one embodiment of the invention, instead of, or in addition to, the stylus computer display described before, a display unit may be provided within the cover of the stylus computer/telecommunication device of the invention, to permit the use of said device for telephone manipulations such as seeing an incoming call number, without being obliged to remove the cover of the device. The connection between said display and said devivice may be established either wirelessly, or by electrical connections. For example, electrical contacts may be provided within said telecommunication device and within said cover so that when said cover covers said electronic device said contacts touch each other to permit electrical connections between said telecommunication device and said display provided within said cover.

Also instead of a speaker, the received sounds or massages may be transformed to corresponding vibrations and be transmitted to user's ear while the user keeps the stylus closed to his ear.

According to one embodiment of the invention, the stylus type computer of the invention may also have telecommunications means, such as infrared, laser, etc., to communicate with other electronic instruments such as other computers, PDA devices, TVs, etc. This will permit, for example, to send and receive documents and data (e.g. to/from a computer, to a printer, etc.).

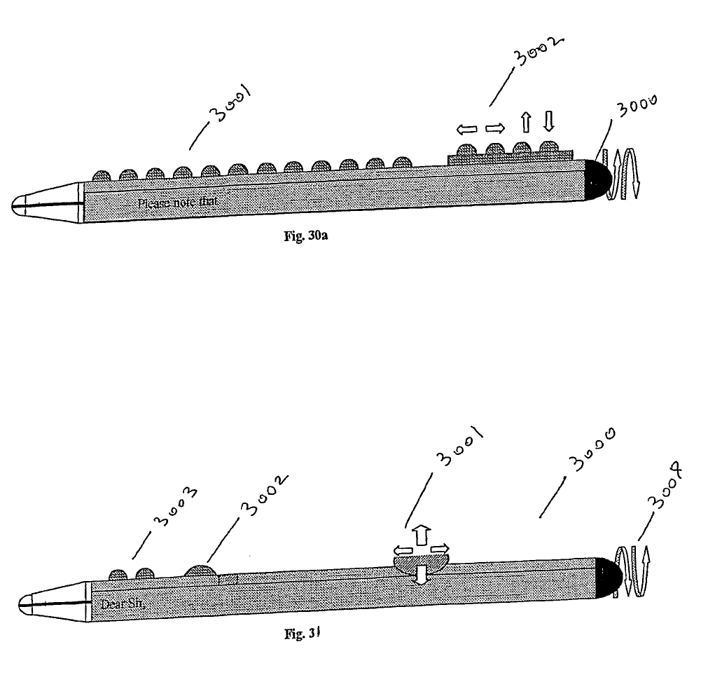

Other types of buttons and mouse may also be considered for the stylus-type-computer. For example, as shown in FIG. 30a, plurality of buttons (3001, 3002) can replace some of the functions previously assigned to the mouse. In this example, the mouse (3000), may for example, be used for line/page up and down. Four buttons (3002) may move the cursor to left, right, up, down, and other buttons (3001) may be assigned to other functions.

In yet another embodiment of the invention, as shown in FIG. 31, a stylus type computer (3000) may contain at least one mouse (3008) for a group of function (e.g. page up/down), at least one multi-directional button (3001) for functions such as cursor manipulations, and at least one multifunction button (3002) for, for example, menu/function selecting operations. Other additional single/multi function buttons (3003) may also provided.

FIG. 31a shows a muli-directional button (3101) that may be used for cursor manipulation. By pressing the button at different edges (3102), cursor will move to different direction (3103) accordingly. FIGS. 31b to 31f demonstrate a cursor (3111) which is directed to different locations on the LCD display by different manipulations (3112) of the button (3102).

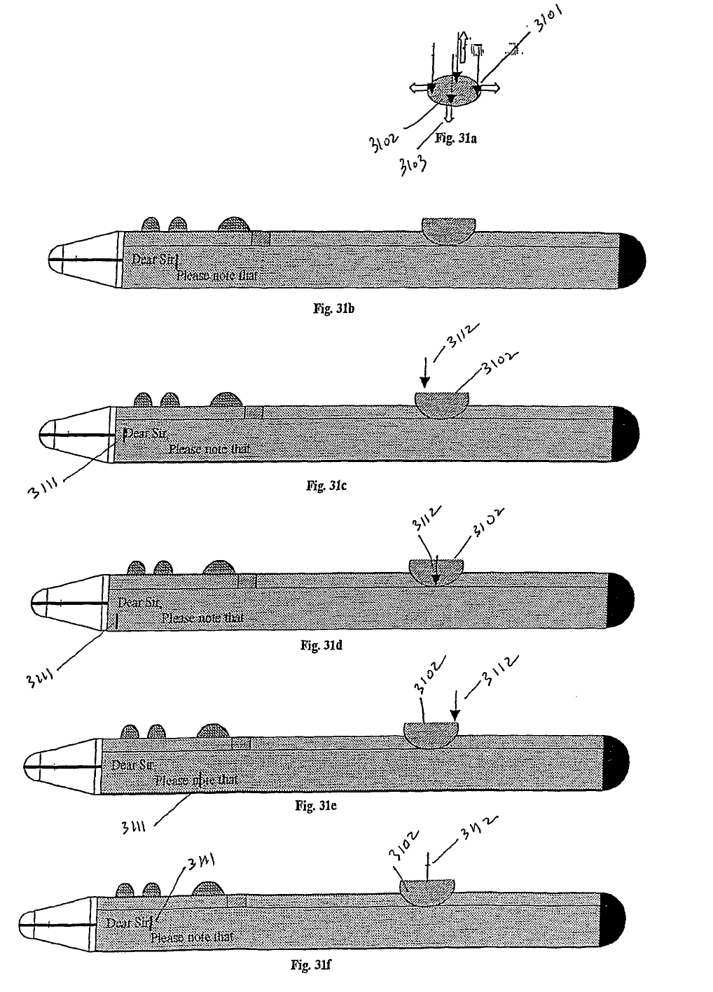

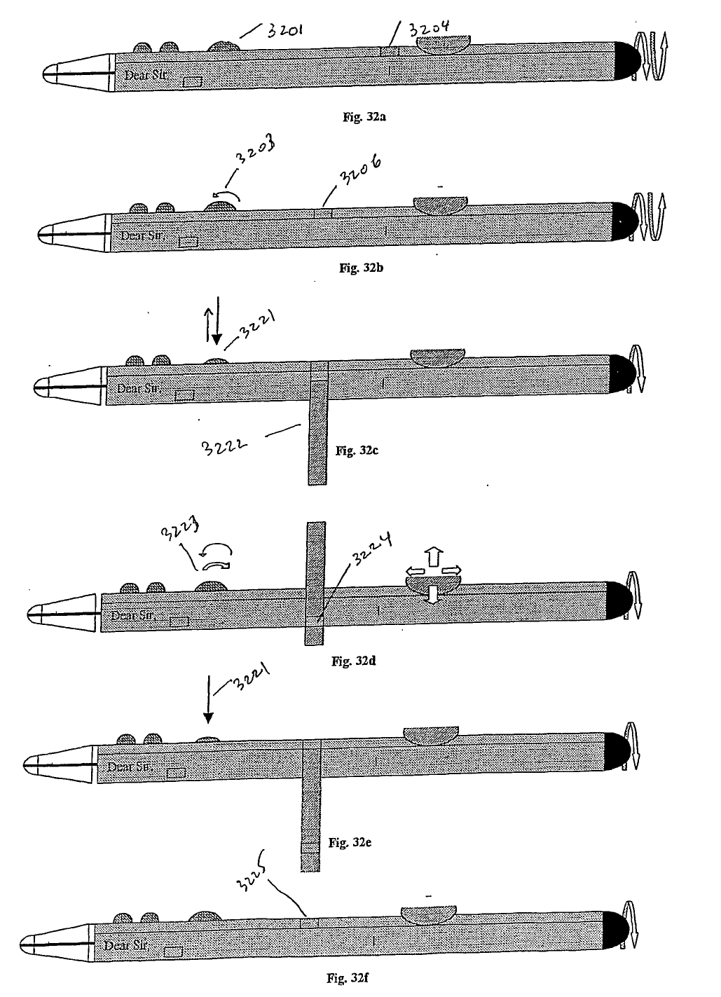

FIGS. 32a-32f demonstrate how according to one embodiment of the invention, another type of function selecting button (3201) may operate. As shown in FIGS. 32a-32b, by rotating this button to right (3202) or left (3203), the menu selecting indicator (3204) is moved to left or right.

For selecting a menu, first the user brings the indicator on the menu to be selected (3206). Then as shown in FIG. 32c, he may push the menu selecting button (3221) to inside stylus direction. The menu bar (3222) opens and the system is in function selecting mode and the key comes back to its original position (e.g. click button). As shown in FIG. 32d, the user then rotates the button (3223) to bring the function indicator (3224) on to be-selected function. Then as shown in FIG. 32e, The user again clicks the selecting button (3221) to select the function. Finally, as shown in FIG. 32f, the function (3225) is selected and the system exits the function selecting mode and goes back to menu selecting mode.

According to one embodiment of the invention, other hand written input and recognition systems based, for example, on written graphs and drawings of symbols or commands (e.g. delayed hand written recognition system), or based on the real time movements of, for example, a stylus tip on a writing surface, may be used by the stylus type computer of the invention. Also printed materials such as characters, images, etc., may be scanned as data input by the stylus computer. For this purpose, the stylus may be equipped with means such as optical reader, laser equipment, camera, etc., and recognition systems such as OCR, and other technologies such as those available today, or in the future.

Also, other input and technologies and systems, such as voice, speech, keyboard, keypad, digitizer, etc., may be used by the stylus type computer.

Also, as mentioned before, the system may include one or more databases of letters, words and symbols in different languages. A predictive word recognition system may also be combined with the system to make the selection of a word possible before entering it entirely. This system may allow an automatic selection of the desired word by the system mostly before ending to enter it entirely and sometimes even without the need of the user interference. This is possible, because by writing, individually and sequentially, characters or symbols (e.g. character by character basis) of a word, and the very small numbers of corresponding words, in many cases, before finishing to enter the word entirely, the word predictive system can either determine the desired word, or may show a few possible words, and the user selects one of them. The selected possible words may be listed in a bar list similar to menu/function bar, and a user may select a desired word among them by using the mouse movements and procedure, similarly to selecting a function in a menu bar.

According to one embodiment of the invention, HWSRS may be combined with other recognition systems to ease the recognition of symbols to be entered. For example, while writing symbols (e.g. a letter, a punctuation, a command, a word or a sentence, etc.) a user may simultaneously pronounce said symbols. Then the HWSRS combined with a voice recognition system will easier recognize said symbols.

According to one embodiment, as mentioned before, a user may write a text word by writing it character by character separately (e.g. to signal the end of each character, the user lifts the pen tip from the writing surface after writing each character). Said user may also, simultaneously speak said word while writing said word's letters. The HWSRS of the invention interprets each character of said word. After interpreting said characters, the system compares said characters with the spoken word and vise versa. Then after matching those two words (e.g. written word and spoken word) with a dictionary database of written words and corresponding key patterned spoken words, the system selects a candidate word having the highest probability with the intended word which was inputted by the user. This will permit a very natural manner of writing by a user, while enabling the system to have a more accurate recognition capability. Providing a directional microphone near the stylus writing tip, and an extendable directional microphone closed to the user's mouth will facilitate a better quality handwriting (based on sounds of the writing tip on a writing surface) and voice entry. Of course, the data entry methods (e.g. using HWSRS and/or voice recognition) as described before, may be used separately or combined with other data entry systems. For example, for a still better accuracy of input recognition, in addition to, and simultaneously with, said data entry methods, an optical handwriting recognition system based on recognition of symbols based on the graffiti of written characters may also be combined with other recognition means such as the ones described before.

For a faster data entry the sound patterns concerning the symbols of a shorthand writing system may also be memorized by a user and later compared to shorthand written texts of said user during a data entry using the HWSRS of this invention.

Also, commands such as “Caps Lock”, may be inputted by voice. For example, a user may say “Cap” and write “a”. Then the system will input an “A”. Also, different speeds of writing while writing a symbol may be assigned to different symbols. For example, writing fast a lower case letter may correspond to a lower case version of said letter, and writing slowly a same lower case character may correspond to its uppercase version.

Also, as shown in FIG. 33f, characters and functions available on a standard keyboard, may be assigned (3351) to different keys of a keypad (3350) with limited number of keys (e.g. telephone keypad). The keypad keys maybe the keys such as regular clicking keys, sensitive keys (e.g. digitizer, touch sensitive, pressure keys, etc.), or other type of keys. By writing a character (3352) among those (3353) assigned to a key (3354), (or by writing a predefined symbol such as a straight line drawn in a predefined direction causing a sound, assigned to a symbol or to a location on a key corresponding to a symbol, on said key), on the same key, and if necessary, simultaneously, pressing on the key, the key recognition system selects that key, and the HWSRS understands that the character written on the key selected, is one of those assigned to that key. This makes the recognition much easier, because the HWSRS has to compare the character entered, with only the patterns of the characters available on the selected key. It is understood that the writing instrument (e.g. pen, stylus), may preferably have a structured tip of the invention.

For enhancing the written input system, additional technologies and means maybe used. For example, to locate the stylus tip position or its path on the writing surface, the stylus may have means to send and receive back signals (e.g. radar). Different technologies, such as laser, light, microwave, infrared, etc., may be used for sending and receiving back the signals. As shown in FIG. 34a, a reflecting beacon (3401) or the like, may be positioned, on, for example, a writing surface (3404), to reflect the stylus pen tip sending signals (3403) frequently. The stylus may be equipped with measuring systems to locate its pen tip position distance from the reflector, based on the time a signal was sent and received back. The pen tip position (3402) will be calculated based on its distance from, for example, two predetermined points (3405, 3409) on the beacon. It is understood that the beacon relationship angle (3406) must be different from 90 degrees. It is understood that by using the technologies described before, the system may know at any moment, if the pen tip is in touch with the writing surface or not. The positioning system has plurality of advantages such as indicating the end of a word, sentence, etc. to the recognition system.

Also, a hand writing recognition system according to movements of the pointing device in the space may be provided. For example, a reflecting/detecting means to scan/provide three dimensional parameters relating to the locations of a pointing device tip in the space during the writing procedure of a symbol may be used. A position of said pointing tip in the space, at a precise time, may be determined by signals sent/received by said pointing device tip, and detected and/or reflected to said signals to said pointing device tip and received by it

Also according to another embodiment of the invention, the pointing device and its tip may structured and designed in a manner to detect (e.g. by means of sensors), for example, the air pressure level applied on different portions of said pointing device and/or is tip.

Also according to another embodiment of the invention, the pointing device and/or its tip may be structured and designed in a manner to detect, for example, the heat level of on different portions of said pointing device and is tip in contact with the air while writing symbols. For example the sensors may be heated permanently by a system and according to the contact with the air of said pointing device while writing, the degree of heat on each said portion may change accordingly. They may be detected, and been analyzed by a recognition system.

According yet to another embodiment of the invention, as shown in FIG. 34b, the stylus cover (3410), may be used as the reflecting beacon.

It is understood that instead of using a reflecting beacon system, the stylus pen tip may send to be detected signals to a detecting means. For this purpose a detecting unit such as the beacon described before, may be provided to detect those signals and if needed to process them. Then the detecting mean may transmit the information (e.g. positions of the stylus tip on precise times) to the stylus type computer. It is understood that said reflecting beacon mat be constructed in a manner to provide a three dimensional detecting/reflecting means.

The above mentioned positioning information at a precise time, may be used by a real time hand writing recognition system procedure to interpret the symbols written.

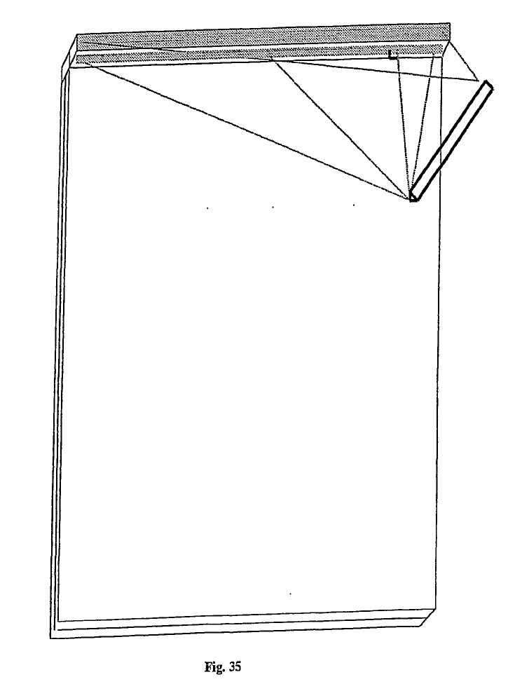

According to one embodiment of the invention, and by using the technologies described before, the reflecting or detecting beacon may horizontally be fixed on a writing surface. As shown in FIG. 35, note pads, note books, and other writing surfaces may be manufactured having a reflecting means incorporated.

According yet to another embodiment of the invention, the stylus type computer may be equipped with a barcode reading/recognizing systems. Said barcode reader may be installed in an appropriate place within, or outside the stylus computer of the invention.

According to one embodiment of the invention, a stylus computer of the invention may have a barcode reader installed near its writing tip to scan the information concerning the position of said writing tip at different fractions of time while writing a symbol.

According to yet another embodiment of the invention, a barcode reader of the stylus type computer may be located on a rotating clip button of the stylus computer in a manner to scan the information concerning the position of said stylus computer writing tip at different fractions of time during writing a symbol on a writing surface. For a good view of the writing tip on a writing surface while writing symbols by a user, said clip button may be rotated and fixed by said user, in an appropriate position.

It is understood that because of a variety of different movements of the stylus computer while writing a text, for a better scan, more than one barcode reader positioned at different of locations on the stylus and/or in other locations, may be provided.

FIG. 36 shows a writing surface (3601). The horizontal locations on the writing surface may be numerated by vertical barcodes (3602) and the vertical locations on the writing surface may be numerated by horizontal barcodes (3603). The intersections of those barcodes on the writing surface (3604) indicate precise positions on the writing surface. For this purpose, each point of interaction between two bars must have a unique information property. For example, a predefined number of neighboring bars (e.g. vertical and horizontal bars) around a crossing point of two bars (e.g. a vertical bar and a horizontal bar) of said barcodes may always have a different characteristics (e.g. different configuration of bars, bars having different colors, etc.) from the same predefined number of neighboring barcodes around another crossing point of two bars of said barcodes on the same writing surface. By reading said predefined neighboring number of barcodes by a barcode reader installed, for example, on a stylus computer of the invention, during the writing procedure, information such as a shape of a graffiti of a written symbol, or drawings, or a location in a text or on a writing surface during writing a text, or end of a symbol, space between two symbols, etc., may be provided and been processed either in real time, and/or been stored for a delayed processing. It is understood that the bars of the barcodes may have different characteristics such as having different width, different colors, etc. It must be noted that the horizontal and vertical barcodes shown, is only a sample. Variety of other directions for said bars of the barcodes may be considered. For example, a first group of bars may be horizontal and a second crossing group of bars on the same surface may be diagonal. Also more than two groups of bars wherein each of said group of bars having a different direction, may be provided on a writing surface.

By equipping the stylus type computer tip with barcode readers and systems, while writing, the position of the pen tip on the writing surface at each moment, may be known by the system.

According to another embodiment of the invention, as shown in FIG. 37, each location on the writing pad may be marked by means such as different numbers, different colors, etc. for this purpose the stylus type computer may be equipped with optical and/or color readers and recognition systems.

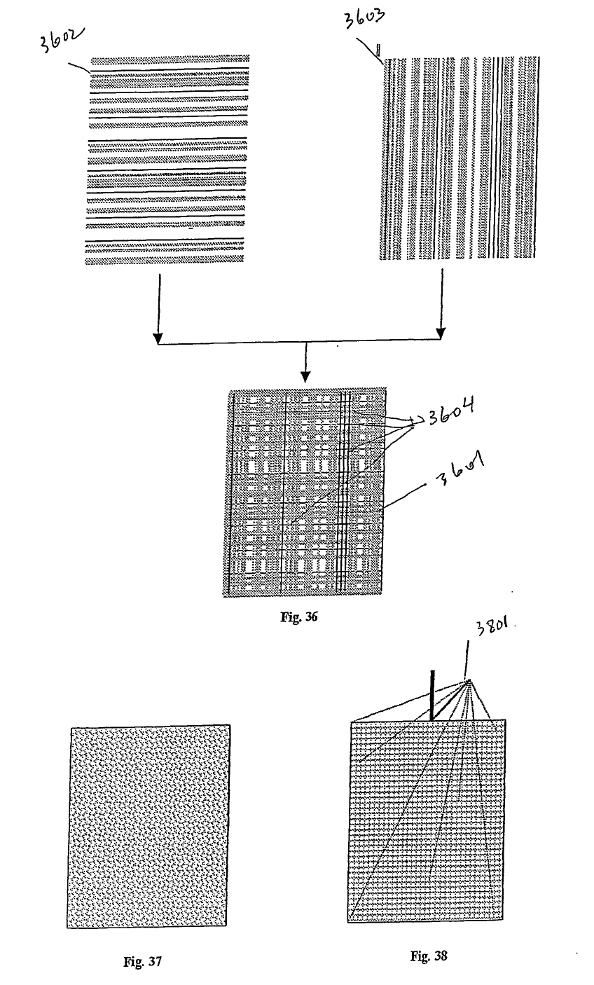

As shown in FIG. 38, barcodes, numbers, colors, and/or other position indicating information, maybe projected on a writing surface, by means of projectors (3801).

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature.

16. A pointing device comprising a writing tip, said writing tip having a surface being structured in a manner that while writing with said writing tip on a writing surface, in a different direction, the contacts of said writing tip with said writing surface produce a different sound.

17. The device according to claim 16, wherein writing procedure of a symbol on a writing surface with said pointing tip, produces a predefined sound waveform.

18. A handwriting recognition system according to claim 17, wherein said hand writing recognition system recognizes said waveform and selects a symbol assigned to said waveform.

19. A stylus type electronic device according to claim 18, wherein said stylus comprises said hand writing recognition system to permit recognition of symbols written by said stylus tip on a writing surface.

20. The device according to claim 19, wherein said stylus further comprises a microphone, a speaker, a display unit, and a transceiver for communication with other electronic devices.

21. The devices according to claim 20, wherein said stylus functions as a telephone device wherein said speaker and said microphone are far enough from each other to provide a distance between them wherein while using said telephone, said microphone and said speaker are in a relatively appropriate position closed to user's mouth and ear.

22. The devices according to claim 20, wherein said stylus functions as a telephone device wherein said speaker and said microphone are located near opposite ends of said stylus telephone.

23. The devices according to claim 20, wherein a user dials a number by writing said number with the stylus writing tip.

24. The devices according to claim 20, wherein a user writes massages by writing said massages with the stylus writing tip and sends said massages using said stylus communication means.

25. The devices according to claim 20, wherein said stylus comprises a display unit wherein said display unit raps around said electronic device in a manner to cover at least a substantial portion of the surface of said electronic device.

26. The devices according to claim 20, wherein said stylus comprises a mouse unit wherein said mouse unit operates as a pointing and selecting unit of said stylus-type electronic instrument, said mouse being installed on one end of said electronic device in said stylus type electronic device axis.

27. The devices according to claim 20, wherein said stylus comprises a clip button wherein said clip button operates as a multi key unit wherein pressing on a different location of said clip button corresponds to pressing a different predefined key.

28. The devices according to claim 20, wherein said clip button is used to attach said stylus computer to user's pocket.

29. A display unit for a stylus-type electronic device wherein said display unit raps around said electronic device in a manner to cover at least a substantial portion of the surface of said electronic device.

30. A mouse device operating as a pointing and selecting unit for a stylus-type electronic instrument, said mouse being installed at one end of said electronic device in said stylus-type device axis.

31. The device according to claim 30, wherein said mouse having rotating movements.

32. The device according to claim 30, wherein said mouse having at least two positions in said stylus axis.

33. The device according to claim 30, wherein said mouse having clicking movements in stylus axis.

34. The device according to claim 30, wherein said mouse responds to pressures applied on different locations on it.

35. A position recognition means, said means recognizes a position on a surface based on printed barcodes on said surface, wherein said barcodes comprise bars arranged in a multi-directional arrangements in a manner to provide crossing points of said bars.

36. A hand writing recognition system based on at least recognition of waveforms produced by a writing tip having a surface having sensors structured in a manner that the contacts of said writing tip with said writing surface, while writing a symbol, produce a predefined waveform.

37. The device according to claims 19 and 36, wherein said waveform is produced by vibrations sensed by said sensors.

38. The device according to claims 19 and 36, wherein said waveform is produced by heat sensed by said sensors.

39. The device according to claims 19 and 36, wherein said waveform is produced by sounds produced by said contacts.
